(19) United States
(12) Patent Application Publication
(10) Pub. No.: US 2017/0221059 A1
(43) Pub. Date: Aug. 3, 2017

(54) SYSTEM AND METHOD FOR GENERATING A LOCATION SPECIFIC TOKEN

(71) Applicant: RANVIR SETHI, FOREST LAKE (AU)

(72) Inventor: RANVIR SETHI, FOREST LAKE (AU)

(21) Appl. No.: 15/309,249

(22) PCT Filed: May 29, 2015
(86) PCT No.: PCT/AU2015/050291

§ 371 Date: Nov. 7, 2016

(30) Foreign Application Priority Data
May 29, 2014 (AU) 2014902052
Nov. 14, 2014 (AU) 2014904571

(51) Int. Cl. G06Q 20/40; G06Q 20/32; H04L 29/06

(52) U.S. Cl. CPC G06Q 20/405; H04L 63/083; H04L 63/107; G06Q 20/3224

(57) ABSTRACT

A server (108) for authenticating an interaction between a first user device (104) and a second user device (110) is provided. The server (108) includes a memory unit, a set of modules, a database (232), and a processor. The set of modules comprise a token request processing module (202), a token associating module (204), a token comparison module (210), a distance obtaining module (212) and an interaction processing module (214). The token request processing module (202) receives an input from a first user (102) comprising a location specific token with a location. The token associating module (204) associates the location specific token with the location. The distance obtaining module (212) obtains a distance between a location associated with the first user (102) and the second user (112). The interaction processing module processes an interaction between the first user (102) and the second user (112).

### CROSS-REFERENCE TO RELATED APPLICATIONS

This application claims priority from PCT Patent Application number PCT/AU2015/050291 filed on May 29, 2015, the complete disclosure of which, in its entirely, is herein incorporated by reference.

### BACKGROUND

Technical Field

The embodiment herein generally relates to a system that uses communication networks to authenticate user's identity, and more particularly, to a system and method to authenticate a plurality of users by generating a location based token.

Description of the Related Art

In recent years use of user identifications and passwords are not the most secure authentication mechanism and can be spoofed by unauthorized parties. As a result, SSO (Single sign on) is sometimes enhanced by using digital certificates, security tokens, smart cards, and/or biometric authentication mechanisms, for example, to provide access to higher risk applications and information. For security reasons, many of these applications require some form of authentication. Rather than require a user to logon to each individual application, single sign on (SSO) allows the user to logon a shared network to access multiple applications.

SSO between applications on a mobile device requires a shared token. Such Lukens are long strings or number, which cannot be conveniently recited by humans. Therefore, these tokens are transmitted using NFC (near field communications), QR (Quick response) codes etc., all of these are machine to machine communication. Since computational devices are getting more personal and private and pervasive of malicious software, users are not comfortable to indulge in machine to machine communication with their devices. Their only alternative is to recite these long tokens. If these tokens are less long, they tend to expire quickly.

Accordingly, there is a need for more secure authentication mechanism wherein, users can easily and quickly share the token verbally or otherwise without exposing their devices to other devices for machine to machine transmission of tokens.

### SUMMARY

In view of the foregoing, an embodiment herein provides a server for authenticating an interaction between a first user device and a second user device is disclosed. In one aspect, the sever for authenticating an interaction between a first user device and a second user device includes a memory unit that stores, a set of modules, a database and a processor. The processor executes the set of modules and the set of modules includes a token request processing module, a token associating module, a token communication module, a token receiving module, a token comparison module, a distance obtaining module and an interaction processing module. The token request processing module receives an input from a first user. The received input from the first user comprises a request to associate a location specific token with a location. The token associating module associates the location specific token with the location. The location specific token is specific to the location characterized by a threshold distance or a threshold area. In an embodiment, the token association module simultaneously associates identical tokens that are separated by a threshold distance, and a location of the first user is a physical location or an assumed location. The location of the first user is characterized by a first threshold area or distance and a second threshold area or distance. The first threshold area or distance is within the second threshold area or distance.

The token communicating module communicates the location specific token to or from a first user device associated with the first user. In an embodiment, the token communication module further communicates the location specific token to a plurality of user devices associated with the plurality of users. The location specific token is communicated from the first user device to a second user device associated with a second user. The token communicating module further communicates the location specific token to and from the payee device or the payer device or communicates the location specific token to the payer device and obtains the location specific token from the payee device.

The token comparison module compares data based on the location specific token which is associated by the server with the location specific token which is received by the server for a match. The distance obtaining module, obtains a distance between a location associated with the first user and a location associated with the second user. In an embodiment, the distance obtaining module further obtains a distance between the location associated with the location specific token and the location of the first user. In an embodiment, this distance is between two location specific tokens of the two users, or distance of a location associated with a location specific token with location associated with a second user. The distance calculation module is calculating distance associated with two users of user devices. In an embodiment, the distance calculation module uses tokens to calculate distance between users or their associated location specific tokens. The users can assume locations or use their actual locations. The interaction processing module processes an interaction between the first user and the second user. In an embodiment the first user is a payer and the second user is a payee. The transaction comprises exchange of data between a payer device and a payee device. In an embodiment, the interaction processing module processes an interaction between the first user and the second user when a match is found between the location associated with location specific token associated by the server or the distance between the first user and the second user is within the threshold area or the threshold distance. The first user of the first user device or the second user of the second user device is inside or outside of the location characterized by the threshold area or the threshold distance and a location associated with a user is a physical location of the user or an assumed location of the user.

In an embodiment, the set of modules further comprise a token association module, a token deactivation module, a location receiving module, a token reusing module, an approval receiving module, a transaction processing module, a payee identifier communication module, a security check module, and a token verification module. The token association module simultaneously associates identical tokens that are separated by a threshold distance. The location of the first user is characterized by a first threshold area or the threshold distance and a second threshold area or the threshold distance. The first threshold area or the threshold distance is within the second threshold area or the threshold distance. The location specific token is a reusable token that is identical for a plurality of users and simultaneously used by a plurality of users from a plurality of locations. The approval receiving module receives an approval for the transaction from the payer device

The token deactivation module deactivates the location specific token when the first user moves out of the first threshold area for which the location specific token is generated, the interaction between the first user and the second user is completed, or deactivates the location specific token when the first user indicates to deactivate the location specific token. The location receiving module receives the location of the first user. The token generating module generates a set of tokens that are specific to location of third user and the location is within the threshold distance or the threshold area of location of the first user. The token reusing module reuses the location specific token for an interaction between a third user and a fourth user when the interaction between the first user and the second user is completed.

The transaction processing module is configured to process the transaction between the payer and the payee upon successfully receiving the approval; and when a match is found between the location specific token associated with the payer device and the location specific token associated with the payee device. The transaction processing module notifies a completion or a decline message of the transaction to the payer device. Transaction document about the transaction is also exchanged between payer and payee about the transaction. This document can be a real time incremental transmission of itemized data from the scanning till of a merchant payee upon scan of each item to the payer device before the payment is approved and made by the payer. The consolidated itemized list is sent after the payment is made. The payer device and payee device are informed upon a successful completion or a failure of the transaction. In an embodiment, the transaction is processed based on an agreement between the payer and the payee. The transaction document is exchanged between the payee and the payer based on an identifier of an agreement. The payee identifier communication module communicates a payee identifier to the payer device. The payee identifier may be an individual, a business or a group or plurality of payees. The payee identifier and a payer identifier are associated with the location of the location specific token characterized by the threshold area or the threshold distance.

The a security check module performs an additional security check for the payer upon detection of breach of a threshold amount by a cumulative total of the transaction starting from a previous additional security check. The token verification module verifies whether the location specific token associated with the payer or the payee exists in a database of location specific tokens and the database of the location specific tokens is associated with the threshold distance or the threshold area characterized by the location associated with the payee device or the location associated with the payer device.

In another aspect, a user device for authenticating an interaction between a first user and a second user are disclosed. The user device for authenticating an interaction between a first user and a second user includes a display unit, a database, and a processor which when configured by the instructions executes the set of modules. The set of modules comprises a token processing module, a token manifesting module, a token communicating module, a token receiving module, and a token notification module. The token processing module obtains a location specific token associated with a threshold area or distance based on an interaction from a first user device with a server and the location specific token is valid only for a location characterized by a threshold area or a threshold distance. The token manifesting module manifests the location specific token on a first user device. The token communicating module communicates the location specific token to the server. The token receiving module receives plurality of location specific tokens from the server. The token notification module notifies or implies a successful comparison between the location specific token associated with the first user device and the location specific token associated with the second user device to a user of the device.

In an embodiment, the set of modules further includes a token obtaining module that obtains identical tokens. The token obtaining module communicates the identical tokens to the token communicating module. A location of the first user is a physical location or an assumed location. In an embodiment, the set of modules further comprise a token deactivation communication module. The token deactivation communication module communicates a deactivation message to the server for deactivating the location specific token when the payer moves out of a first threshold area for which the location specific token is generated, the transaction between the first user and the second user is completed, the first user indicating to deactivate the location specific token or a predefined threshold time of the location specific token exceeds a predefined limit or upon closing of an application in the user device. In an embodiment, a biometric data of the first user is used for authorizing the location specific token for the first user to ensure the user obtaining token is authorised to interact with the first user device or the server.

In another aspect, a payer and a payee device for processing a transaction between a payer and a payee by obtaining a location specific token is disclosed. The payer and the payee device includes memory unit that stores a set of modules, a database, and a processor which executes the set of modules. The set of modules comprise an amount module, a location specific token obtaining module, a location specific token receiving module, and an approval module. The amount module that sends a transaction amount associated with the transaction to a server or receives the transaction amount associated with the transaction from the server. Upon interaction with the server by payer device, the location specific token obtaining module, obtains the location specific token on the payer device. The approval module notifies and obtains payer's approval for processing a transaction. The location specific token is specific to a location characterized by a threshold distance or a threshold area and communicates the location specific token to the payee or the payee device. The location specific token receiving module receives location specific token from a payee or payee device. The set of modules for payee device comprise an amount module, a location specific token obtaining module and a location specific token receiving module. The amount module that sends a transaction amount associated with the transaction to a server or receives the transaction amount associated with the transaction from the server. Upon interaction with the server by payee device, the location specific token obtaining module obtains the location specific token on the payee device. The location specific token is specific to a location characterized by a threshold distance or a threshold area and communicates the location specific token to the payer or the payer device. The location specific token receiving module receives location specific token from a payer or payer device.

The location specific token receiving module receives the token from the payee or the payee device. The approval module notifies payer's approval of the transaction to a server based on the amount or payee identifier or both. The approval includes input of the amount by the payer or payee identifier or a plurality of payee identifier. In an embodiment, set of modules further comprise a token request processing module that generates a request to match the location specific token associated with the payer and the location specific token associated with the payee.

In another aspect, a user device for processing an interaction between a first user and a second user by obtaining a location specific token is disclosed. The first user and the second user device includes memory unit that stores a set of modules, a database, and a processor which executes the set of modules. The set of modules comprise includes a token processing module, a token manifesting module, a token communicating module, a token receiving module, a token notification module and a token deactivation communication module. In one embodiment, the token processing module obtains a location specific token associated with a threshold area or distance based on an interaction from a first user device with a server. The location specific token is valid only for a location characterized by a threshold area or a threshold distance. The token manifesting module manifests the location specific token on the first user device. In one embodiment, the token communicating module communicates the location specific token from or to the server. The token receiving module receives location specific tokens from the second user or second user device. In one embodiment, the token notification module notifies or implies a successful comparison between the location specific token associated with the first user device and the location specific token associated with the second user device to a user of the device. In one embodiment, the token deactivation communication module communicates a deactivation message to the server for deactivating the location specific token when (a) the user moves out of a first threshold area for which the location specific token is generated, (b) the transaction between the first user and the second user is completed, (c) the payer indicating to deactivate the location specific token, (d) a predefined threshold time of the location specific token exceeds a predefined limit and (e) upon closing of an application in the user device. A token request processing module generates a request to match location specific token within device by obtaining location specific tokens from server obtained by others users within threshold distance or area from a server.

In another aspect, a processor implemented method for authenticating an interaction between a first user device and a second user device are disclosed. The processor implemented method for authenticating an interaction between a first user device and a second user device includes receiving an input from a first user comprising a request to associate a location specific token with a location. Associating the location specific token with the location. The location specific token is specific to a location characterized by a threshold distance or a threshold area. Communicating the location specific token to or from a first user device associated with the first user. The location specific token is communicated from the first user device to a second user device associated with a second user. Receiving the location specific token from the second user device. Comparing data based on the location specific token which is associated by the server with the location specific token which is received by the server for a match.

Obtaining a distance between a location associated with the first user of and a location associated with the second user. Processing an interaction between the first user and the second user when the match is found between the location associated with location specific token which is associated by the server and the location specific token which is received by the server and the distance between the first user and the second user is within the threshold area or the threshold distance. The first user of the first user device or the second user of the second user device is inside or outside of the location characterized by the threshold area or the threshold distance and a location associated with a user is a physical location of the user or an assumed location of the user.

In another aspect, one or more non-transitory computer readable storage mediums storing one or more sequences of instructions are disclosed. One or more non-transitory computer readable storage of instructions which when executed by one or more processors, causes receiving an input from a first user comprising a request to associate a location specific token with a location. Associating the location specific token with the location and the location specific token is specific to a location characterized by a threshold distance or a threshold area. Communicating the location specific token to or from a first user device associated with the first user. The location specific token is communicated from the first user device to a second user device associated with a second user. Receiving the location specific token from the second user device. Comparing data based on the location specific token which is associated by the server with the location specific token which is received by the server for a match.

Obtaining a distance between a location associated with the first user and a location associated with the second user. Processing an interaction between the first user and the second user when the match is found between the location specific token associated by the server and the location specific token received by the server, or the distance between the first user and the second user is within the threshold area or the threshold distance. The first user of the first user device or the second user of the second user device is inside or outside of the location characterized by the threshold area or the threshold distance and a location associated with a user is a physical location of the user or an assumed location of the user.

Accordingly, these and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

The embodiments herein will be better understood from the following detailed description with reference to the drawings, in which:

FIG. 1 illustrates a system view of a first user interacting with a second user through a server according to an embodiment herein;

FIGS. 2A and 2B illustrate an exploded view of the server of FIG. 1, according to an embodiment herein;

FIG. 2C illustrates an exploded view of a database of a payer device according to an embodiment herein;

FIG. 2D illustrates an exploded view of a database of a payee device according to an embodiment herein;

FIG. 2E illustrates an exploded view of a database of a user device according to an embodiment herein;

FIGS. 3A, 3B and 3C are a flowchart that illustrates a method for verifying stranger authentication through the server of FIG.1, according to an embodiment herein;

FIGS. 4A, 4B and 4C are a flowchart that illustrates a method for pairing two devices through the server of FIG. 1, according to an embodiment herein;

FIGS. 5A, 5B and 5C are a flowchart that illustrates a method for pairing one device with plurality of devices which can exchange identity, data or read an allocated memory space in a one-way paired mode, through the server 1, according to an embodiment herein;

FIGS. 6A, 6B and 6C are a flowchart that illustrates a method for pairing a device with website in which they can exchange identity, data or read an allocated memory space of in a one way paired mode, through the server of FIG. 1, according to an embodiment herein;

FIGS. 7A, 7B and 7C are a flowchart that illustrates a method for pairing a website session with a device after which they can exchange identify, data or read an allocated memory space of each other, through the server of FIG. 1, according to an embodiment herein;

FIGS. 8A, 8B and 8C are a flowchart that illustrates a method for two-way pairing a website session with another website session in which they can exchange identify, data or read an allocated memory space of each other, through the server of FIG. 1, according to an embodiment herein;

FIGS. 9A, 9B and 9C are a flowchart that illustrates a method for pairing a website with another website in which they can exchange identify, data or read an allocated memory space of in a one way paired mode, through the server of FIG. 1, according to an embodiment herein;

FIGS. 10A and 10B are user interface views of a location specific token generated by using a method such that identical tokens can be used by several users simultaneously through the server, according to an embodiment herein;

FIGS. 11A, 11B, 11C and 11D are a flowchart that illustrates a method of payment by a nearby payee to a payer through the server, according to an embodiment herein;

FIGS. 12A, 12B, 12C and 12D are a flowchart that illustrates a method of payment to payer by payee for any location in the world through the server, according to an embodiment herein;

FIGS. 13A, 13B and 13C are a flowchart that illustrates a method for a secure payment when the payer device or payee device is lost with the server, according to an embodiment herein;

FIGS. 14A, 14B, 14C and 14D are a flowchart that illustrates a method of payment to a payee through an ATM from payer's account through the server, according to an embodiment herein;

FIGS. 15A, 15B, 15C, 15D and 15E are a flowchart that illustrates a method of paying recurring payments to a payee by a nearby payer through the server, according to an embodiment herein;

FIGS. 16A, 16B, 16C, 16D and 16E are a flowchart that illustrates a method of paying recurring payments to a payee by a remote payer through a unique agreement identifier in the server, according to an embodiment herein;

FIGS. 17A, 17B, 17C, 17D and 17E are a flowchart that illustrates a method of paying recurring payments to a website in the server, according to an embodiment herein;

FIGS. 18A, 18B, 18C, and 18D are a flowchart that illustrates a method of purchase from a payer to a payee through an automatic vending machine (AVM) in the server, according to an embodiment herein;

FIGS. 19A, 19B, 19C, and 19D are a flowchart that illustrates a method of purchase from a payer to a payee through an automatic checkout machine (ACM) in the server, according to an embodiment herein;

FIGS. 20A, 20B, 20C and 20D, are a flowchart that illustrates a method of purchase from a payer to a website through the server 108 of FIG. 1, according to an embodiment herein;

FIGS. 21A, 21B, 21C and 21D are a flowchart that illustrates a method of purchase from a website to an application through the server, according to an embodiment herein;

FIG. 22 is a flowchart that illustrates a method of transmission of transaction document through the server, according to an embodiment herein;

FIG. 23 is a flowchart that illustrates a method of transmission of multiple transaction documents based on an agreement identifier through the server, according to an embodiment herein;

FIG. 24 illustrates an interface view of a database model of the server according to an embodiment herein;

FIGS. 25A and 25B illustrate a method for pairing two devices in a geographically non-intersecting areas through the server of FIG. 1, according to an embodiment herein;

FIGS. 26A and 26B illustrate a method for pairing two devices in geographically intersecting areas through the server of FIG. 1, according to an embodiment herein;

FIG. 27 is a flowchart that illustrates a method for token generation in a device, through the server of FIG. 1, according to an embodiment herein;

FIG. 28 is a flowchart that illustrates a method for token generation in a server of FIG. 1, according to an embodiment herein;

FIG. 29 illustrates a method for obtaining a location specific token for authenticating an interaction between a first user device and a second user device; and

FIG. 30 is a schematic diagram of a computer architecture used in accordance to the embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skilled in the art to practice the embodiments herein. Accordingly, the examples should not be construed as limiting the scope of the embodiments herein.

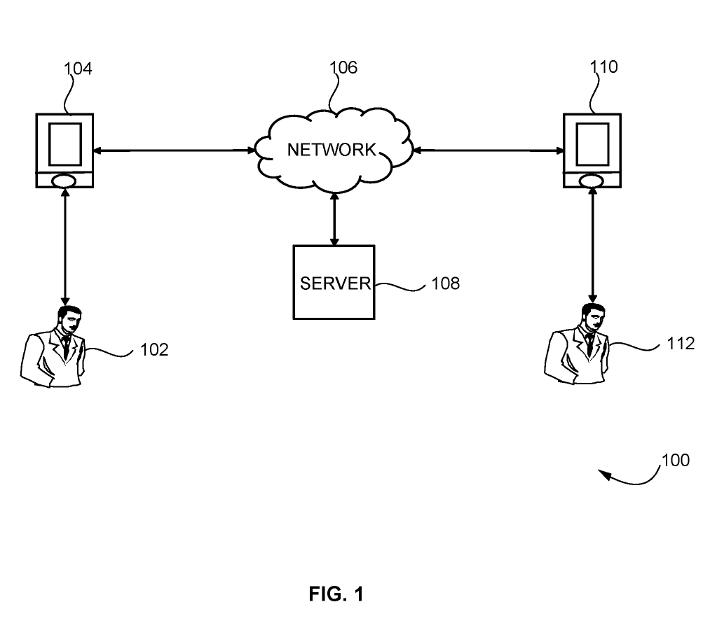

As mentioned, there remains a need for more secure authentication mechanism wherein, users can easily and quickly share the token verbally or otherwise without exposing their devices to other devices for machine to machine transmission of tokens. Referring now to the drawings, and more particularly to FIGS. 1 to 30, where similar reference characters denote corresponding features consistently throughout the figures, these are shown preferred embodiments.

FIG. 1 illustrates a system view 100 of a first user 102 interacting with a second user 112 through a server 108 according to an embodiment herein. The system view 100 includes a first user device 104, a second user device 110, and a network 106, according to an embodiment herein. The first user 102 interacts with the second user 112 through the network 106 provided by the server 108. The first user 102 interacts with the second user 112 through a network 106 with a smart phone, a computer or both, or such computation devices. In one embodiment, the first user device 104 obtains a token by interacting with a server 108, whereas second user device 110 receives the token from first user 102 or first user device 104 and sends it back to server 108 for matching. In one embodiment the first user 102 is a payer and a second user 112 is a payee. In one embodiment, the first user device 104 is a payer device and the second user device 110 is a payee device. In one embodiment, the first user 102 is a payee and a second user 112 is a payer and the first user device 104 is a payee device and the second user device 110 is a payer device. In an embodiment, a user can be payer or a payee, both. The user can decide to be a payer or a payee, that is, a first user 102 can obtain a token from server 108 and share it with second user 112 to transfer funds or receive finds, that is, first user 102 can be a payer and or payee, within the same embodiment.

A location specific token is created for interacting between the first user 102 and the second user 112. This token can be obtained for any location, including a location that is remote from device location. By setting location of the tokens to within a threshold area of distance, two users, by exchanging the token, can interact or transact with each other. This interaction can happen when two users are in proximity and also when they are remote from each other. The location acts as additional factor of authentication, in addition to the token. In one embodiment, the token is unique to the location. In one embodiment, if a user moves out of a pre-defined distance from that location, the token is deactivated. In one embodiment, a user can only interact with an interface by obtaining token of a pre-agreed location. For example, bank employee can only access intranet system of bank from a location that is pre-assigned to the user by the bank, which provides additional security to the user and the bank. The bank employee is never required to be at the secret location physically to obtain the token as token can be obtained from anywhere by assuming the location.

In an embodiment a token can be unique and repeatable. For example, an example token “CD39X” of five characters where first two characters are alphabets or numbers, next two are digits and last one alphabet or number. Such a token can have 4,665,600 possible combinations. Hence, such a five character long repeatable token can serve more than 4 million users simultaneously. In the event, the number of requestors for token at a given time surpasses that number, an additional character can be introduced by the server to the token size. The payer is sought an approval prior to processing a payment wherein in an embodiment identifier of payee is disclosed to payer. Hence regardless of whether the token is shared by payer to payee or payee to payer, the payer provides the server with explicit approval prior to processing of the payment by the server. The approval displays payee identifier or amount or both to payer. A payer may input amount. The server may deactivate a token instantly where it detects that more than one user has entered the same active token in their devices simultaneously. This method can be used for all embodiments herein for interaction and transaction between a first user 102 and a second user 112.

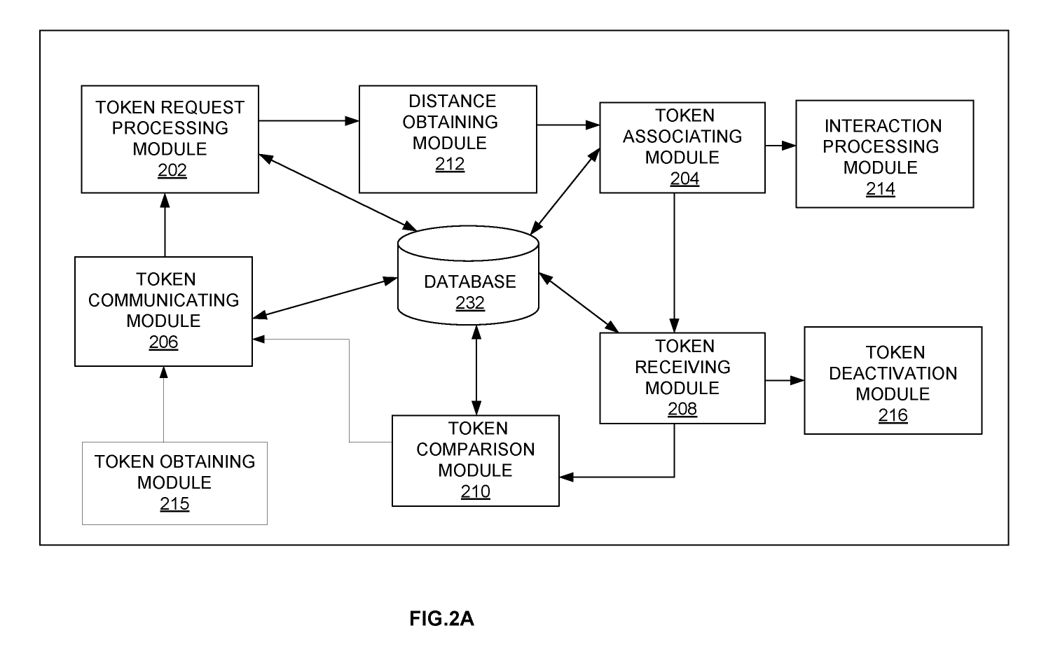

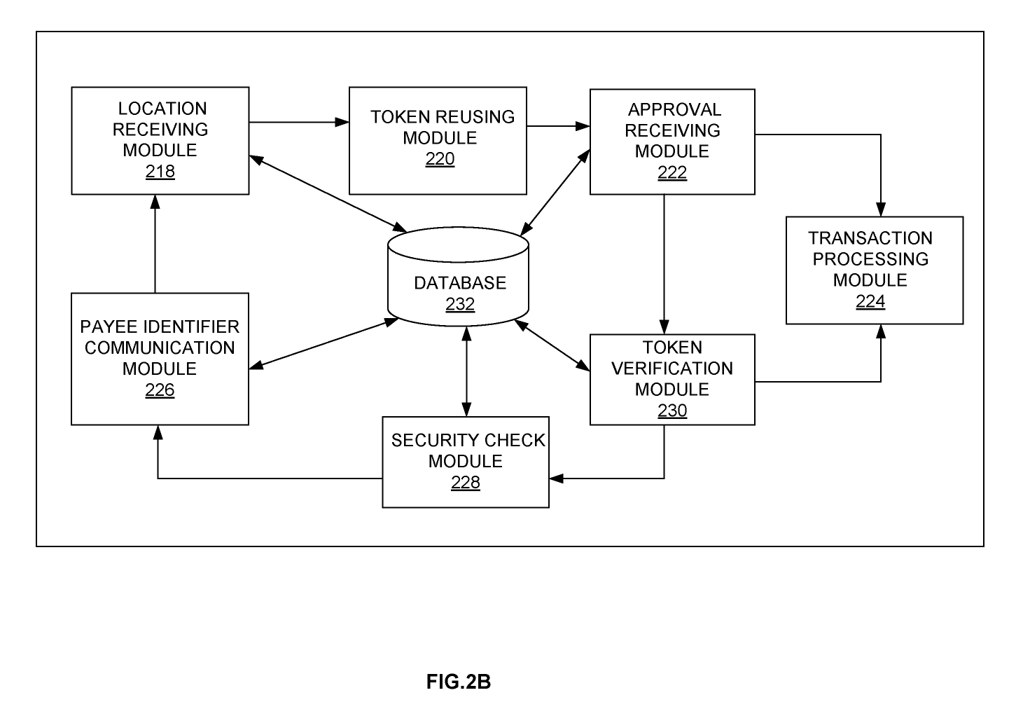

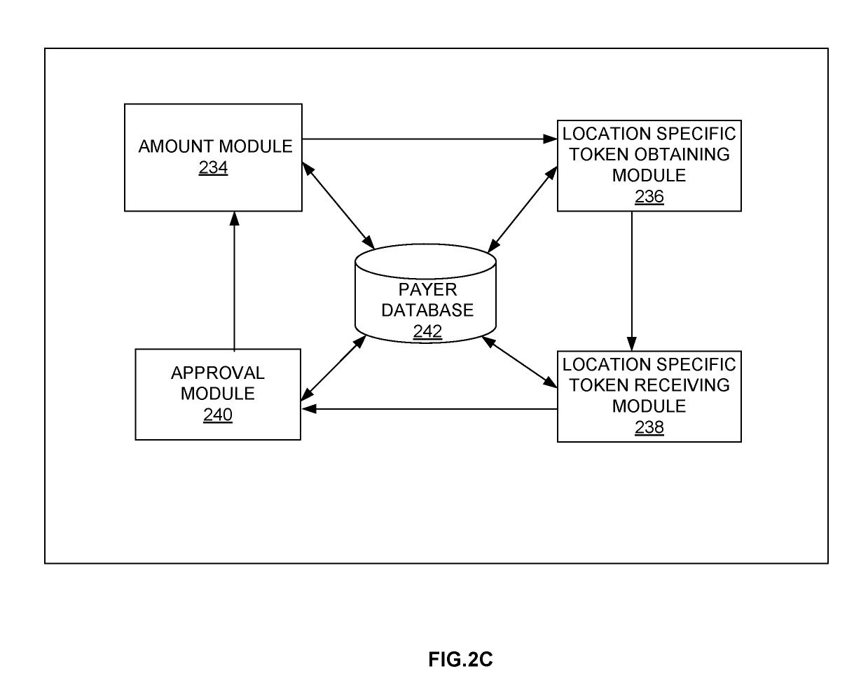

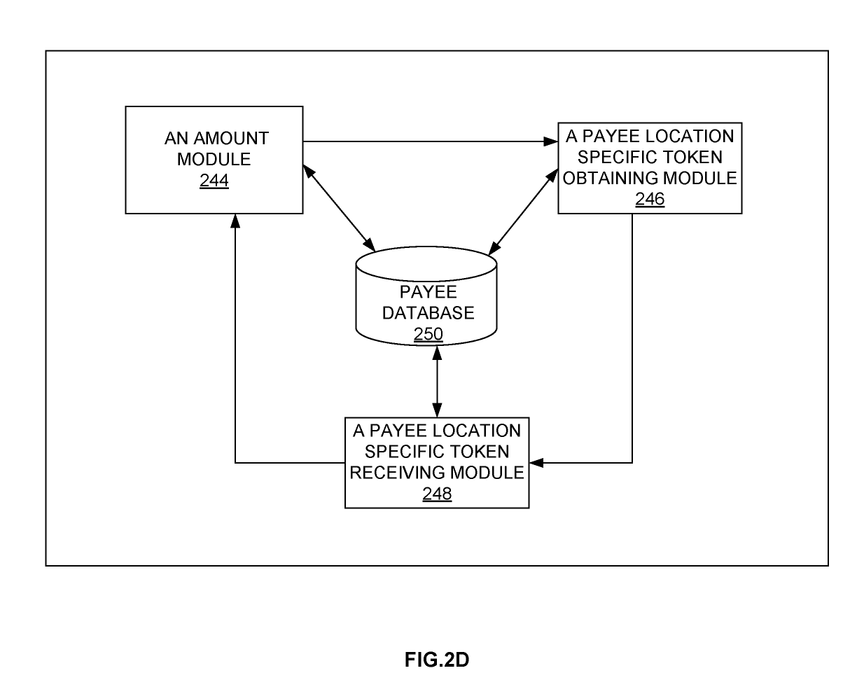

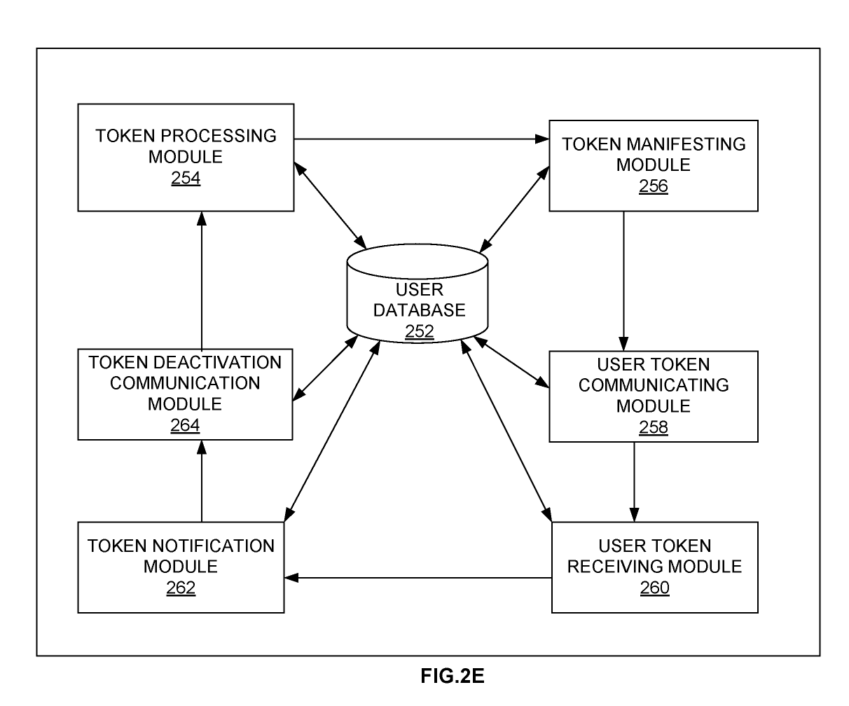

FIGS. 2A & 2B illustrate an exploded view of the server 108 of FIG. 1 according to the embodiment herein. The server 108 includes a token request processing module 202, a token associating module 204, a token communicating module 206, a token receiving module 208, a token comparison module 210, a distance obtaining module 212, an interaction processing module 214, a token obtaining module 215, a token deactivation module 216, a location receiving module 218, a token reusing module 220, an approval receiving module 222, a transaction processing module 224, a payee identifier communication module 226, a security check module 228, a token verification module 230, and a database 232.The token request processing module 202receives an input from the first user 102 comprising a request to associate a location specific token with a location. The location specific token is valid only for a location characterized by the threshold distance or the threshold area.

The token request processing module 202 receives request to associate a token with a location of first user 102, wherein location of first user 102 is its physical location or its assumed location. The token associating module 204associates the location specific token with the location. In one embodiment, the location specific token is specific to the location characterized by a threshold distance or a threshold area. The token associating module 204, associates identical tokens that are separated by a threshold distance. A location of the first user 102 is a physical location or an assumed location. In one embodiment, the location of the first user 102 is characterized by a first threshold area or distance and a second threshold area or distance. The first threshold area or distance is within the second threshold area or distance. The token communicating module 206 communicates the location specific token to or from the first user device 104 of FIG. 1 associated with the first user 102. In one embodiment, the location specific token is communicated from the first user device 104 to the second user device 110 associated with a second user 112 of FIG. 1. The token communicating module 206 communicates the location specific token to a plurality of user devices associated with the plurality of users. In one embodiment, the token communicating module 206 communicates the location specific token to and from the payee device 112 of FIG. 1 or the payer device 104 of FIG. 1 or communicates the location specific token to the payer device 104 of FIG.1 and location receiving module 208 receives the location specific token from the payee device 112 of FIG. 1. The payee is a merchant and the amount is a transaction total.

The token receiving module 208 receives the location specific token from the second user device 110 of FIG. 1. The token comparison module 210 compares data based on the location specific token which is associated by the server 108 of FIG. 1 with the location specific token which is received by the server 108 of FIG. 1 for a match. The distance obtaining module 212 obtains a distance between a location associated with the first user 102 and a location associated with the second user 112 of FIG. 1. It may be also distance between locations associated with a location specific token of first user 102 and second user 112. It may be also be distance between locations associated with a location specific token and location of a first user 102 or second user 112. The interaction processing module 214 processes an interaction between the first user 102 of FIG. 1 and the second user 112 of FIG. 1 when the match is found between the location associated with location specific token that is associated by the server 108 and the location specific token that is received by the server 108, and the distance between the first user 102 and the second user 112 is within the threshold area or the threshold distance. In one embodiment, the first user 102 of the first user device 104 of FIG. 1 or the second user 112 of the second user device 110 is inside or outside of the location characterized by the threshold area or the threshold distance and a location associated with a user is a physical location of the user or an assumed location of the user.

The token deactivating module 216 deactivates the location specific token when the first user 102 moves out of the first threshold area for which the location specific token is associated. The deactivating module 216 deactivates the location specific token when the interaction between the first user 102 and the second user 112 is completed, or upon the first user 102 indicating to deactivate the location specific token. The token can also be deactivated upon expiry of a threshold time. The location receiving module 218 receives the physical or assumed location of the first user 102 and second user 112. In one embodiment, a token generating module generates a set of tokens that are specific to location of third user and this location is within the threshold distance or the threshold area of location of the first user 102 of FIG. 1. The location specific token associated with first user 102 and location of first user 102 become input for generating a location specific token for a third user who is within threshold distance of first user 102, so that the location specific token associated with third user does not conflict with location specific token associated with first user 102. The token generation module generates these tokens for the use of other users within threshold distance of a first user 102, so that tokens could be unique within the threshold distance of first user 102 though non-unique globally. In an embodiment, the eligible set of tokens may be sent to device to select one, the selected one is then associated with a location.

The token reusing module 220 reuses the location specific token for an interaction between a third user and a fourth user when the interaction between the first user 102 and the second user 112 is completed. The approval receiving module 222 receives an approval for the transaction from the payer device 104 of FIG. 1. In one embodiment, the transaction processing module 224 to process the transaction between the payer 102 of FIG. 1 and the payee 112 of FIG. 1 upon successfully receiving the approval and when a match is found between the location specific token associated with the payer device 104 of FIG. 1 and the location specific token associated with the payee device 110 of FIG. 1. The payee identifier communication module 226 communicates a payee identifier to the payer device 104 of FIG. 1. The security check module 228 performs an additional security check for the payer 104 upon detection of breach of a threshold amount by a cumulative total of the transaction starting from a previous additional security check. The token verification module 230 verifies whether the location specific token associated with the payer 102 or the payee 112 exists in a database 232 of location specific tokens. In one embodiment, the database of the location specific tokens is associated with the threshold distance or the threshold area characterized by the location associated with the payer device 104 of FIG. 1 or the location associated with the payee device 110 of FIG. 1. In another embodiment the second user identifier is pre-associated with a location such as in an online phone book, therefore, upon clicking or tapping on the second user 112 identifier by first user 102, a token is automatically obtained that is pre-associated with a location associated with the second user 112.

FIG. 2C illustrates an exploded view of the payer device 104 of FIG. 1 according to the embodiment herein. The payer device 104 of FIG. 1 includes an amount module 234, a location specific token obtaining module 236, a location specific token receiving module 238, an approval module 240 and a payer database 242. The amount module 234 sends a transaction amount associated with the transaction to the server 108 or receives said transaction amount associated with the transaction from the server 108 of FIG. 1. The location specific token obtaining module 236 obtains the location specific token on the payer device 104 of FIG. 1. The payer is first user 102 and payee is second user 112 and the first user device 104 obtaining a token by interacting with server 108 and second user device 110 receiving the token from first user 102 or first user device 104. The location specific token is specific to a location characterized by a threshold distance or a threshold area, and payer 102 or payer device 104 communicates the location specific token to the payee 112 or the payee device 110. The location specific token receiving module 238 is employed to receive the location specific token from the payee 102 or the payee device 104 of FIG. 1, wherein, the payee is first user 102 and the payer is second user 112.

The approval module 240 notifies payer's approval of the transaction to a server 108 based on the amount. The approval includes input of the amount by the payer 104 or payee identifier or a plurality of payee identifiers. In an embodiment, a device can have both the location specific token obtaining module 236 and location specific token receiving module 238 wherein, a payer 104 and payee 112 can decide for themselves the flow of token to be from the payer 104 to the payee 112 or the payee 112 to the payer 104. Whereas another embodiment may have only one, the location specific token obtaining module 236 or location specific token receiving module 238 for a payer 104 and a payee 112 shall have the other module, to compliment.

FIG. 2D illustrates an exploded view of the payee device 110 of FIG, 1 according to the embodiment herein. The payee device 110 of FIG. 1 includes an amount module 244, a payee location specific token obtaining module 246, a payee location specific token receiving module 248 and a payee database 250. The amount module 244 sends a transaction amount associated with the transaction to the server 108 or receives said transaction amount associated with the transaction from the server 108 of FIG. 1. The payee location specific token obtaining module 246 obtains the location specific token on the payee device 104 of FIG. 1, wherein payee is first user 102 and payer is second user 112. The location specific token is specific to a location characterized by a threshold distance or a threshold area, and payee or payee device communicates the location specific token to the payer 112 or the payer device 110. The payee location specific token receiving module 248 is employed to receive the location specific token from the payer 102 or the payer device 104 of FIG. 1, wherein, payer is first user 102 and payee is second user 112.

FIG. 2E illustrates an exploded view of the user device according to the embodiment herein. The user device includes a token processing module 254, a token manifesting module 256, a user token communicating module 258, a user token receiving module 260, a token notification module 262, a token deactivation communication module 264 and a user database 252. The token processing module 254 obtains a location specific token associated with a threshold area or distance based on an interaction from a first user device 104 of FIG. 1 with server 108 of FIG. 1. The location specific token is valid only for a location characterized by a threshold area or a threshold distance. The token manifesting module 256 manifests the location specific token on the first user device 104 of FIG. 1. The token communicating module 258 communicates the location specific token to or from the server 108. The user token receiving module 260 receives one or more location specific tokens from a second user 112 or second user device 110. The token notification module 262 notifies or implies a successful comparison between the location specific token associated with the first user device 104 of FIG. 1 and the location specific token associated with the second user device 110 of FIG. 1 to a user of the device. The token deactivation communication module 264 communicates a deactivation message to the server 108 for deactivating the location specific token when (a) the user moves out of a first threshold area for which the location specific token is generated, (b) the transaction between the first user 102 of FIG. 1 and the second user 110 of FIG. 1 is completed, (c) the payer indicating to deactivate the location specific token, (d) a predefined threshold time of the location specific token exceeds a predefined limit and (e) upon closing of an application in the user device. In one embodiment, user device may perform a biometric authorisation check for a user before manifesting or obtaining a token for a user.

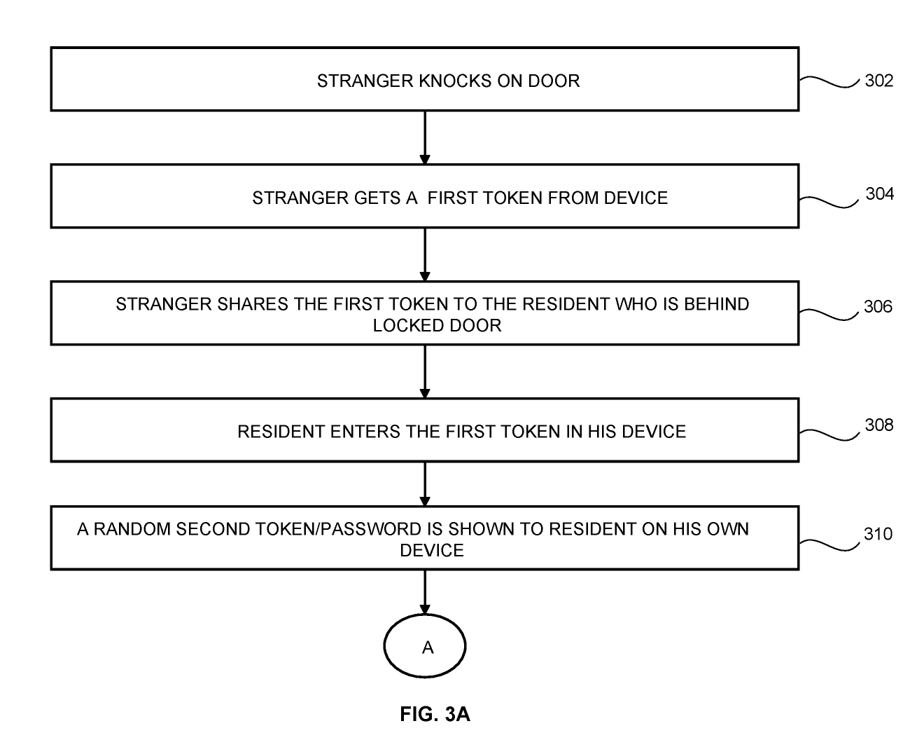

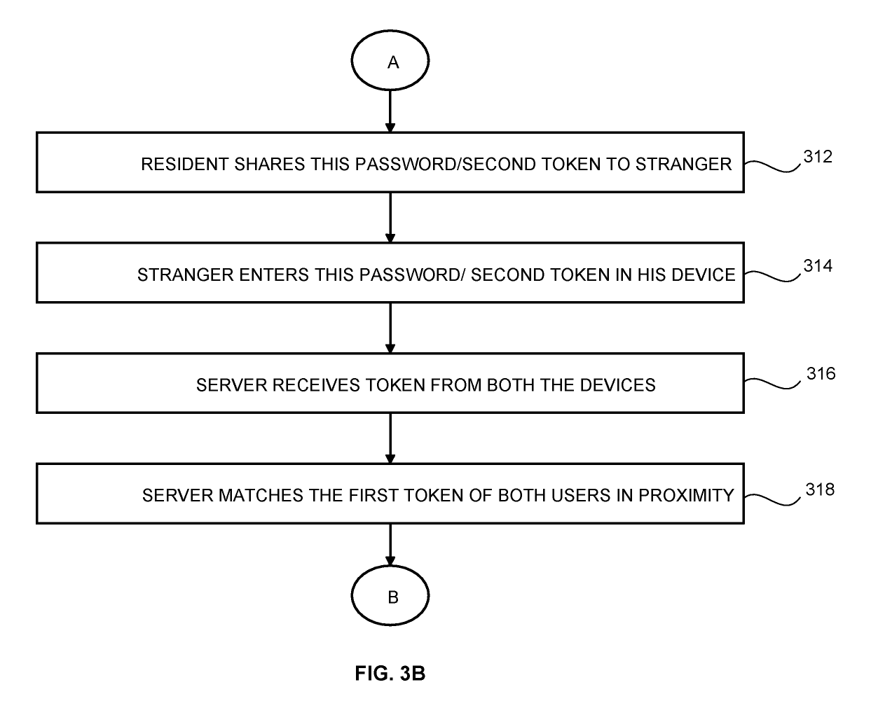

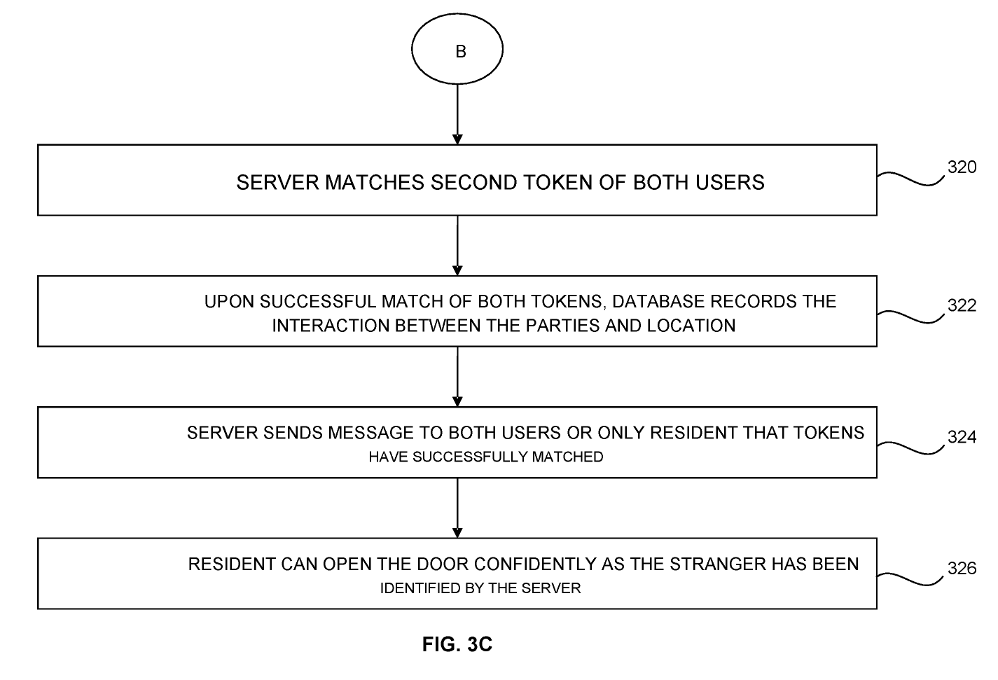

FIGS. 3A, 3B and 3C are a flowchart that illustrates a method for verifying authenticity of a stranger before opening a secure access for a stranger, through the server 108 of FIG.1, according to an embodiment herein. In an example embodiment, in step 302, a stranger knocks the door. In step 304, a first token from the first user device 104 of FIG. 1 is obtained by the stranger. In step306, the first token is shared by the stranger to the resident who is reluctant to open the door. In step 308, the first token in the second user device 110 of FIG. 1 is entered by the resident. In step 310, the second user device 110 of FIG. 1, that is, resident device generates and displays a random password, also being called as a second token. In step 312, the stranger obtains the second token from the resident. In step 314, the second token in the first user device 104 of FIG. 1 is entered by the stranger. In step 316, the first token from the resident and the second token from the stranger are received by the server 108. In step 318, the first token is matched by the server 108 as they are within threshold distance. In step 320, the second token of both users is matched by the server 108. In step 322, upon a successful match of both tokens of both parties that are interacting at the given location the server 108 records in a database. In step 324, the message is sent to both users or only the resident by the server 108, stating that they have been successfully matched and the stranger is identified by the system the stranger is already authenticated to the system on his device. In step 326, the secure access can be opened by the resident confidently as the interaction is recorded by the server 108 where the stranger is a known user. In an embodiment a voice or video call can be initiated between the parties and thus precludes need for a security intercom. In one embodiment, stranger communicates his token into a doors interface, then receives an approval notice to approve opening of the door if the stranger, who is having a secured access to his device, is supposed to have access to the door. Upon stranger's approval, the door is sent a signal to unlock once so the stranger, who is now identified by the server 108, can enter from the door. The token can also be that of a secret location assigned to the user and not necessarily that of the door. The server 108, verifies that the token within threshold distance of the door. The server 108 verifies that the token is within threshold distance of the location. It can be a globally unique token, or a non-unique repeatable token. Hence even if the user device is misused by someone, they must also know the secret location.

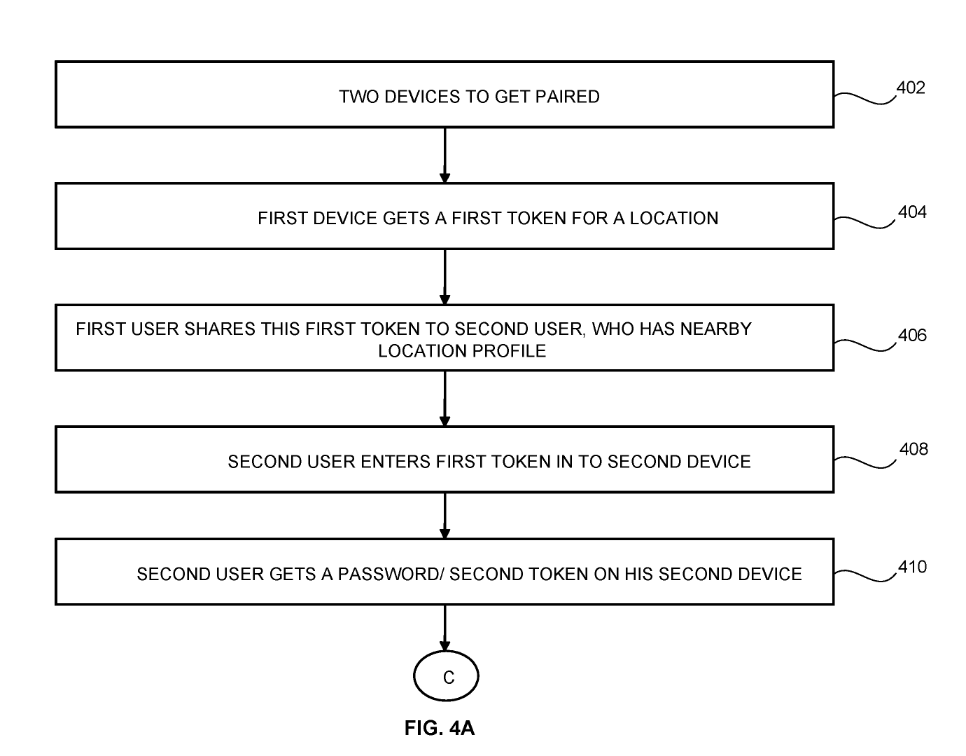

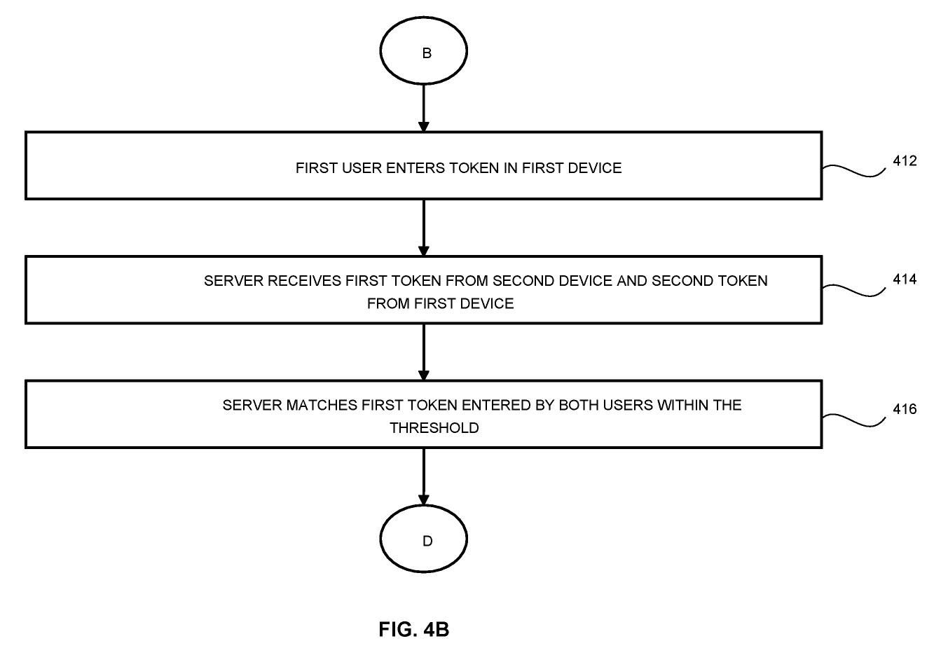

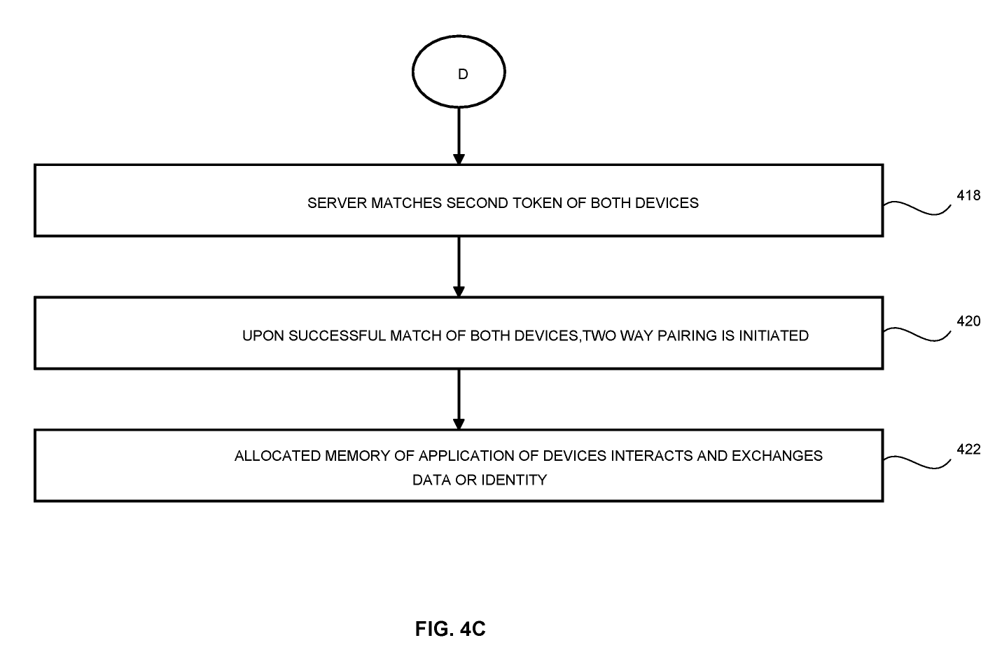

FIGS. 4A, 4B and 4C are a flowchart that illustrates a method for pairing two devices which can exchange identity, data or read an allocated memory space of each other, through the server 108 of FIG.1, according to an embodiment herein. In an example embodiment, in step 402, the users of two devices agree to pair the devices. In step 404, a first token for a location is obtained by a first user device 104 of FIG. 1. In step 406, the first user 102 of FIG. 1 of first user device 104 of FIG. 1 shares the first token to the second user 112 of FIG. 1 who has his actual or assumed location set to same as first token location or nearby within a threshold distance. In step 408,the second user 112 of FIG. 1 enters the first token in the second user device 110 of FIG. 1. In step 410, a random password, also being called the second token, is generated by the second user device 110 of FIG. 1. In step 412, the first user 102 of FIG. 1 enters the second token in the first user device 104 of FIG. 1 which is shared by the second user 112 of FIG. 1. In step 414, tokens of both the users are received by the server 108. In step 416 first token is matched by the server 108 as it is entered by users within threshold distance. In step 418, the second token of both devices is matched by the server 108, both the tokens of both the devices are cross matched. In step 420, the two devices are connected by the server 108 in a two way pairing mode as there is mutual agreement. In step 422, the interaction and exchange of data or identity between the allocated memory of application devices is made.

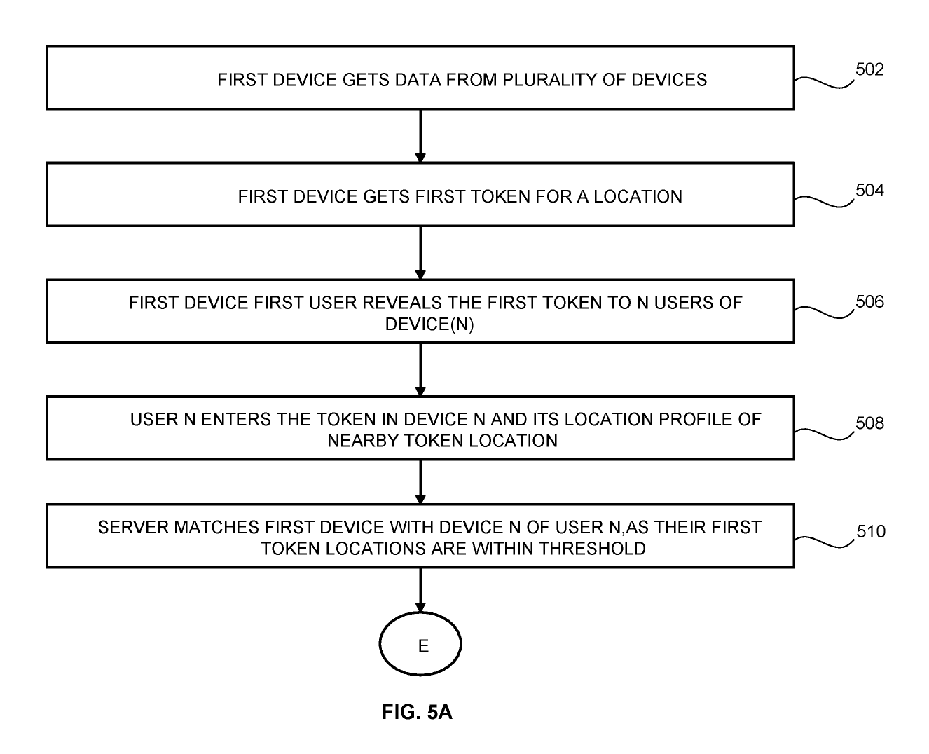

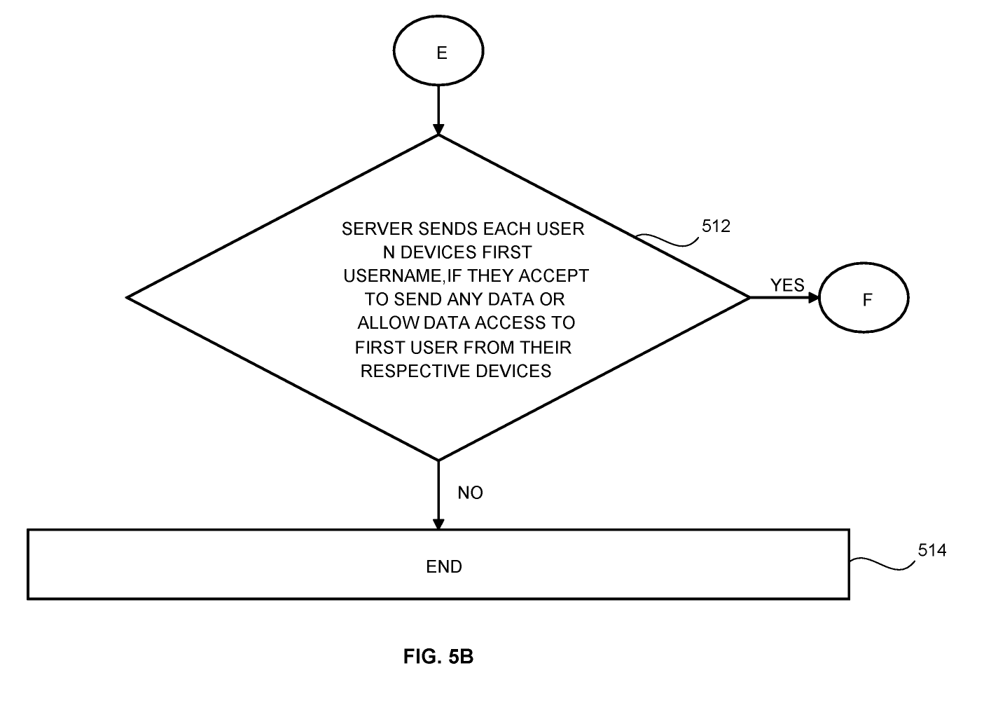

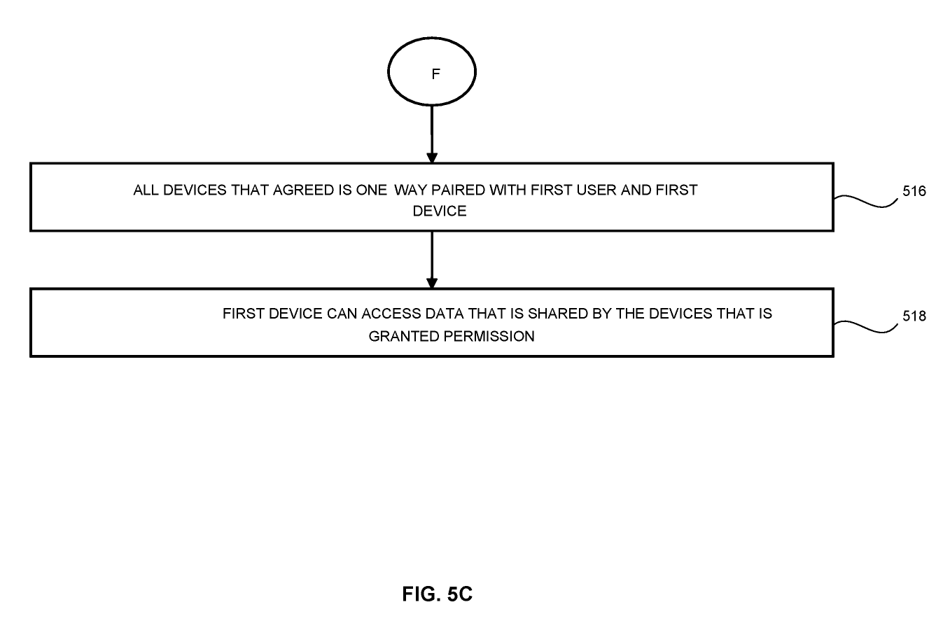

FIGS. 5A, 5B and 5C are a flowchart that illustrates a method for pairing one device with plurality of devices which can exchange identity, data or read an allocated memory space in a one-way paired mode, through the server 108 of FIG. 1, according to an embodiment herein. In an example embodiment, in step 502 the user of a device to pair with plurality of devices. In step 504, the first user device 104 of FIG. 1 gets a first token for a location. In step 506, the first user 102 of FIG. 1 of the first user device 104 of FIG. 1 shares the first token with the second user device N 110 of FIG. 1 or a plurality of such users (for example, a professor sharing his token with his class) whose location is set to same as the token location or nearby within a threshold distance. In step 508, the second user112 of FIG. 1 enters the token in the second user device 110 of FIG. 1. In step 510, the token of both users are matched by the server 108. In step 512, the server 108 sends second user 112 of FIG. 1 the notification with first user identifier for permission to pair with the first user 102. In step 514, the second user 112 of FIG. 1 may decline. In step 516, the second user 112 of FIG. 1 agrees for a one way pairing with the first user 102 of FIG. 1 and the first user device 104 of FIG. 1. In step 518, the server 108 of FIG. 1 connects the two devices in a one way pairing mode. There is one way agreement as the permission is only from second user 112 of FIG. 1 to access its allocated memory of application can interact and exchange data or identity with the first user 102 of FIG. 1, the first user device 104 of FIG. 1.

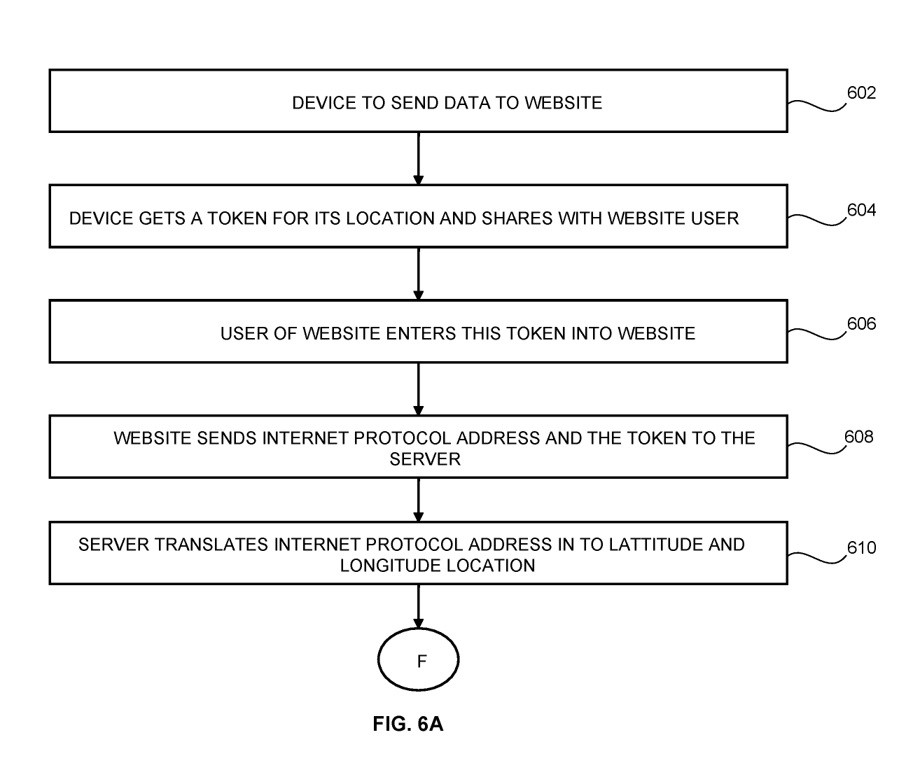

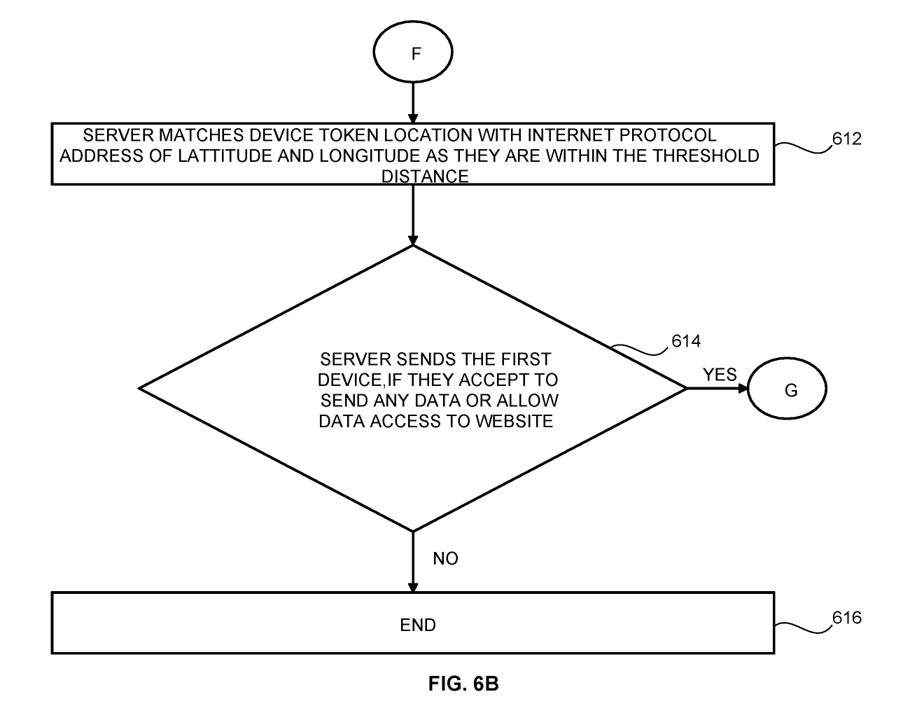

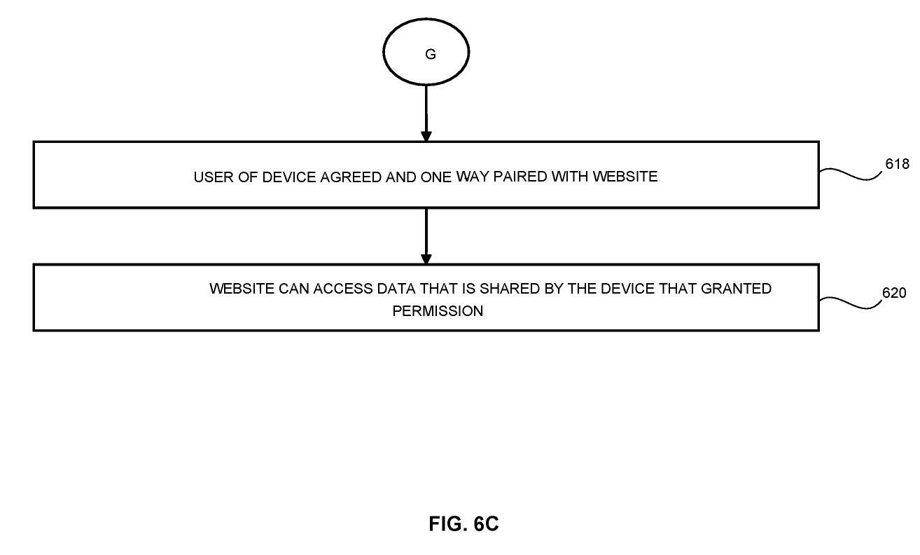

FIGS. 6A, 6B and 6C are a flowchart that illustrates a method for pairing a device with a website which can exchange identity, data or read allocated memory space in a one way paired mode, through the server 108 of FIG. 1. In an example embodiment, in step 602 a first user 102 of FIG. 1 intends to upload the data to the website which is interface of the second user 112 from the first user device 104 of FIG. 1. In step 604, the first user device 104 of FIG. 1 gets a token for a location and shares it with second user 112 of FIG. 1. In step 606, the second user 112 of FIG. 1 enters the token into the website session instance. In step 608, the website sends the token and internet protocol address to server 108. In step 610, the server 108 of FIG. 1 translates internet protocol address into the location. In step 612, the server 108 matches token of the website with first user 102 as they are in threshold distance. In step 614, the server 108 sends the first user device 104 of FIG. 1 the notification for permission to pair with the second user 112 of FIG. 1. In step 616, the first user device 104 of FIG. 1 may decline. In step 618, a one way pairing with the website is agreed by the first user 102 of FIG. 1. In step 620, the server 108 connects the website and the second user device 110 of FIG. 1 in a one way pairing mode. There is one way agreement as the permission is from first user device 104 of FIG. 1, so first user allocated memory can interact and send data to the website's session. This can easily be reversed wherein the token is generated at the website and then shared with the second user device 110 of FIG. 1, and then permission notification is sent to the website. Upon acceptance, the website session can send the data in a one-way flow to the device. In an embodiment, same person can be interacting with device as well as website interface, wherein same person is the first user 102 and the second user 112. In a related embodiment, the step 614 a notification to first user device 104 may include a permission to login to the website. Upon acceptance in first user device 104, the user is logged into the website which is second user interface, wherein username of user is sent to from the server 108 to correspond with the website session or IP address of the website instance.

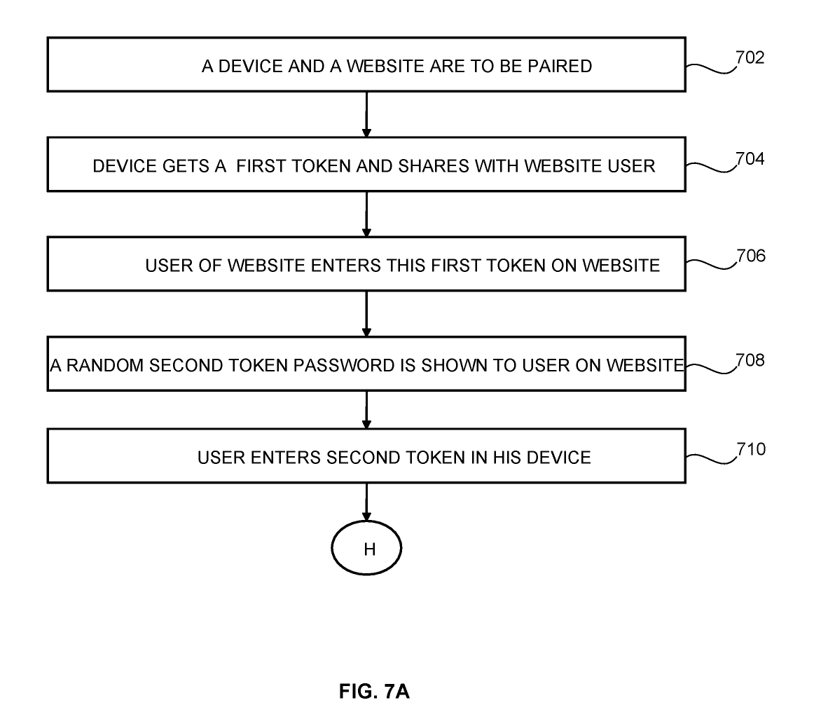

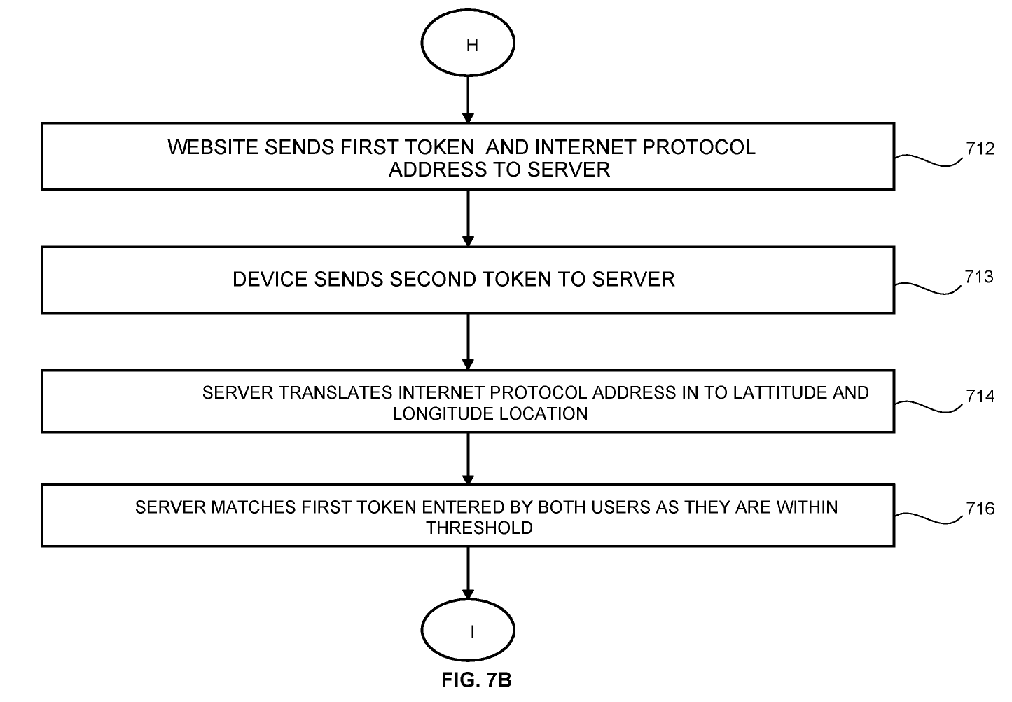

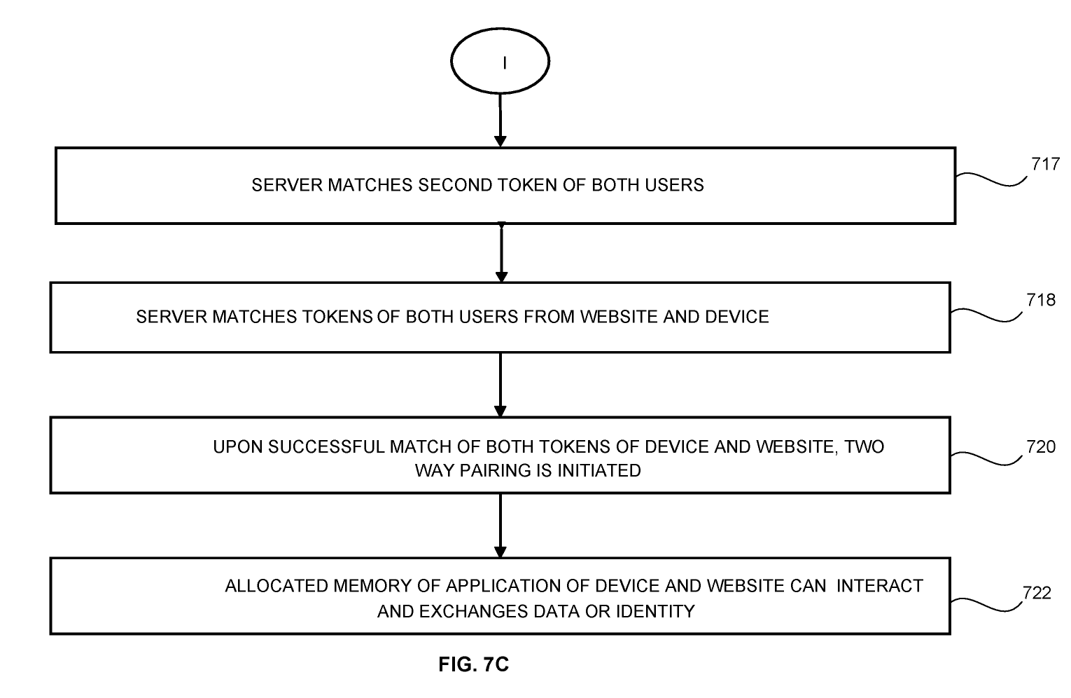

FIGS. 7A, 7B and 7C are a flowchart that illustrates a method for pairing a website session with a device which can exchange identity, data or read an allocated memory space of each other, through the server 108 of FIG. 1, according to an embodiment herein. Therefore this is a two way pairing. In an example embodiment, in step 702, the first user device 104 of FIG. 1, and the website session instance, being interface of second user, agree to pair. In step 704, the first user device 104 of FIG. 1 gets a first token for a location nearby where website is open on a computer. In step 706 the first user device 104 of FIG. 1 shares this token with the second user 112 of FIG. 1 and the second user 112 of FIG. 1 enters the token in the website. In step 708, a random password, also being called a second token, is generated by website and displayed. In step 710, the second user 112 of FIG. 1 enters the second token in the second user device 110 of FIG. 1 which is shared with him by the first user 102 of FIG. 1. In step 712, the server 108 receives first token and the internet protocol address from the website. In step 713, second token is sent to the server 108 by the device. In step 714, the server 108 translates the internet protocol address into the location. In step 716, the server 108 matches the first token of both users as they are in threshold distance. In step 717, second token of both users are matched by the server 108. In step 718, both tokens of both users are now cross matched. In step 720, the server 108 connects the website session and the device in a two way pairing mode as there is mutual agreement. In step 722, the allocated memory of application device and website can interact and exchange the data or identity. In one embodiment, when an approval is obtained from a user, it is a one-way pairing wherein only approving user is providing access, hence pairing is asymmetric. Whereas when second token or password is employed, the pairing can be a two-way or symmetric.

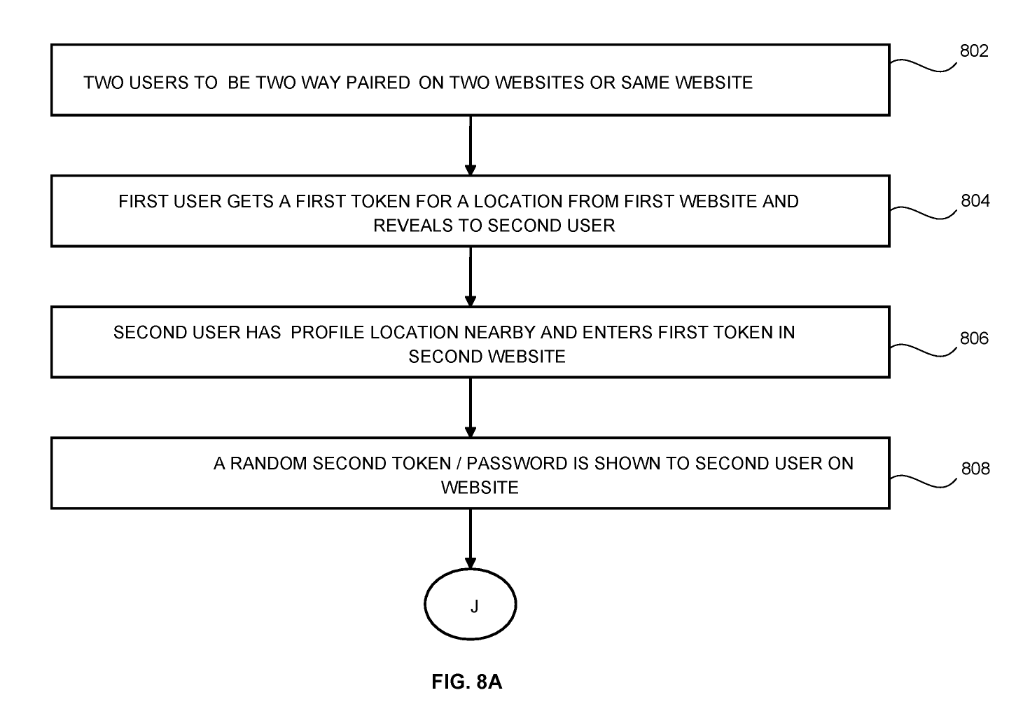

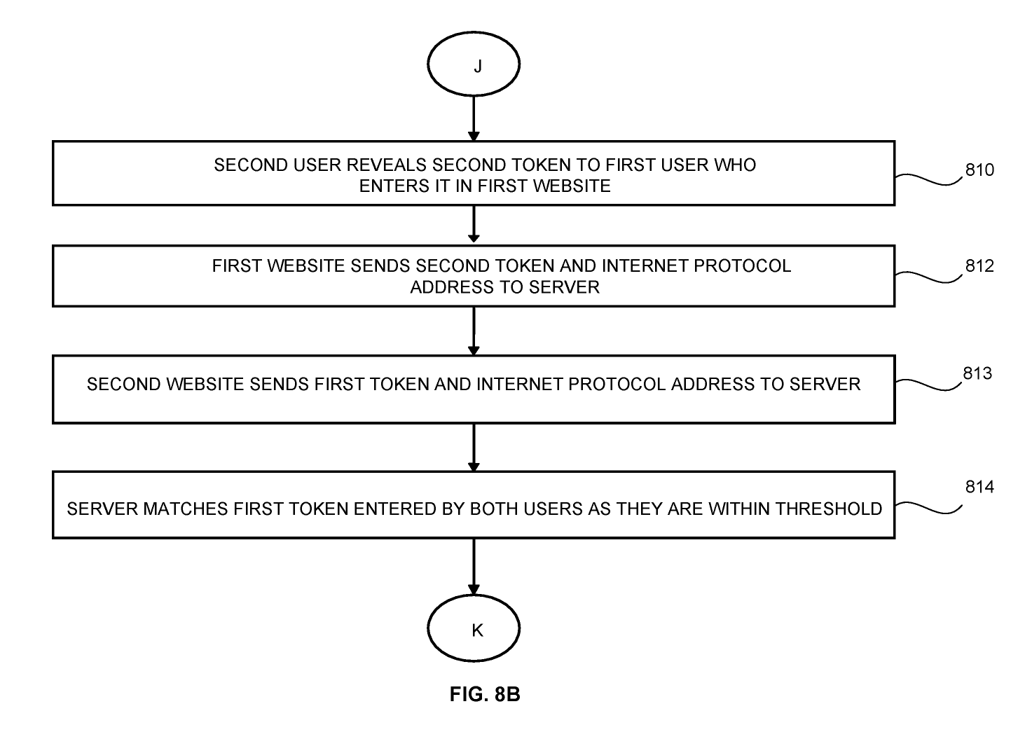

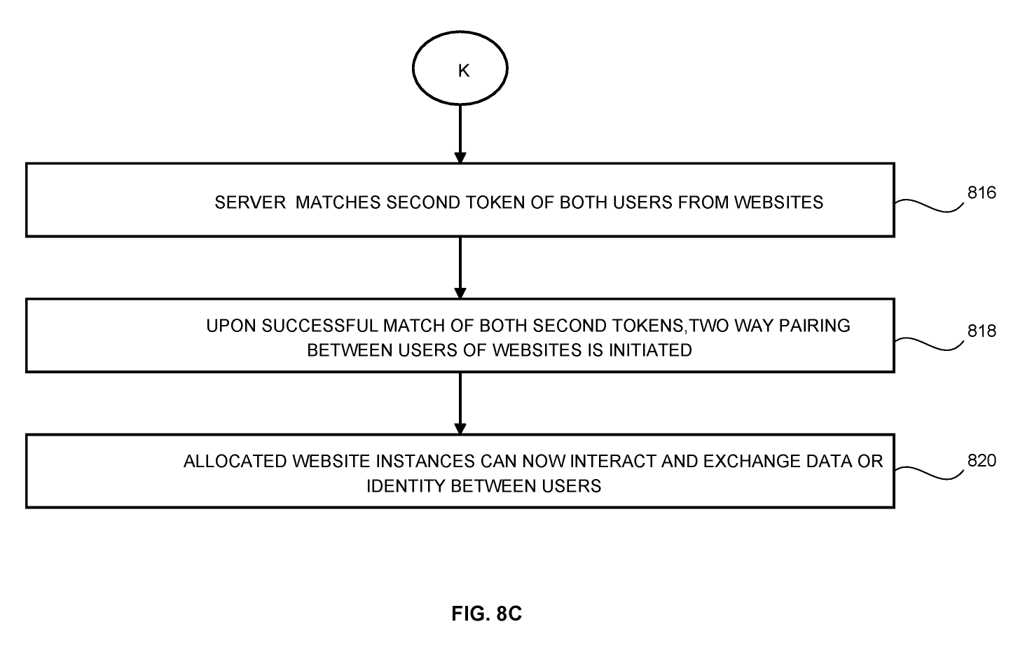

FIGS. 8A, 8B and 8C are a flowchart that illustrates a method for pairing a website session with another website session which can exchange identify, data or read allocated memory space of each other, through the server 108 of FIG. 1, according to an embodiment herein. In an example embodiment, in step 802 the users and two website sessions agree to pair. In step 804, a first user 102 of FIG. 1 gets a first token on computer, wherein its internet protocol address from the first website is sent to server 108, translated into location, then token is obtained for that location and reveals to the second user 112 of FIG. 1. In step 806, the second user 112 of FIG. 1 has the profile location set to nearby the location of the first user 102 of FIG. 1, then the first user 102 of FIG. 1 shares this token with the second user 112 of FIG. 1 of the second website. The second website may be another instance of the same website or another instance of another website. The second user 104 of FIG. 1 enters the token in the second website. In step 808, a random password, also being called second token, is generated by the website and displayed. In step 810, the first user 102 of FIG. 1 enters the second token in the first website which is shared with him by the second user 112 of FIG. 1. In step 812, the server 108 receives second token and internet protocol address of first website session. In step 813, first token and internet protocol address is sent to the server 108 of FIG. 1 by the second website session. In step 814, the server 108 matches first tokens of both users as they are in the threshold distance. In step 816, the server 108 matches the second token of both the users, hence both the tokens of both the users are cross matched. In step 818, the server 108 connects the website session of first user 102 of FIG. 1 and the website session of second user 112 of FIG. 1 in a two way pairing mode as there is mutual agreement. For example, now they can initiate a chatting session. In step 820, the allocated memory of application device and website can now interact and exchange the data or identity.

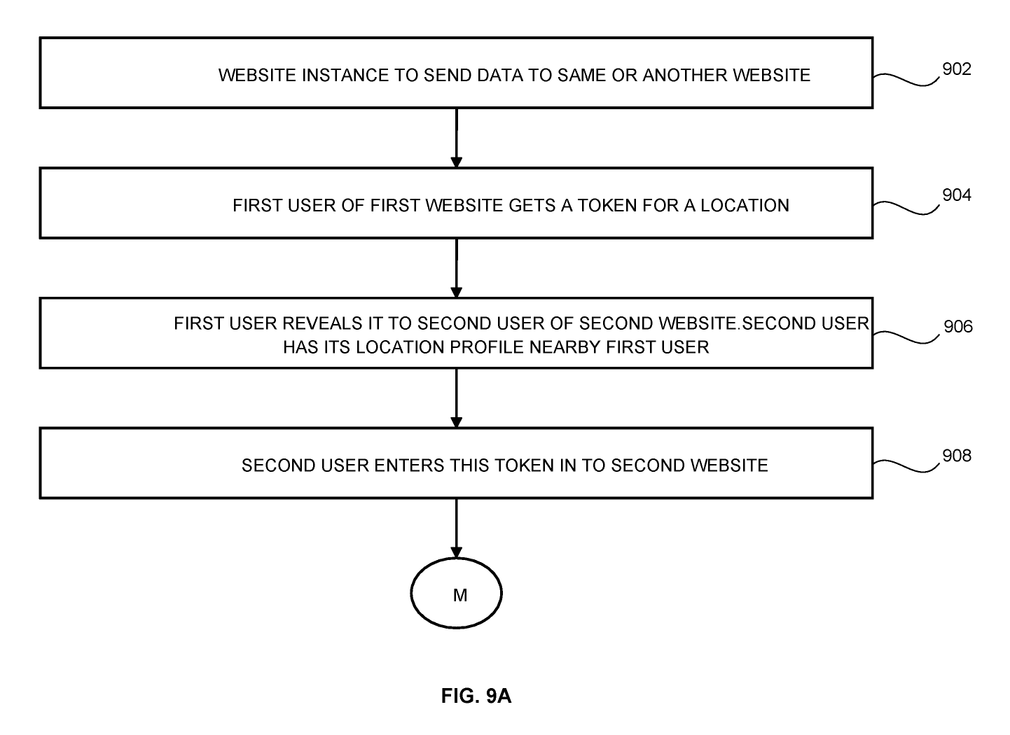

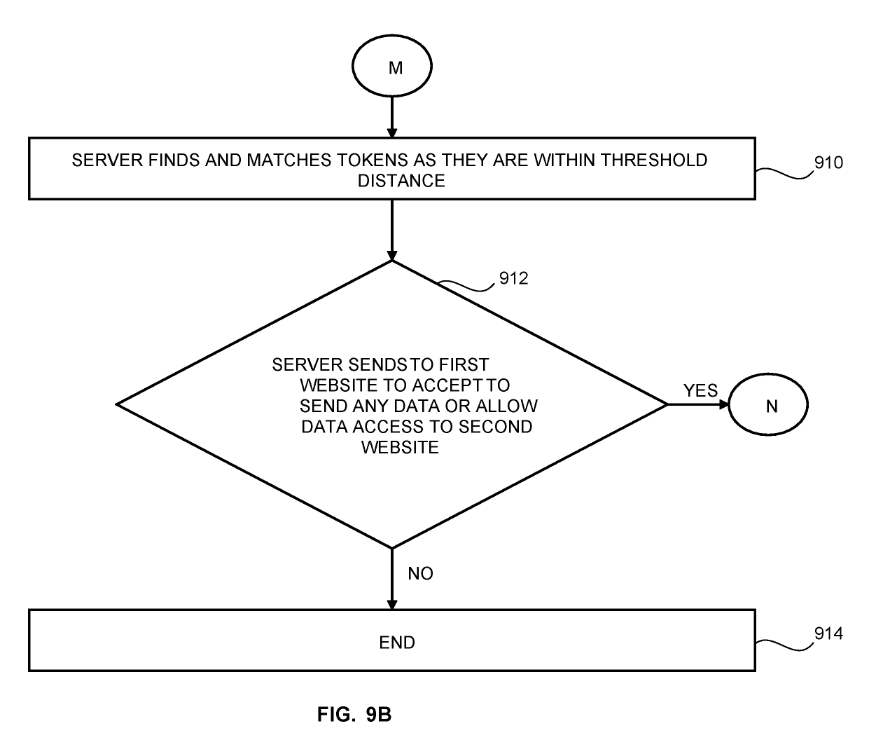

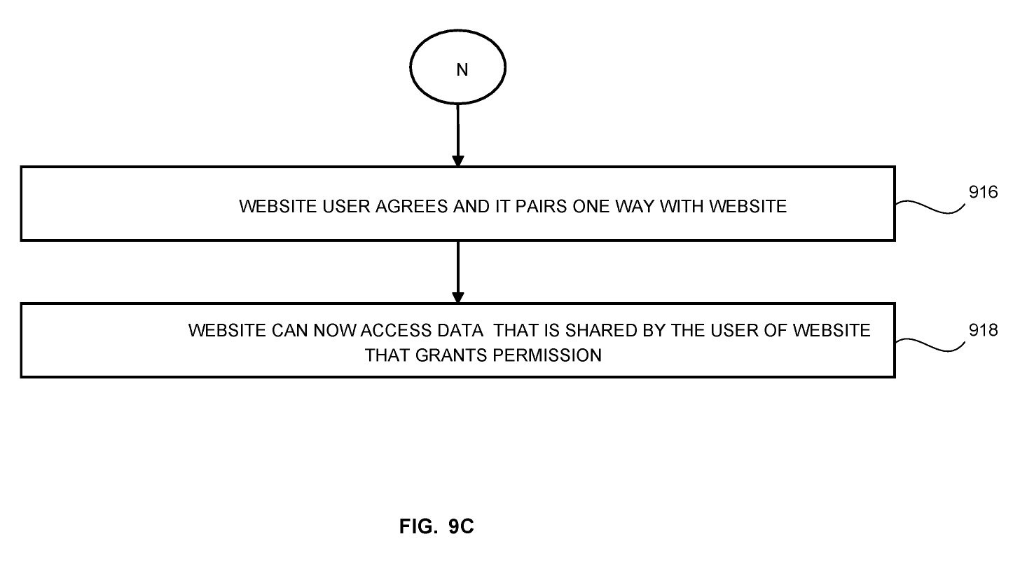

FIGS. 9A, 9B and 9C are a flowchart that illustrates a method for pairing a website with another website which can exchange identity, data or read an allocated memory space of in a one way paired mode, through the server 108 of FIG. 1, according to an embodiment herein. In step 902, the user of the website session agrees to pair to another session of the website. In step 904, a first user 102 of FIG. 1 gets a token, wherein its internet protocol address of first website gets translated into a location and token is obtained, or it may get it directly for a location for example by interacting with a map interface. In step 906, the first user 102 of FIG. 1 shares the token with the second user 112 of FIG. 1 who has his assumed location nearby the location associated with first user 102 of FIG. 1 token. In step 908, the second user 112 of FIG. 1 enters this token into the second website. In step 910, the server 108 finds and matches tokens as they are within threshold distance. In step 912, the server 108 of FIG. 1 sends to the first website accepts to send any data or allow data access to second website. In step 914, the first user device 104 of FIG. 1 user may decline. In step 916, website user agrees and it pairs one way with website. In step 918, website can now access data that is shared by the user of website that grants permission in 912.

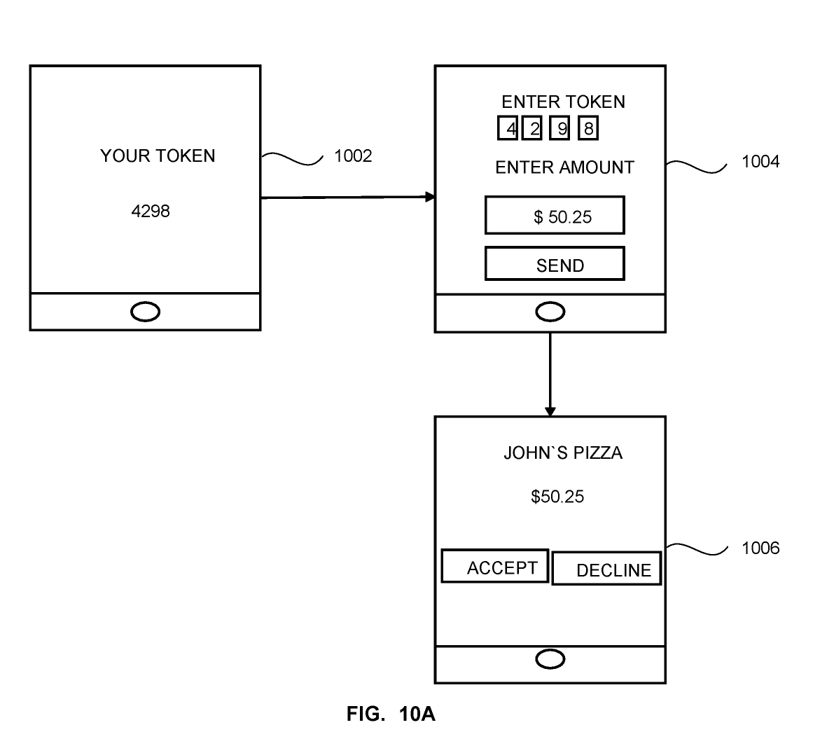

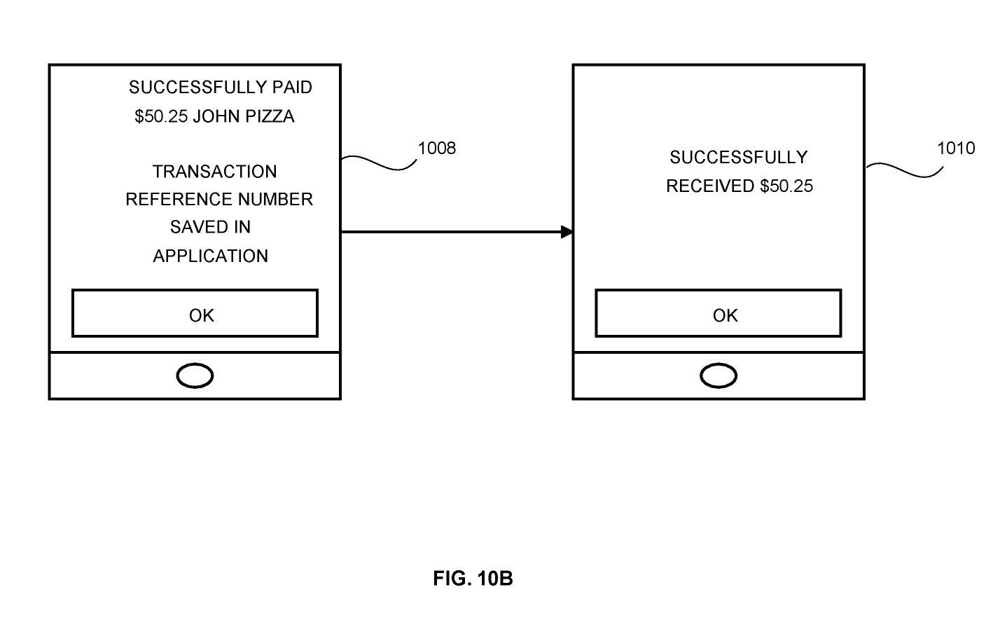

FIGS. 10A and 10B are user interface views of a location specific token generated by using a method such that identical tokens can be used by several users simultaneously through a server 108 of FIG.1, according to an embodiment herein. In an example embodiment, in step 1002, the token is generated in a payer device 104 of FIG. 1 to transfer the funds. In step 1004, the token is entered into a payee device 114, the token can be a four digit numeric or alpha-numeric code. In step 1006, the payer 102 of FIG. 1 receives the name of payee 112 of FIG. 1 and amount. The payer 102 of FIG. 1 can accept or decline the received information. In step 1008, upon the payment of the amount by the payer 102 of FIG. 1 to the payee 112 of FIG. 1, the payer 102 of FIG. 1 receives a transaction reference number on processing the transaction. The transaction reference number is saved in the application. In step 1010, upon the payment of the amount by the payer 102 of FIG. 1 to the payee 112 of FIG. 1, the payee device 110 of FIG. 1 receives a successful transaction message. However, in an embodiment the token flow can be reversed, that is, a token can be passed from payee 112 to payer 102. In an embodiment, the options of token flow may be present, payer 102 to payee 112 and payee 112 to payer 102 and it is for the payer 102 and payee 112 to decide how they prefer to transact. In an embodiment amount may be entered by payer 102. In an embodiment, amount is entered by a payee 112. When amount is entered by payee 112, payer 102 approves it by interacting with an approval notification. When amount is entered by payer 102, the amount is approved by payee 112. In an embodiment the amount is entered by payer 102, the payer 102 may still have to approve a payee identifier by interacting with an approval notification. In an embodiment, amount is entered by payer 102 and payee 112; the amount of payer 102 and payee 112 is matched in that case, as it acts and a second token, for transaction to process.

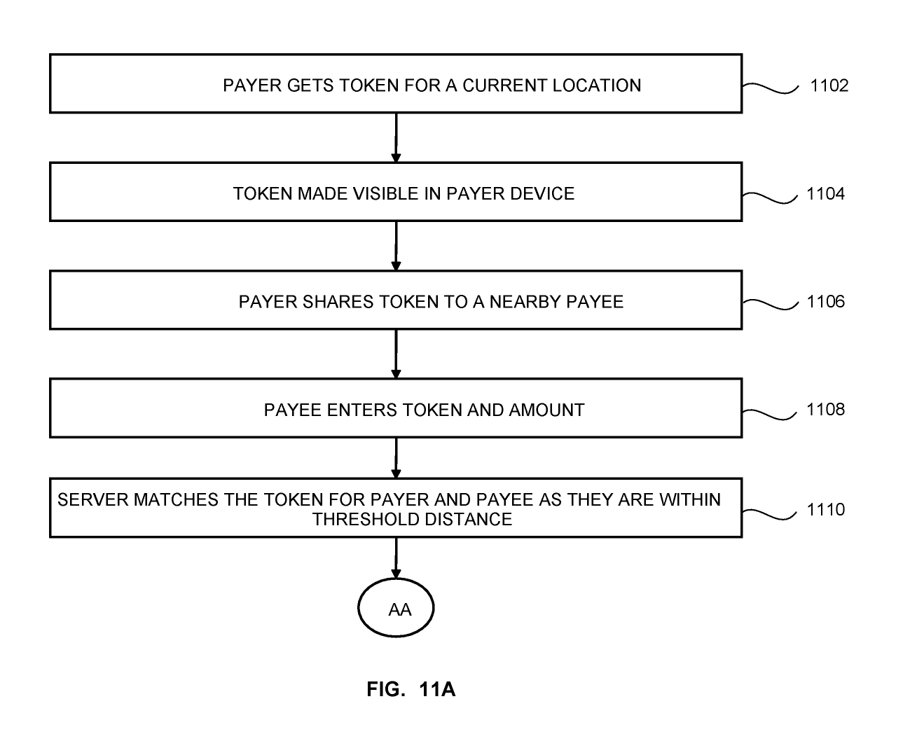

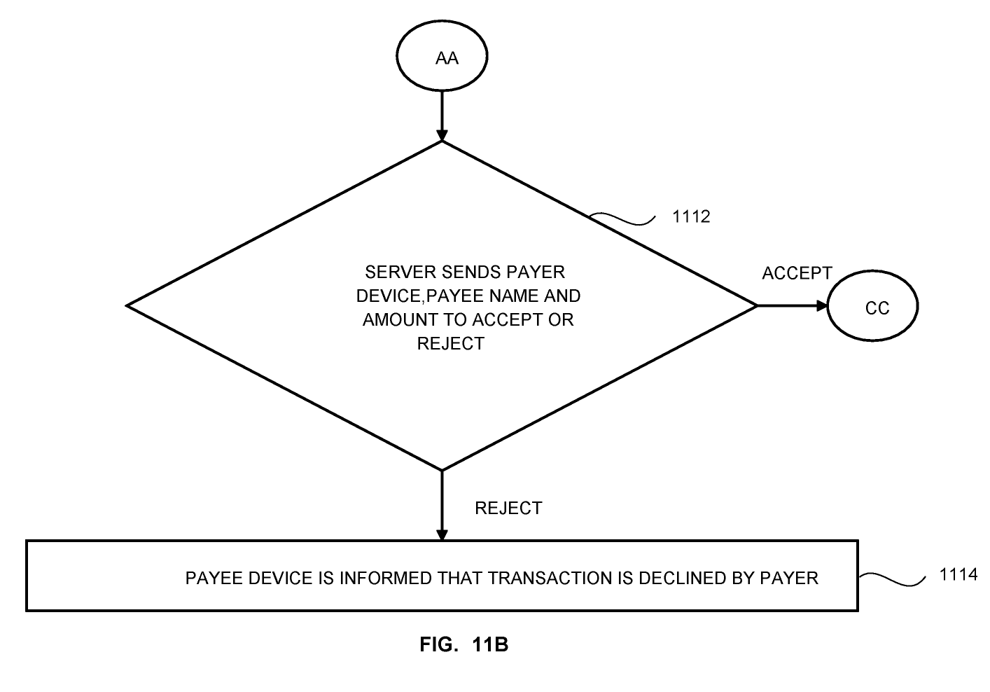

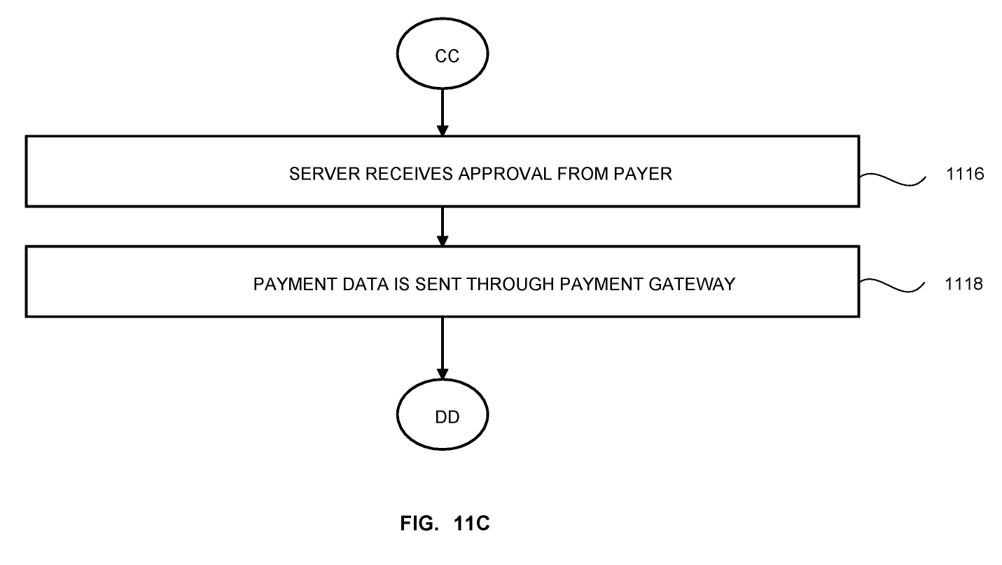

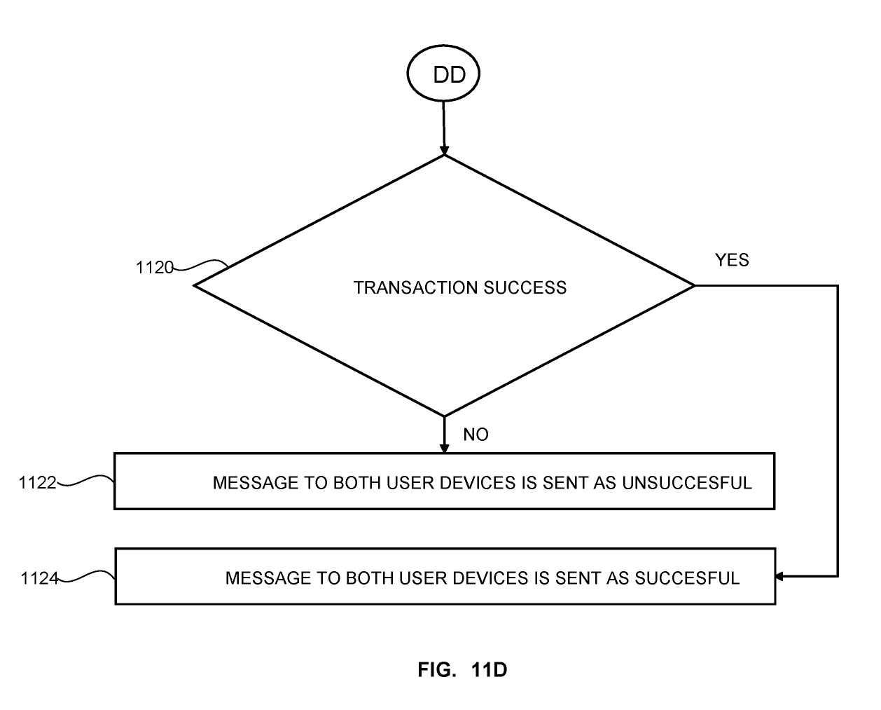

FIGS. 11A, 11B, 11C and 11D are a flowchart that illustrates a method of payment by a nearby payee 112 to a payer 102 through the server 108 of FIG. 1, according to an embodiment herein. In an example embodiment, in step 1102, the payer 102 of FIG. 1 requests a token for a current location. In step 1104, the token is displayed in a payer device 104 of FIG. 1. In step 1106, the payer 102 of FIG. 1 shares the token to the payee 112 of FIG. 1 nearby. In step 1108, the Payee 112 of FIG. 1 enters the token and an amount in the payee device 110 of FIG. 1. In step 1110, the server 108 matches the payer 102 of FIG. 1 and the payee 112 of FIG. 1 on the basis of the same token association and being within threshold distance. In step 1112, the server 108 sends the payer 102 of FIG. 1, notification to accept or decline the payment. This request is processed, in preferred embodiment, though not a requirement, only if the application is already open in the payer device 104 of FIG. 1. In step 1114, the request is declined and the payer device 104 of FIG. 1 is informed that the payment is declined by the payer 102 of FIG. 1. In step 1116, the request is accepted, and the server 108 receives approval from the payer 102 of HU. 1. In step 1118, the payment request is sent through payment gateway to process the transaction. In step 1120, the outcome of the payment is received from the gateway that may connect to banks, an accounting system or a crypto currency (e.g. bit coin) escrow system. In the step 1122, a message is communicated to the payer device 104 and the payee device 110 indicating that the transaction is unsuccessful. In the step 1124, a message is communicated to the payer device 104 and the payee device 110 indicating that the transaction is successful. In an embodiment the payer 102 or payee 112 or both are securely logged into their respective devices or interfaces: Upon login, the server 108 can access the user's account details, such as account balance, or bank account details, or credit or debit card details. However, in an embodiment a login may not be necessary wherein account balance is associated to the device and not the user. In an embodiment credit available to a payer 102 can be sent to a device by a server 108 to compare with amount of transaction to determine outcome of a transaction, and updated credit available is reported back to the server 108.

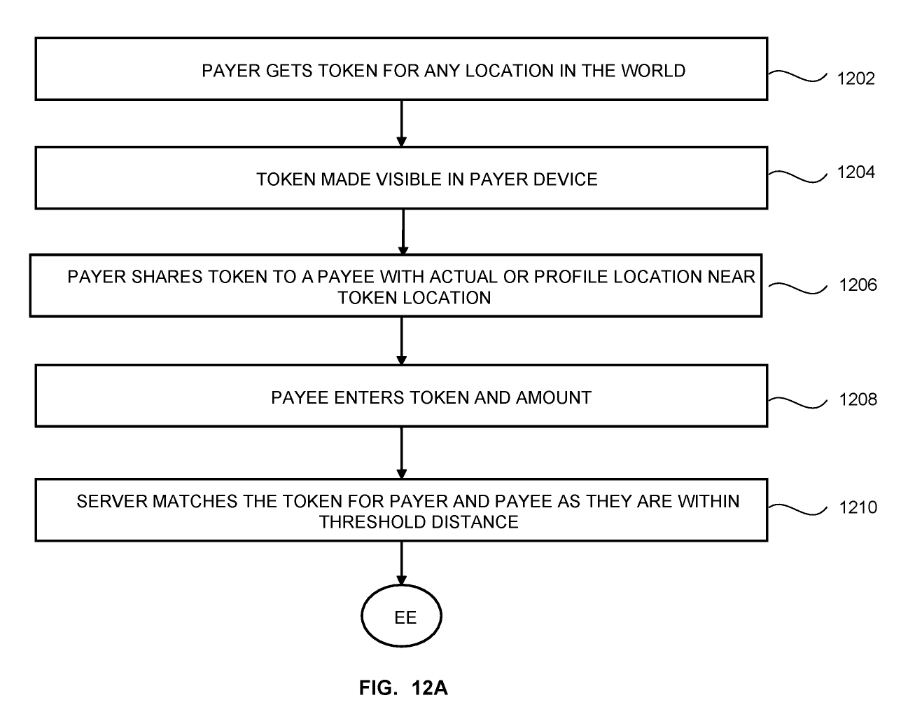

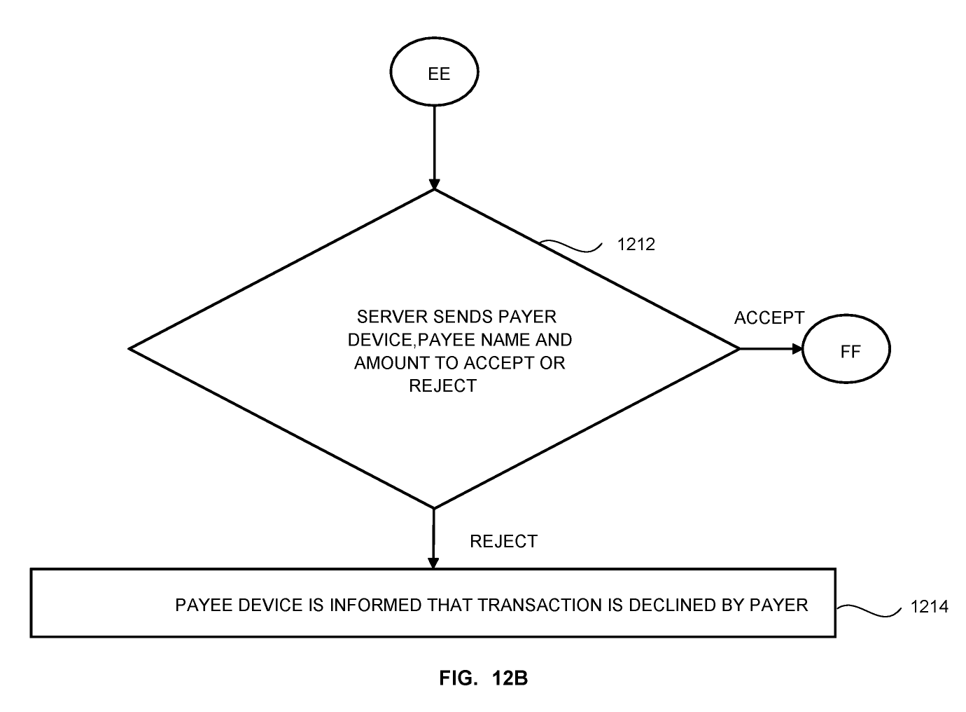

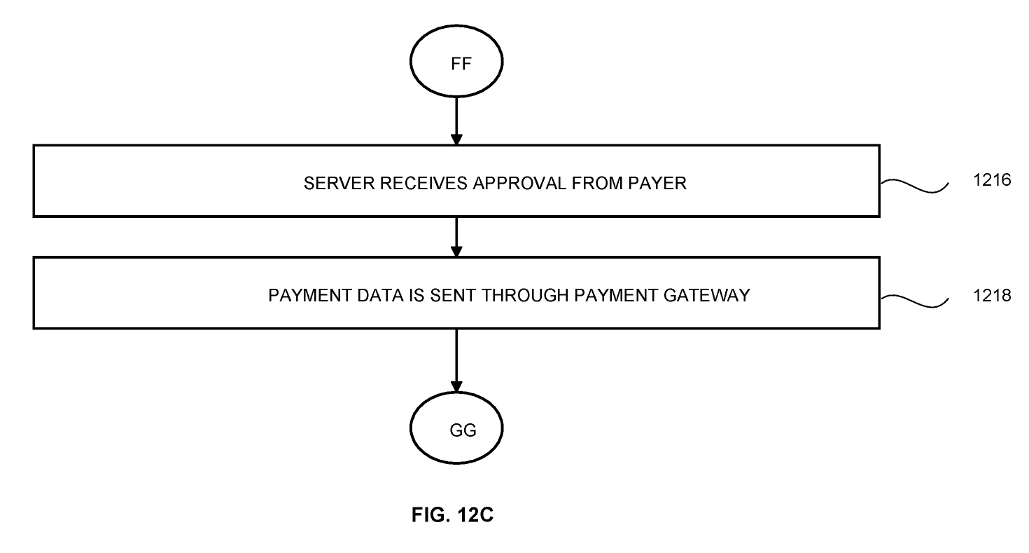

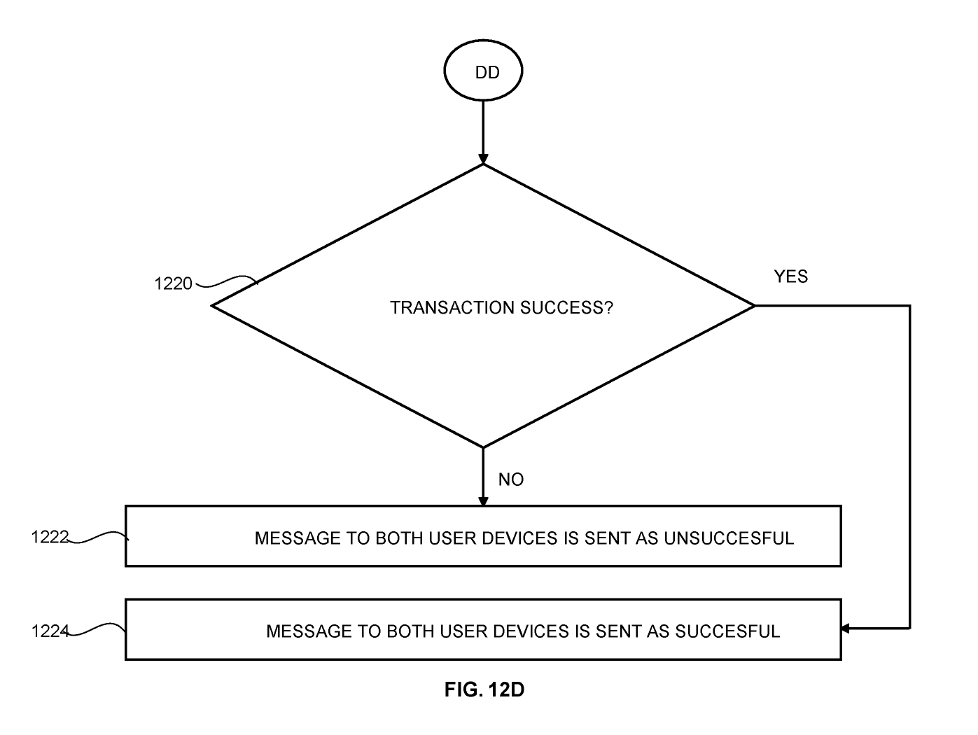

FIGS. 12A, 12B, 12C and 12D are a flowchart that illustrates a method of payment to a payer 102 by a payee 112 and the payee 112 gets token from any location in the world through the server 108 of FIG. 1, according to an embodiment herein. In an example embodiment, in step 1202, the payer 102 of FIG. 1 requests a token for a location in the world that may be a location remote to payer's current location. In step 1204, the token is displayed in a payer device 104 of FIG. 1. In step 1206, the payer 102 of FIG. 1 shares the token to the payee 112 of FIG. 1 whose location or a profile location is nearby the location associated with payer 102 of FIG. 1. In step 1208, the payee 112 of FIG. 1 enters the token and an amount in the payee device 110 of FIG. 1. In step 1210, the server 108 matches the payer 102 of FIG. 1 and the payee 112 of FIG. 1 on the basis of the same token association and being within threshold distance. In step 1212, the server 108 sends the payer 102 of FIG. 1, a notification to accept or decline the payment. This request is processed, in preferred embodiment, though not a requirement, only if the application is already open in the payer device 104 of FIG. 1. In step 1214, the request is declined and the payee device 110 of FIG. 1 is informed that the payment is declined by the payer 102 of FIG. 1. In step 1216, the request is accepted, and the server 108 receives approval from the payer 102 of FIG. 1. In step 1218, the payment request is sent through payment gateway to process the transaction. In step 1220, the outcome of the payment is received from the gateway that may connect to banks, an accounting system or a crypto currency (e.g. bit coin) escrow system. In the step 1222, a message is communicated to the payer device 104 and the payee device 110 indicating that the transaction is unsuccessful. In the step 1224, a message is communicated to the payer device 104 and the payee device 110 indicating that the transaction is successful.

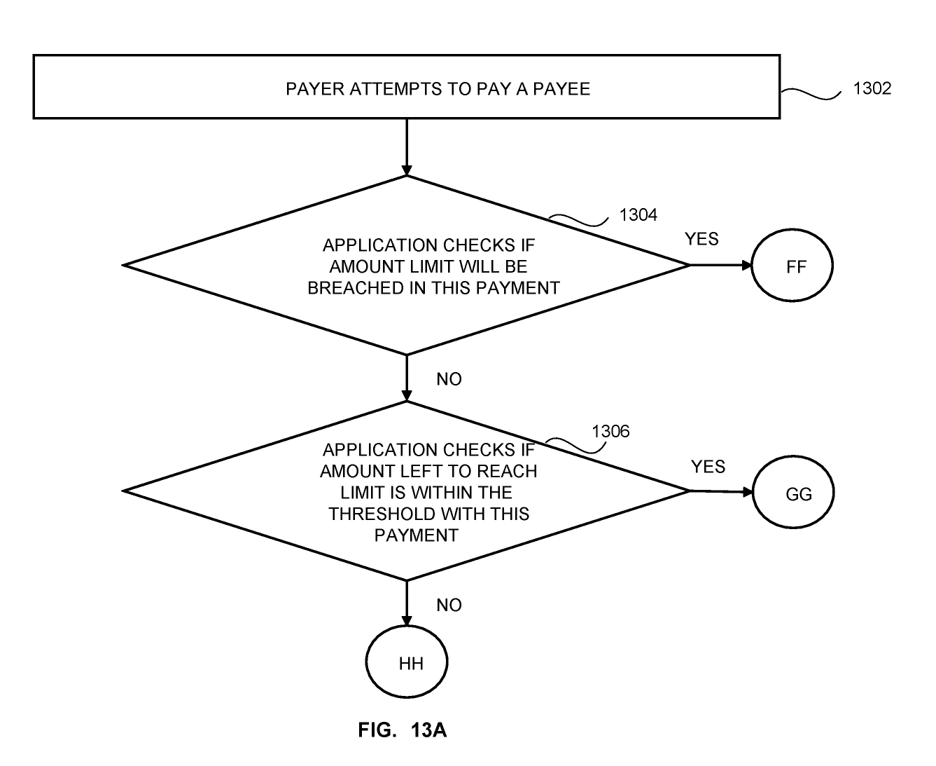

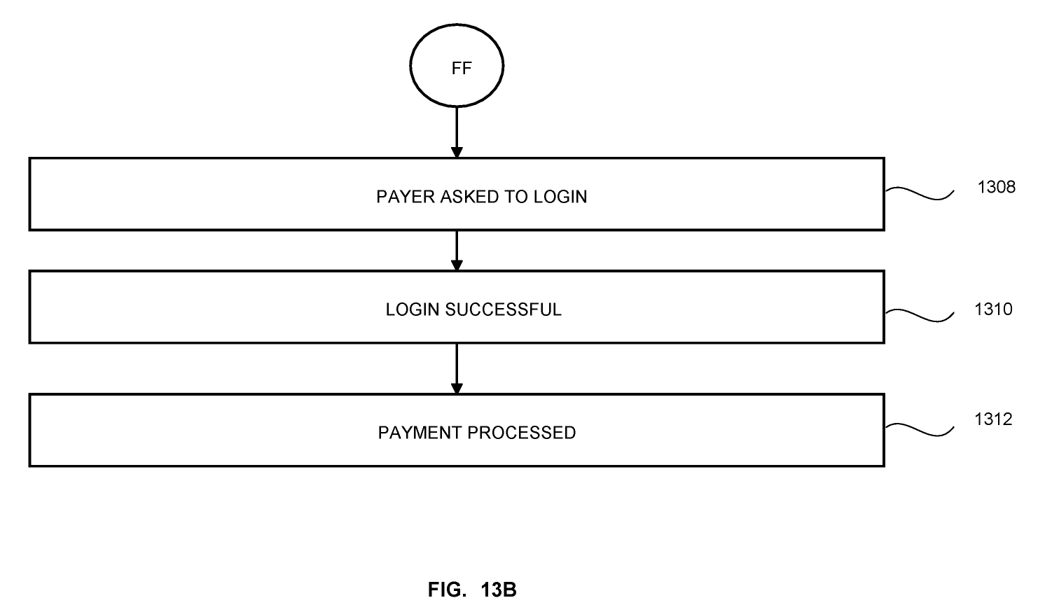

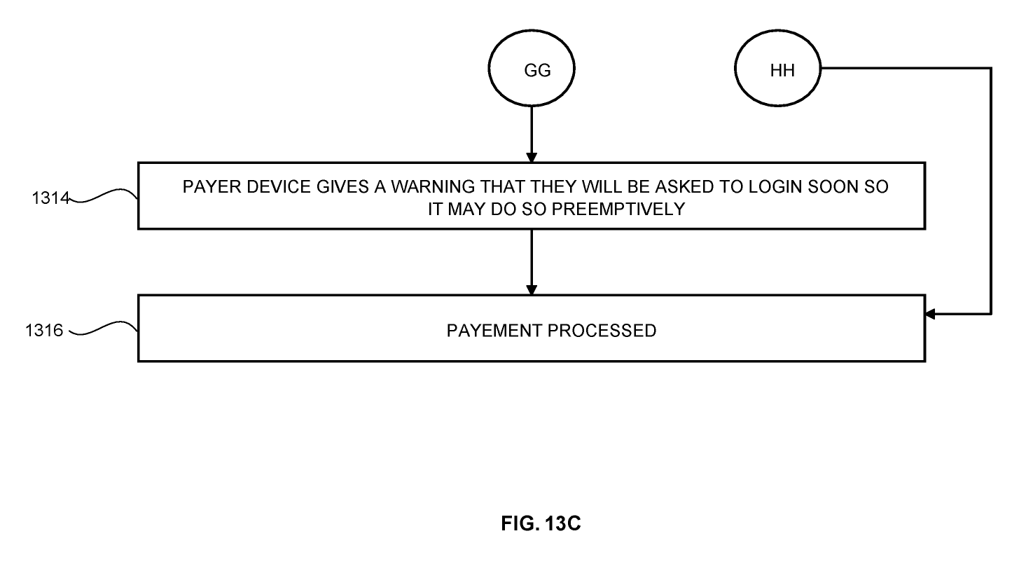

FIGS. 13A, 13B and 13C are a flowchart that illustrates a method for secure payment through the server 108 of FIG. 1, in the event of a payer device 104 or a payee device 110 is lost, according to an embodiment herein. In an example embodiment, in step 1302, the payer 102 of FIG. 1 attempts to make a payment to payee 112 of FIG. 1. In step 1304, the application checks if this payment will breach the spend limit that is set in payer 102 of FIG. 1 profile. In step 1306, the application checks if the amount left to breach spend limit will be within a threshold set by payer 102 of FIG. 1 in his profile. In step 1308, if the payment amount is going to breach the spend limit the payer 102 of FIG. 1 cannot proceed with payment unless he logs into the application. In step 1310, the server 108 confirms if the login is successful. In step 1312, the payment gets processed. In step 1314, the payer device 104 of FIG. 1 gives a warning that payer 102 of FIG. 1 will be asked to login soon, so it may do pre-emptively to reset the balance amount left to spend back to its maximum spend limit before next login will become due. In the step 1316, the payment is processed.

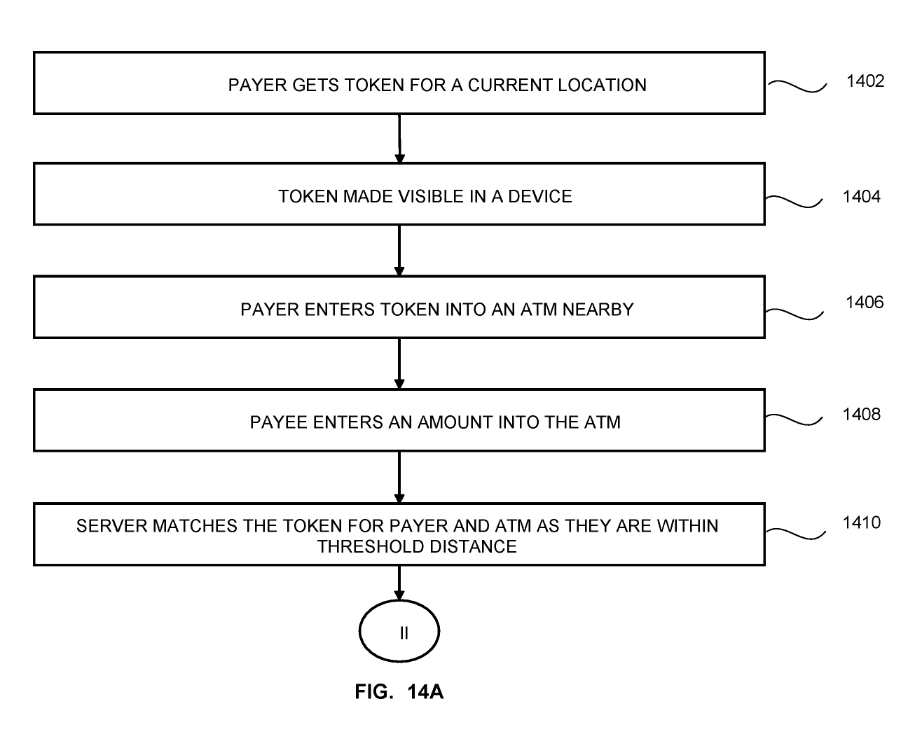

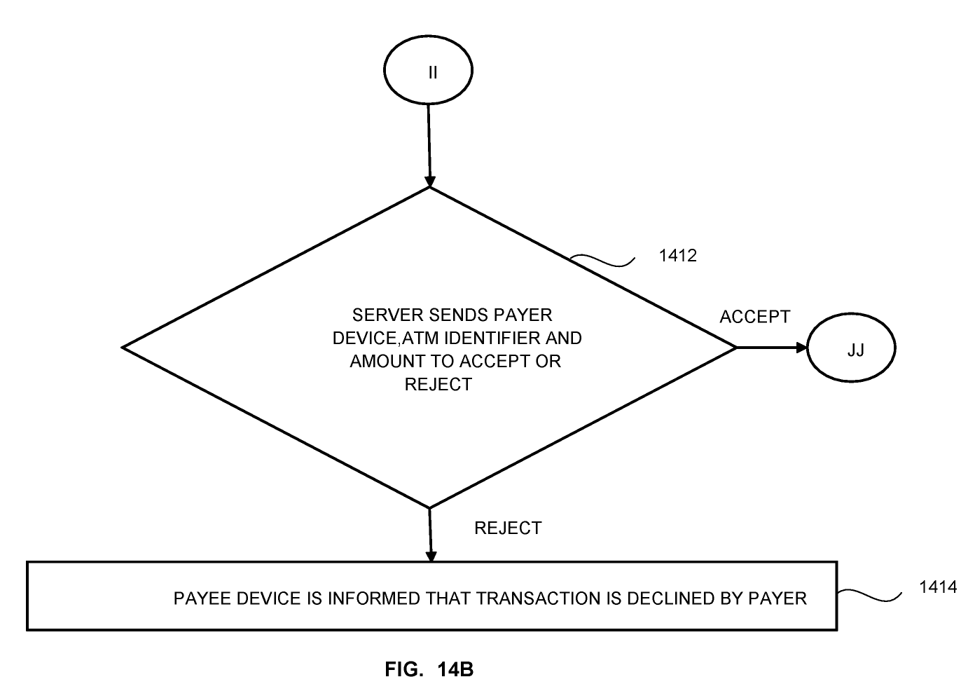

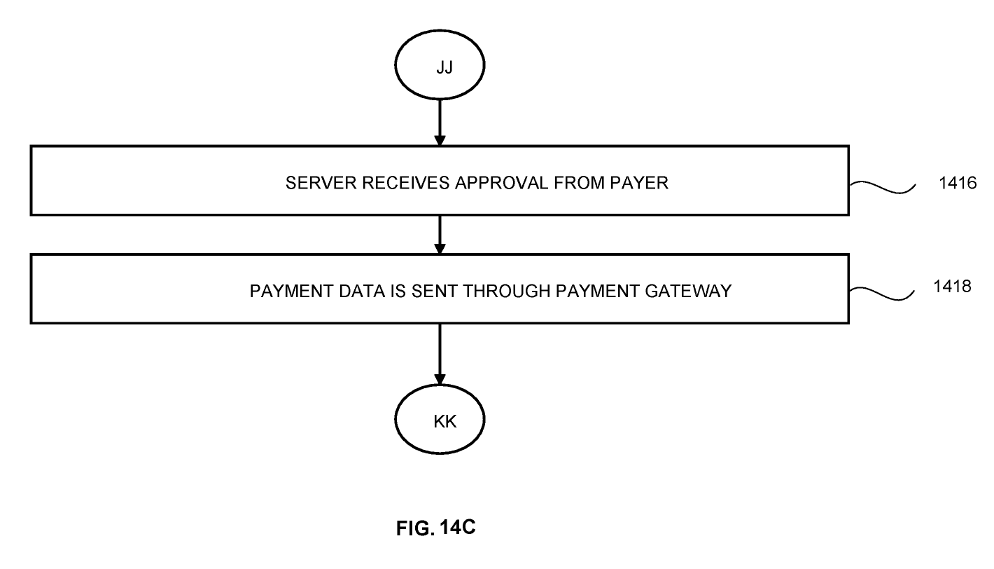

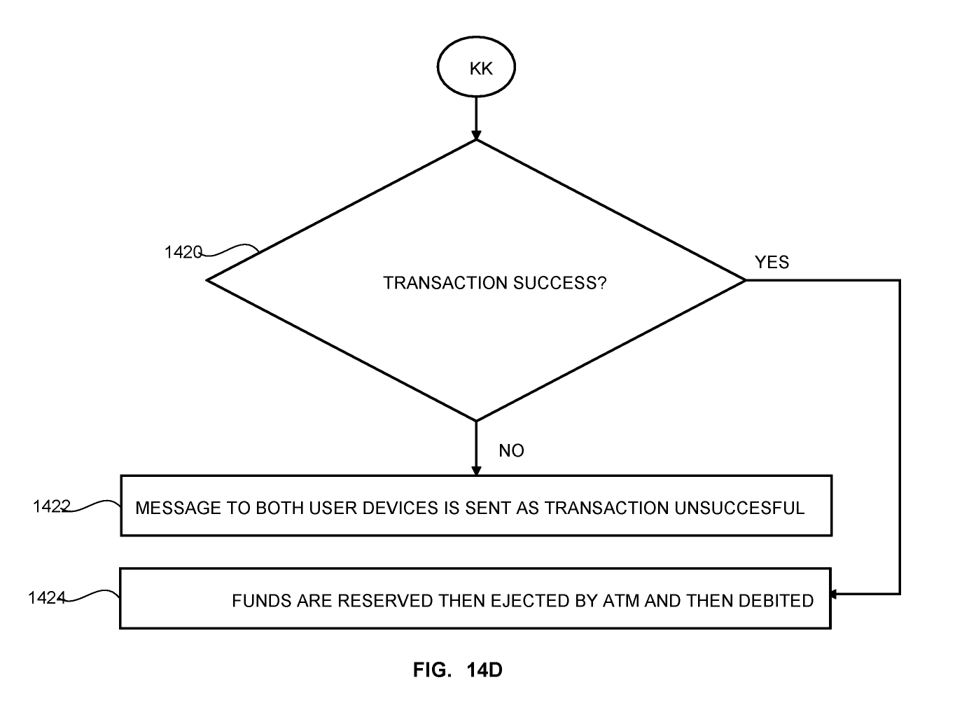

FIGS. 14A, 14B, 14C and 14D are a flowchart that illustrates a method of payment to a payee 112 through an ATM from payer's account with the server 108 of FIG. 1, according to an embodiment herein. In an example embodiment, in step 1402, the payer 102 of FIG. 1 requests a token for a current location. In step 1404, the token is displayed in a payer device 104 of FIG. 1. In step 1406, the payer 102 of FIG. 1 enters the token into the ATM. In step 1408, the payee 112 of FIG. 1 enters the token and an amount in the ATM. In step 1410, the server 108 matches the payer 102 of FIG. 1 and the ATM on the basis of the same token association and being within threshold distance. In step 1412, the server 108 sends the payer device 104 of FIG. 1 notification to accept or decline the payment. In step 1414, the request is declined and the ATM or its owner is informed that the payment is declined by the payer 102 of FIG. 1 who is trying to withdraw funds from ATM. In step 1416, the request is accepted, and the server 108 receives approval from the payer 102 of FIG. 1. In step 1418, the payment request is sent through payment gateway to process the transaction. In step 1420, the outcome of the payment is received from the gateway that may connect to banks, an accounting system or a crypto currency (e.g. bit coin) escrow system. In the step 1422, a message is communicated to the payer device 104 and the ATM device indicating that the transaction is unsuccessful. In the step 1424, upon successful reservation of funds, cash is made accessible to payer 102 of FIG. 1 by the automatic teller machine, upon successful delivery of cash the transaction process is completed by the server 108 of FIG. 1.

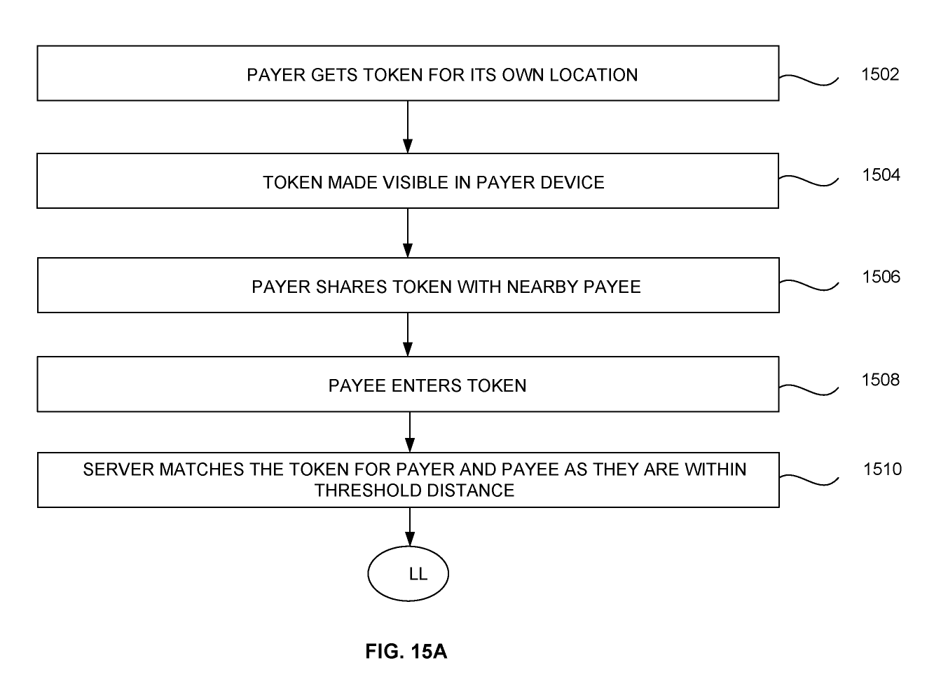

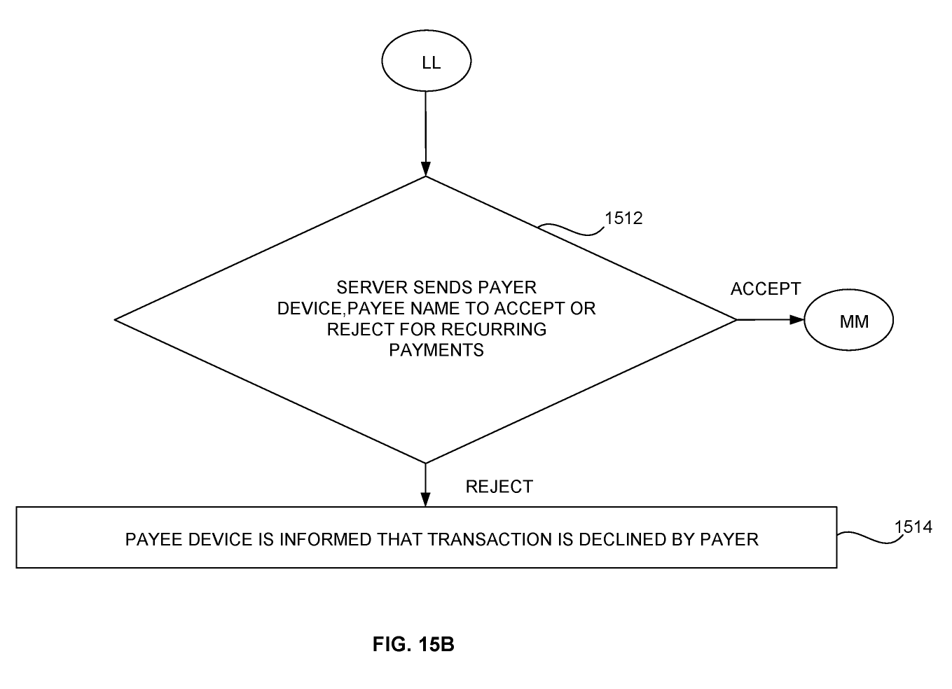

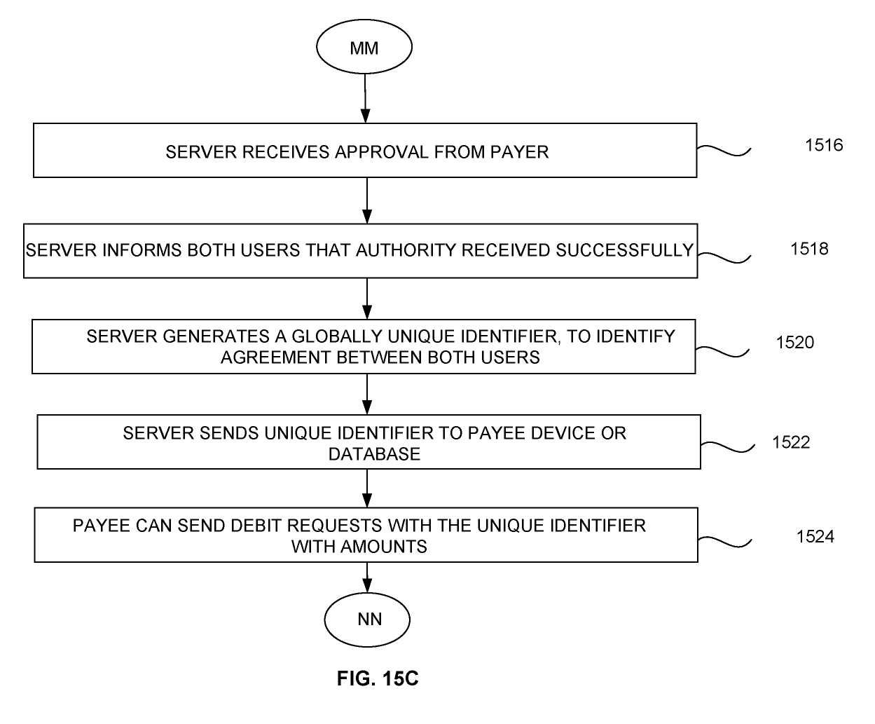

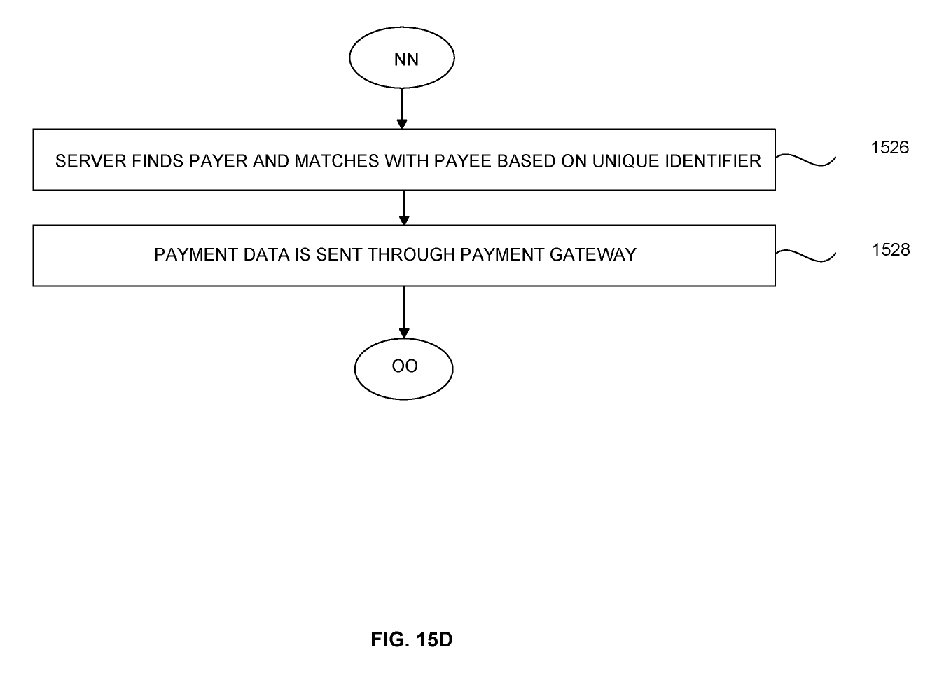

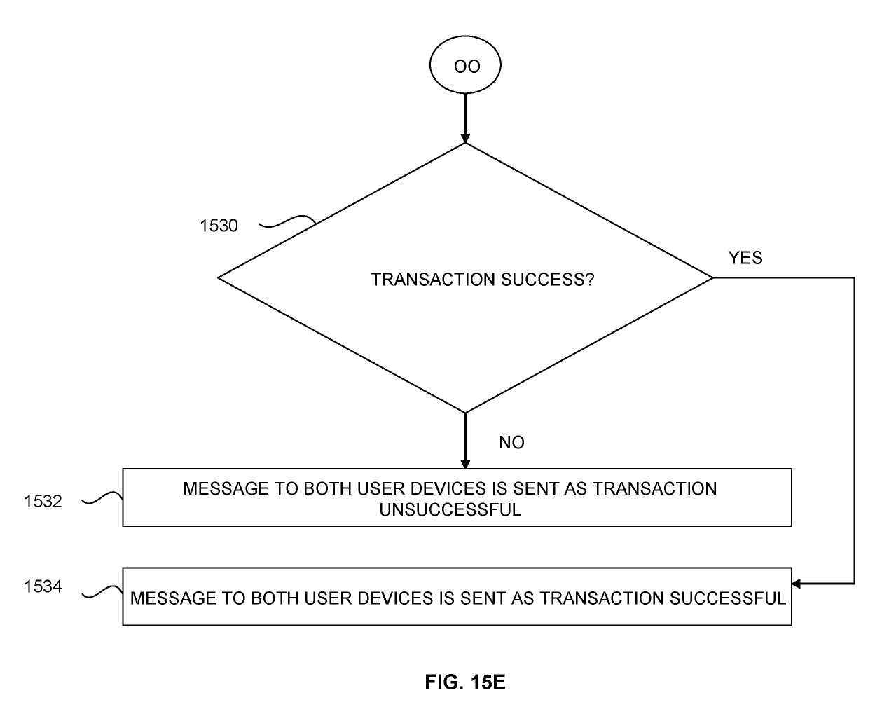

FIGS. 15A, 15B, 15C, 15D and 15E are a flowchart that illustrates a method of paying recurring payments to a payer 102 by payee 112 where they reach agreement while they are nearby through the server 108 of FIG. 1, according to an embodiment herein. In an example embodiment, in step 1502, the payer 102 of FIG. 1 requests a token for its own location. In step 1504, the token is displayed in a payer device 104 of FIG. 1. In step 1506, the payer 102 of FIG. 1 shares the token to the payee 112 of FIG. 1 nearby. In step 1508, the payee 112 of FIG. 1 enters the token. In step 1510, the server 108 matches the payer 102 of FIG. 1 and the payee 112 of FIG. 1 on the basis of the same token association and being within threshold distance. In step 1512, the server 108 sends the payer device 104 of FIG. 1 notification to accept or decline the recurring payments. This request is processed, in preferred embodiment, though not a requirement, only if the application is already open in the payer device 104 of FIG. 1. In step 1514, the request is declined and the payee 112 of FIG. 1 is informed that the payment authority is declined by the payer 102 of FIG. 1. In step 1516, the request is accepted, and the server 108 receives approval from the payer 102 of FIG. 1. In step 1518, both the users are informed by the server 108 that the authority is received successfully. In step 1520, a globally unique identifier is generated by a sever 108, to identify agreement between both the users. In step 1522, the unique identifier is sent by the server 108 to payee device 110 of FIG. 1 or a payee's database where payee stores its customer contact information. In step 1524, the payee 112 of FIG. 1 can send debit requests to server 108 with the unique identifier with amounts. In step 1526, the server 108 finds the payer 102 of FIG. 1 and matches with the payee 112 of FIG. 1 based on unique identifier and also confirms that the debit request is originating from a device or a computer that is associated with payee 112. In step 1528, the payment request is sent through payment gateway to process the transaction. In step 1530, the outcome of the payment is received from the gateway that may connect to banks, an accounting system or a crypto currency (e.g. bit coin) escrow system. In the step 1532, a message is communicated to the payer device 104 and the payee device 110 indicating that the transaction is unsuccessful. In the step 1534, a message is communicated to the payer device 104 and the payee device 110 indicating that the transaction is successful. The recurring payment continue uninterrupted even when the payer 102 changes its bank account as the payer 102 can update account in its user device or user interface with new account details, and there is no need for payee 112 to know payer's account details.

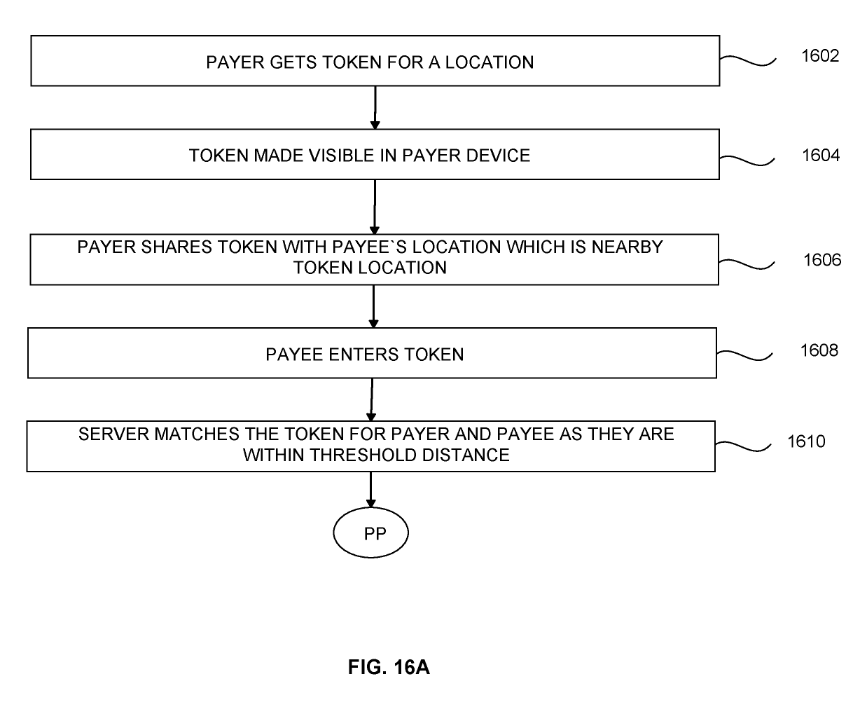

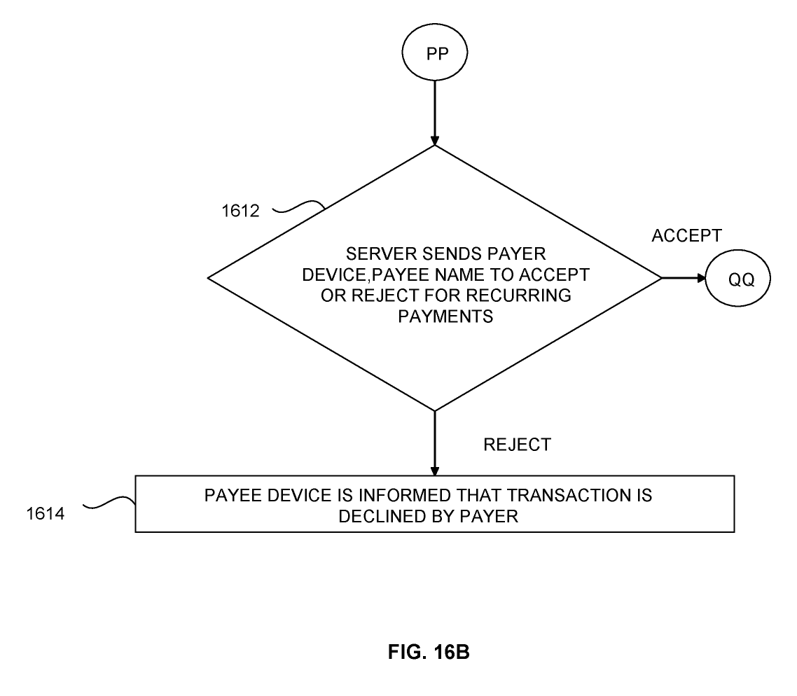

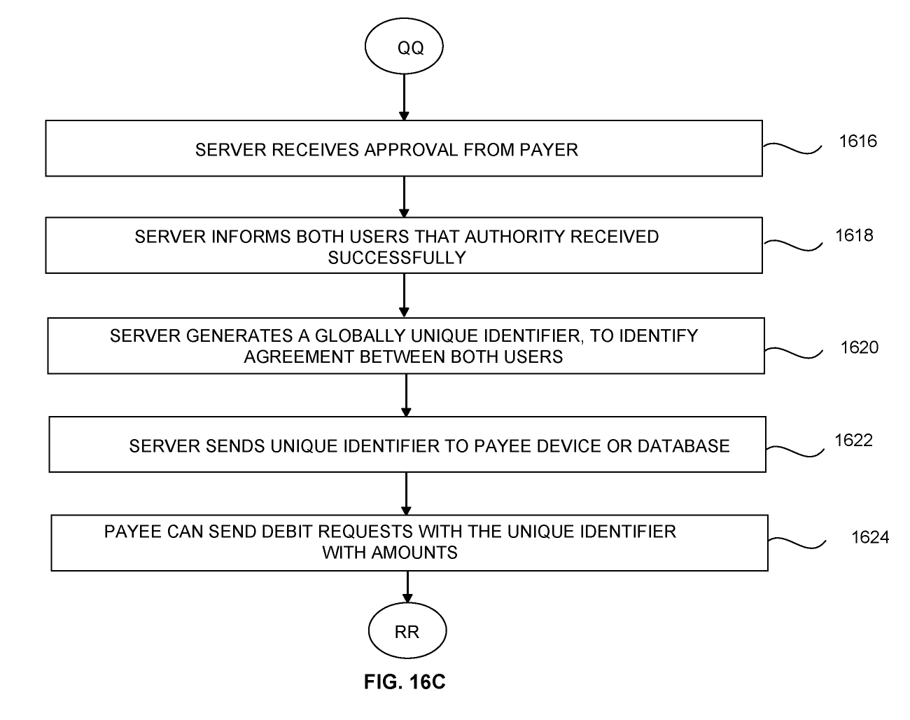

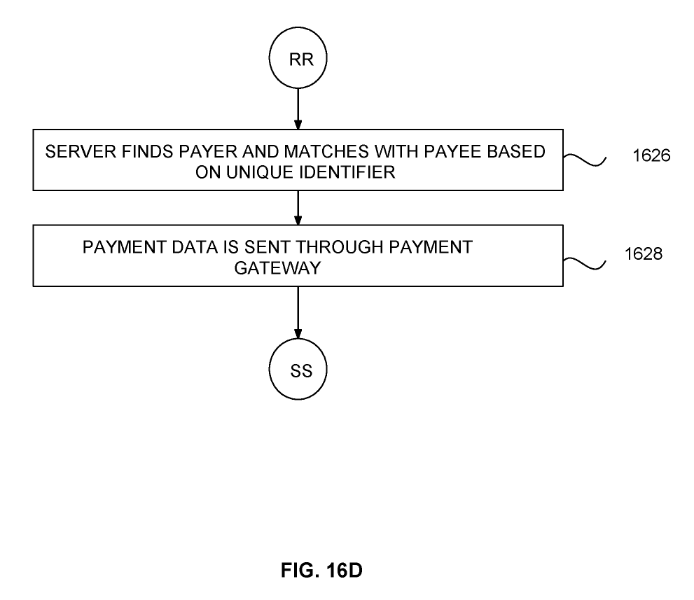

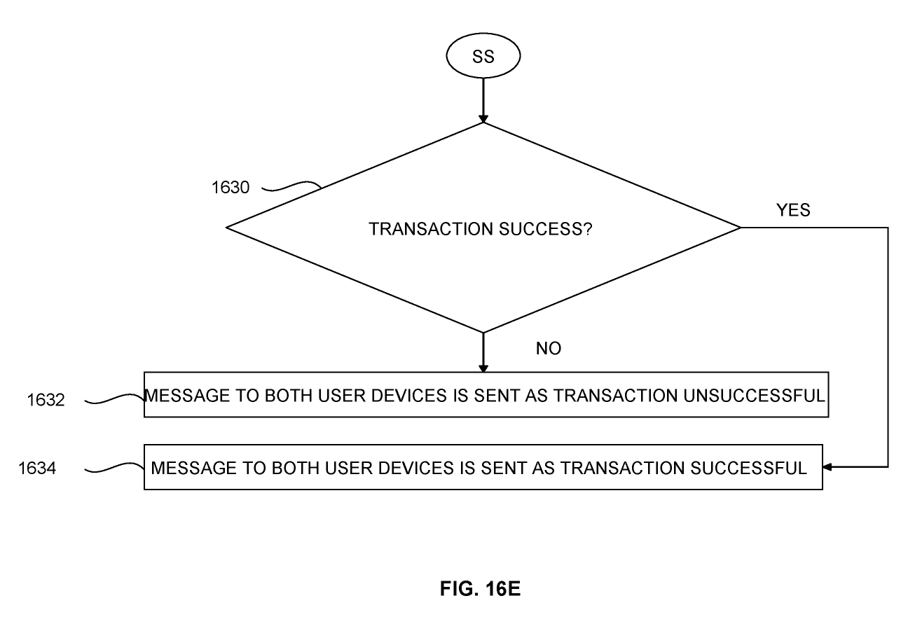

FIGS. 16A, 16B, 16C, 16D and 16E are a flowchart that illustrates a method of paying recurring payments between a payee 112 by a payer 102 through a unique identifier in the server 108 of FIG. 1 where they reach agreement while they are far apart and remote from each other, according to an embodiment herein. In an example embodiment, in step 1602, the payer 102 of FIG. 1 requests a token for a location. In step 1604, the token is displayed in a payer device 104 of FIG. 1. In step 1606, the payer 102 of FIG. 1 shares the token to the payee device 110 of FIG. 1 whose profile location is nearby the token location or payee 112 of FIG. 1 is physically located nearby the location associated with the token. In step 1608, the payee 112 of FIG. 1 enters the token in payee device 110 or interface. In step 1610 the server 108 matches the payer 102 of FIG. 1 and the payee 112 of FIG. 1 on the basis of the same token association and being within threshold distance. In step 1612, the server 108 sends the payer device, 104 of FIG. 1 notification to accept or decline the recurring payments. This request is processed, in preferred embodiment, though not a requirement, only if the application is already open in the payer device 104 of FIG. 1. In step 1614, the request is declined and the payee 112 of FIG. 1 is informed that the payment authority is declined by the payer 102 of FIG. 1. In step 1616, the request is accepted, and the server 108 receives approval from the payer 102 of FIG. 1. In step 1618, both the users are informed by the server 108 that the authority is received successfully. In step 1620, a globally unique identifier is generated by a sever 108, to identify agreement between both the users. In step 1622, the unique identifier is sent by the server 108 to payee device 110 of FIG. 1 or a payee database 250 where payee 112 stores its customer contact information. In step 1624, the payee 112 of FIG. 1 can send debit requests with the unique identifier with amounts. In step 1626, the server 108 finds the payer 102 of FIG. 1 and matches with the payee 112 of FIG. 1 based on unique identifier and also confirms that the debit request is originating from a device or a computer that is associated with the payee 112. In step 1628, the payment request is sent through payment gateway to process the transaction. In step 1630, the outcome of the payment is received from the gateway that may connect to banks, an accounting system or a crypto currency (e.g. bit coin) escrow system. In the step 1632, a message is communicated to the payer device 104 and the payee device 110 indicating that the transaction is unsuccessful. In the step 1634, a message is communicated to the payer device 104 and the payee device 110 indicating that the transaction is successful.

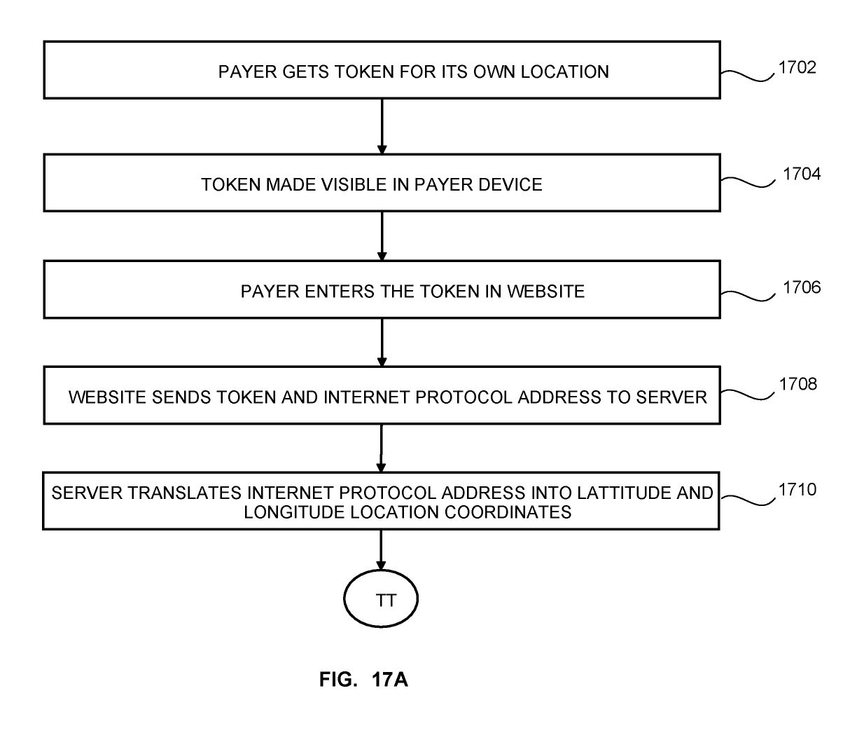

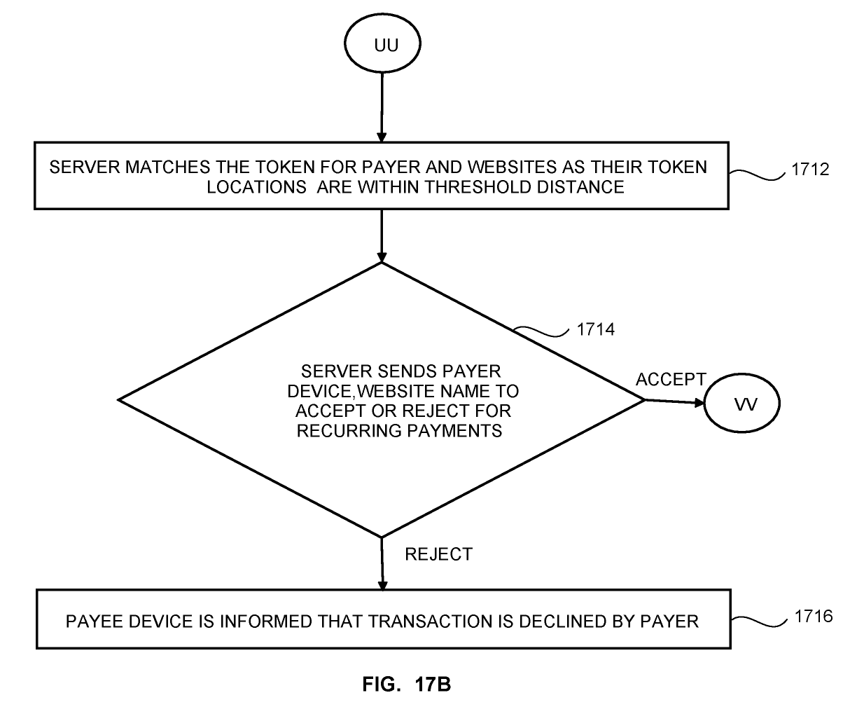

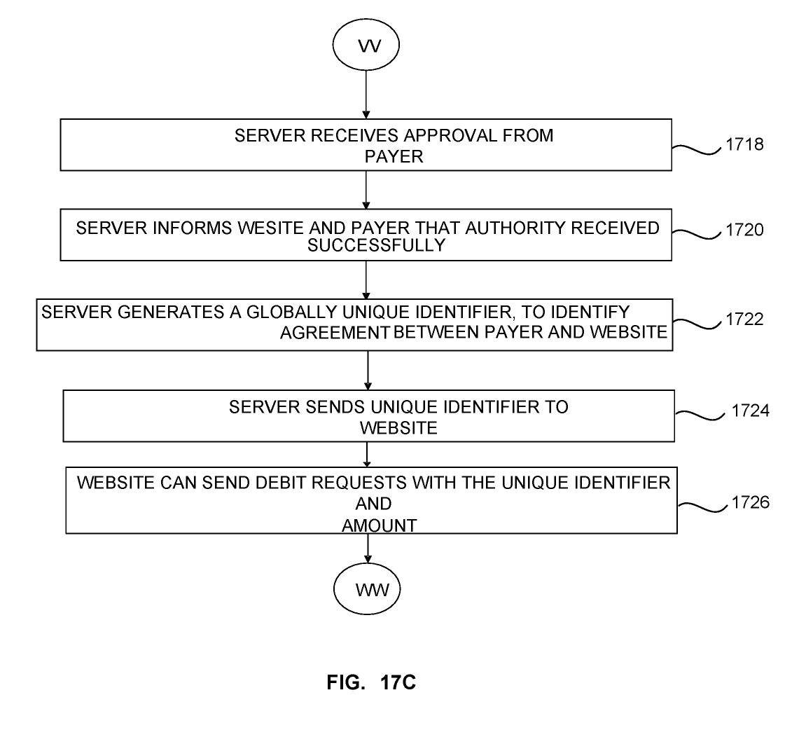

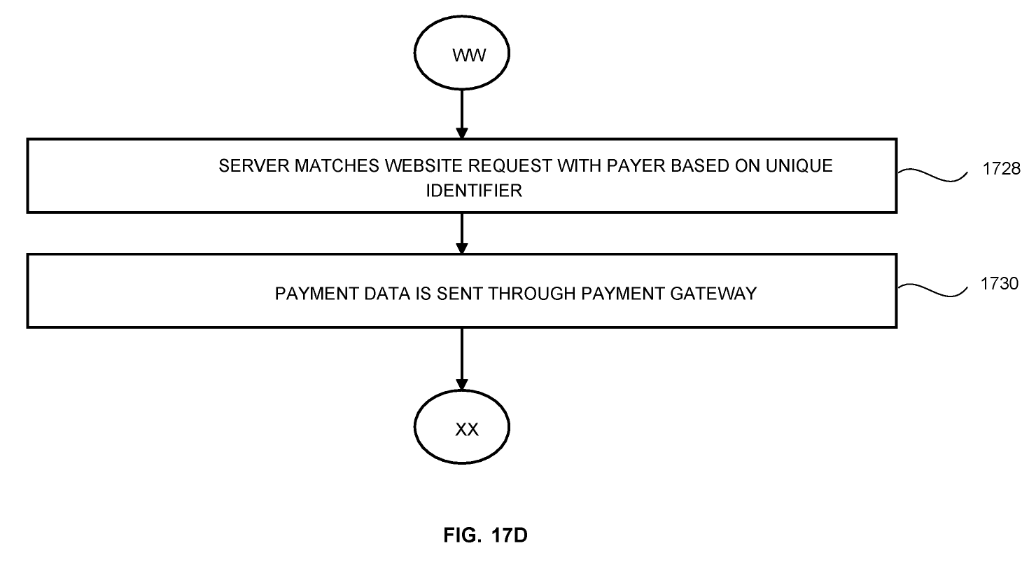

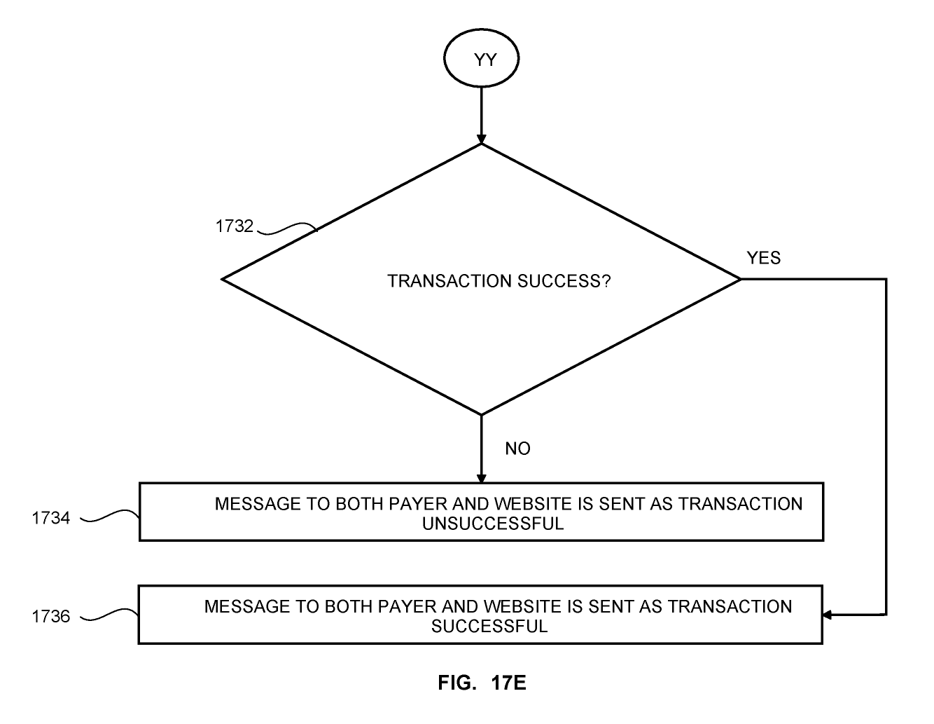

FIGS. 17A, 17B, 17C, 17D and 17E are a flowchart that illustrates a method of paying recurring payments to a website, through the server 108 of FIG. 1, according to an embodiment herein. In an example embodiment, in step 1702, the payer 102 of FIG. 1 requests a token for its own location. In step 1704, the token is displayed in a payer device 104 of FIG. 1. In step 1706, the payer 102 of FIG. 1 enters the token in website. In step 1708, the website sends the token and internet protocol address to server 108. In step 1710, internet protocol address is translated by the server 108 in to the latitude and the longitude location coordinates. In step 1712, the token for the payer 102 of FIG. 1 and the website is matched by the server 108 as their token locations are within threshold distance. In step 1714, the server 108 sends the payer device 104 of FIG. 1 notification to accept or decline the recurring payments. This request is processed, in preferred embodiment, though not a requirement, only if the application is already open in the payer device 104 of FIG. 1. In step 1716, the request is declined and the website is informed that the payment authority is declined by the payer 102 of FIG. 1. In step 1718, the request is accepted, and the server 108 receives approval from the payer 102 of FIG. 1. In step 1720, the website and the payer 102 of FIG. 1 are informed by the server 108 that the authority is received successfully. In step 1722, a globally unique identifier is generated by a sever 108, to identify agreement between the payer 102 of FIG. 1 and the website. In step 1724, the unique identifier is sent by the server 108 to the website where the unique identifier is stored and associated with the payer 102 in its customer database. In step 1726, the website can send debit requests with the unique identifier with amounts. In step 1728, the server 108 finds the website and matches with the payer 102 of FIG. 1 based on unique identifier to confirm the agreement of payments between the payer 102 and the website. In step 1730, the payment request is sent through payment gateway to process the transaction. In step 1732, the outcome of the payment is received from the gateway that may connect to banks, an accounting system or a crypto currency (e.g. bitcoin) escrow system. In the step 1734, a message is communicated to the payer device 104 and the payee website indicating that the transaction is unsuccessful. In the step 1736, a message is communicated to the payee website and the payer device 104 indicating that the transaction is successful.

The method explained in the embodiment can easily be reversed where a website is a payer 102 of FIG. 1 and a user is a payee 112 of FIG. 1 that is able to transfer payment regularly. A payment is a payment, and when the payment is a negative, leveraging the agreement identifier, it is still a payment wherein a payer 102 of FIG. 1 is now a payee 112 of FIG. 1 and payee 112 of FIG. 1 is now a payer 102 of FIG. 1.

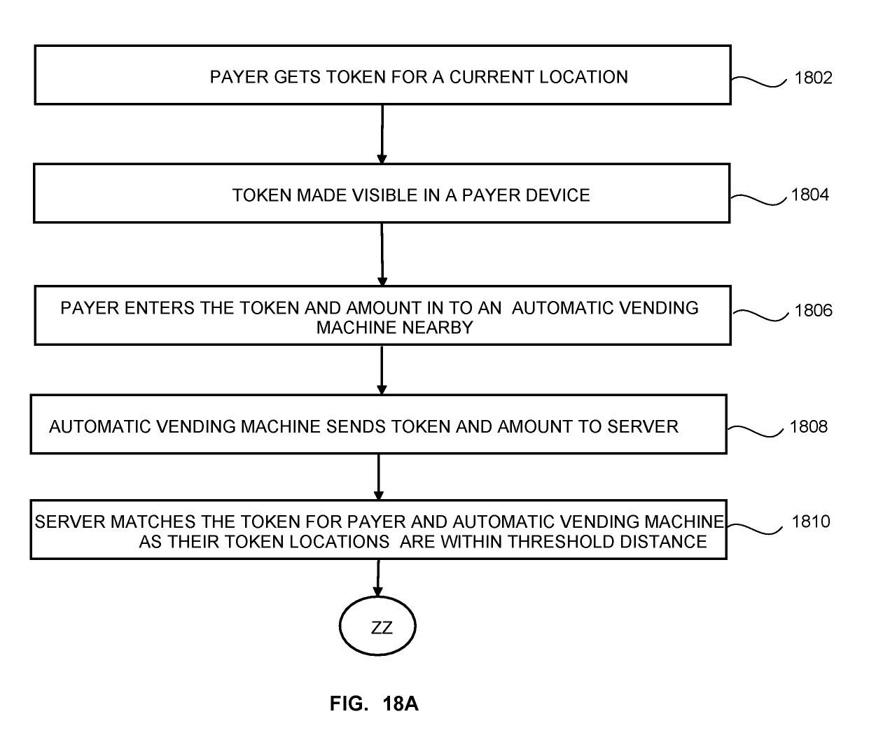

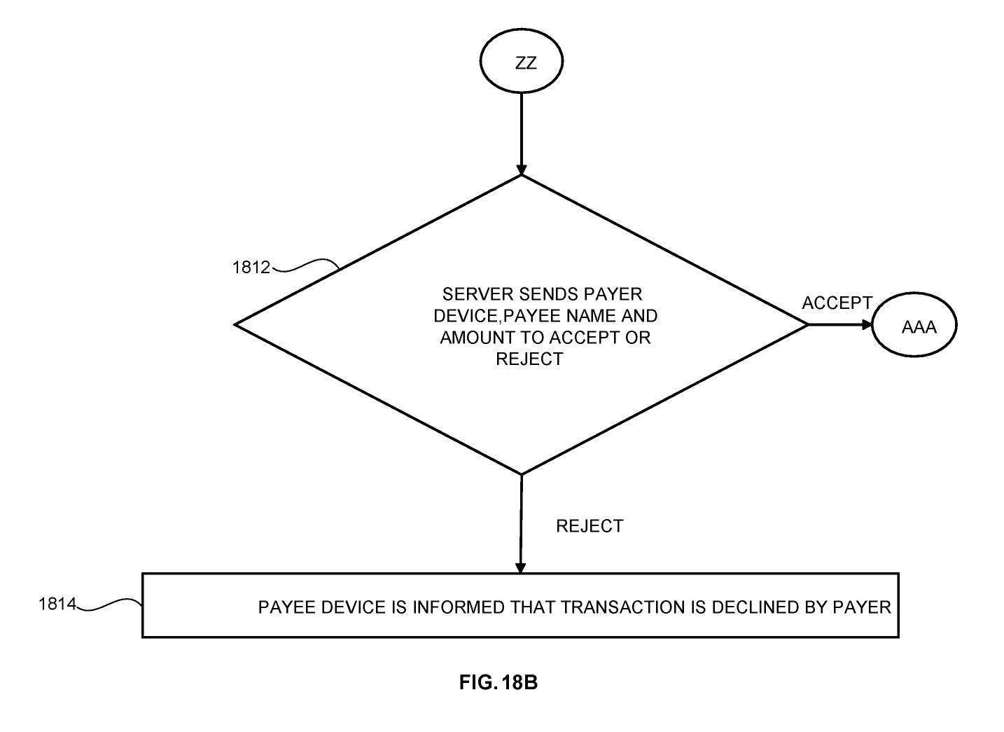

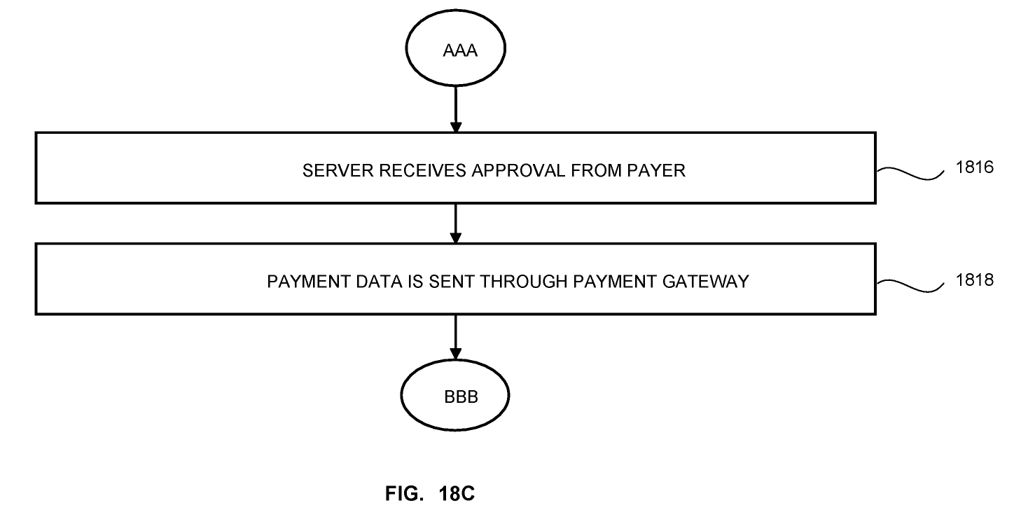

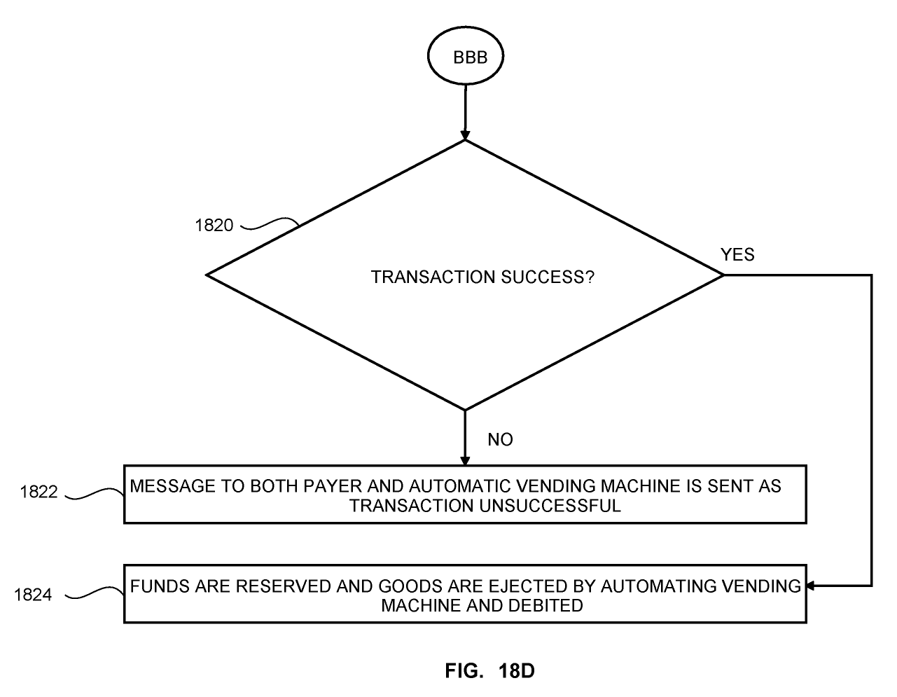

FIGS. 18A, 18B, 18C and 18D are a flowchart that illustrates a method of purchase from a payer 102 to a payee 112 through an automatic vending machine (AVM) in the server 108 of FIG. 1, according to an embodiment herein. In an example embodiment, in step 1802, the payer 102 of FIG. 1 requests a token for a current location. In step 1804, the token is displayed in a payer device 104 of FIG. 1. In step 1806, the payer 102 of FIG. 1 enters the token in to an automatic vending machine in a nearby location. In step 1808, the automatic vending machine sends the token and internet protocol address to the server 108. In step 1810, the payer 102 of FIG. 1 and the automatic vending machine is matched by the server 108 on the basis of the same token association and being within threshold distance. In step 1812, the server 108 sends the payer device 104 of FIG. 1 notification to accept or decline the amount. In step 1814, the request is declined and the automatic vending machine is informed that the payment is declined by the payer 102 of FIG. 1. In step 1816, the request is accepted, and the server 108 receives approval from the payer 102 of FIG. 1. In step 1818, the payment data is sent through the payment gateway. In step 1820, the outcome of the payment is received from the gateway that may connect to banks, an accounting system or a crypto currency (e.g. bit coin) escrow system. In the step 1822, a message is communicated to the payer device 104 and the AVM indicating that the transaction is unsuccessful. In the step 1824 upon successful reservation of funds, goods are made accessible to the payer 102 of FIG. 1 by the automatic vending machine, upon successful deliver of goods purchased and transaction is process is completed by the server 108 of FIG. 1.

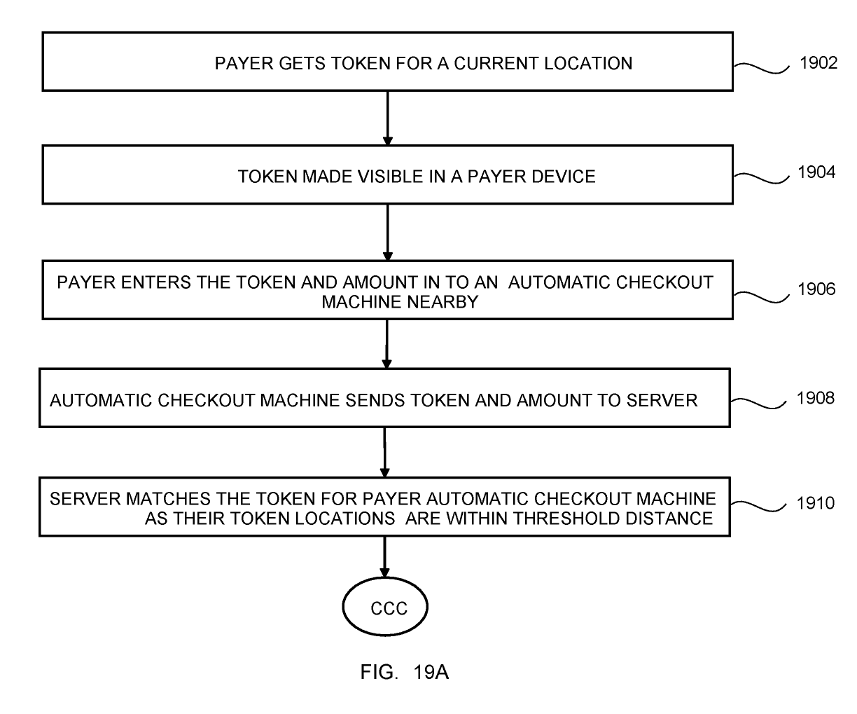

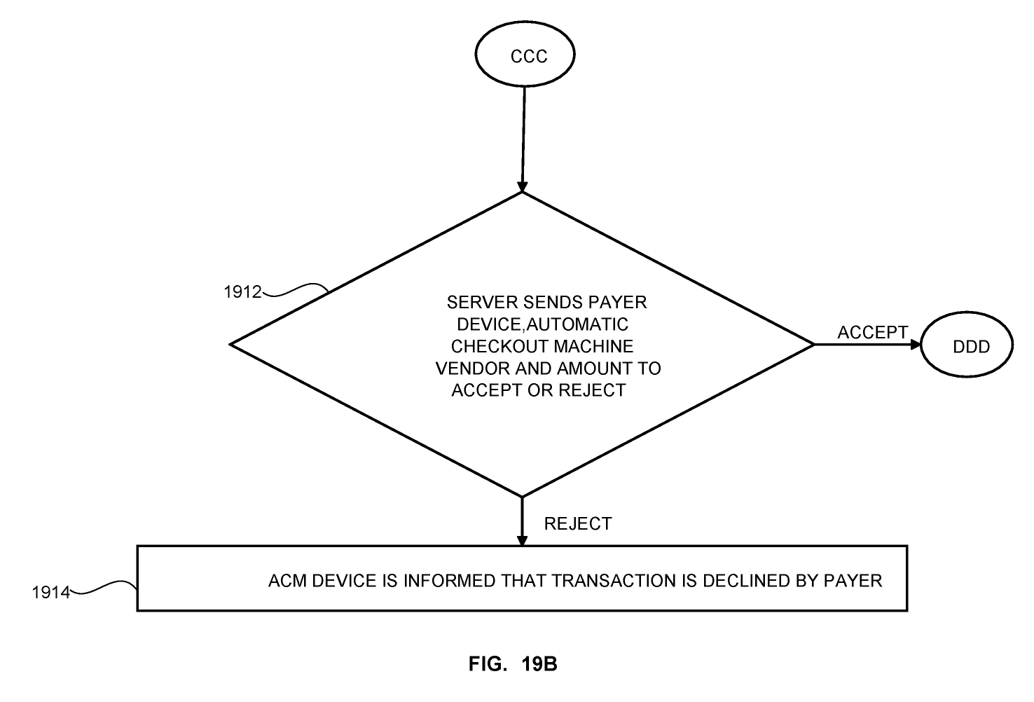

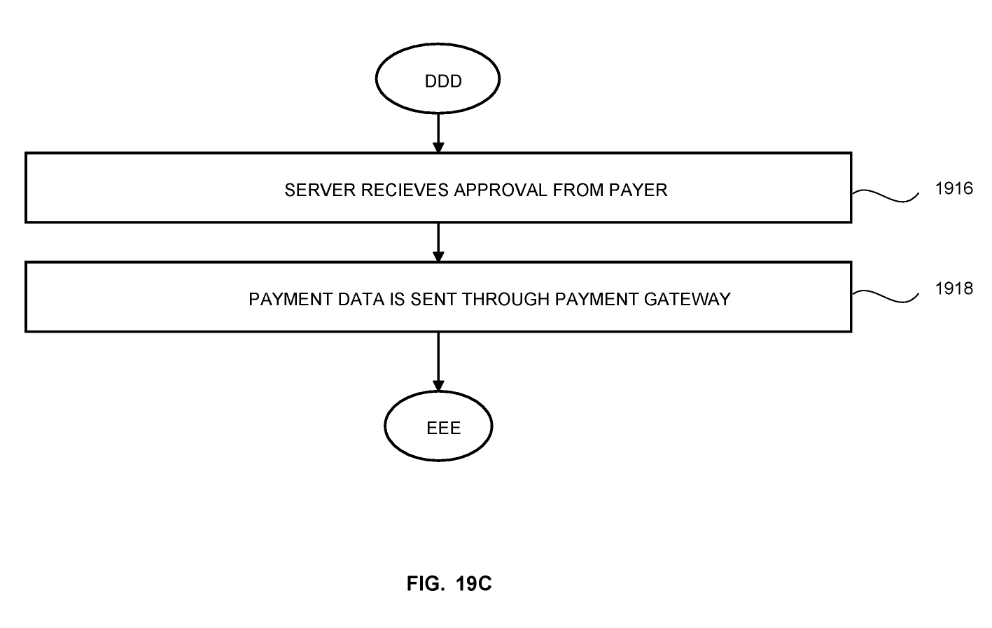

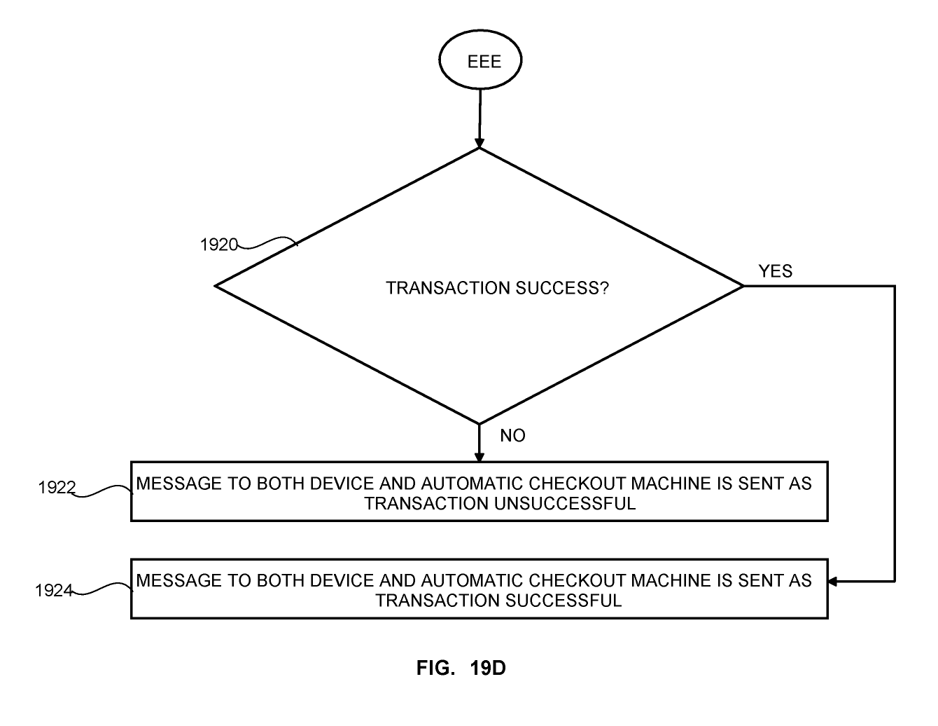

FIGS. 19A, 19B, 19C and 19D are a flowchart that illustrates a method of purchase from a payer 102 to a payee 112 through an automatic checkout machine (ACM) in the server 108 of FIG. 1, according to an embodiment herein. In an example embodiment, in step 1902, the payer 102 of FIG. 1 requests a token for a current location. In step 1904, the token is displayed in a payer device 104 of FIG. 1. In step 1906, the payer 102 of FIG. 1 enters the token in to an automatic checkout machine in a nearby location. In step 1908, the automatic checkout machine sends the token and internet protocol address to the server 108. In step 1910, the payer 102 of FIG. 1 and the automatic checkout machine is matched by the server 108 on the basis of the same token association and being within threshold distance. In step 1912, the server 108 sends the payer device 104 of FIG. 1 notification to accept or decline the amount. In step 1914, the request is declined and the ACM's owner, the payee 112 of FIG. 1 is informed that the payment is declined by the payer 102 of FIG. 1. In step 1916, the request is accepted, and the server 108 receives approval from the payer 102 of FIG. 1. In step 1918, the payment data is sent through the payment gateway. In step 1920, the outcome of the payment is received from the gateway that may connect to banks, an accounting system or a crypto currency (e.g. bit coin) escrow system. In the step 1922, a message is communicated to the payer device 104 and the payee device 110 indicating that the transaction is unsuccessful. In the step 1924, a message is communicated to the payer device 104 and the payee device 110 indicating that the transaction is successful. The automatic check out machine can be a self-checkout where the shopper is interacting with its device and also the machine or the machine may be manned by a checkout clerk who is interacting with the machine and shopper is interacting with its device only.

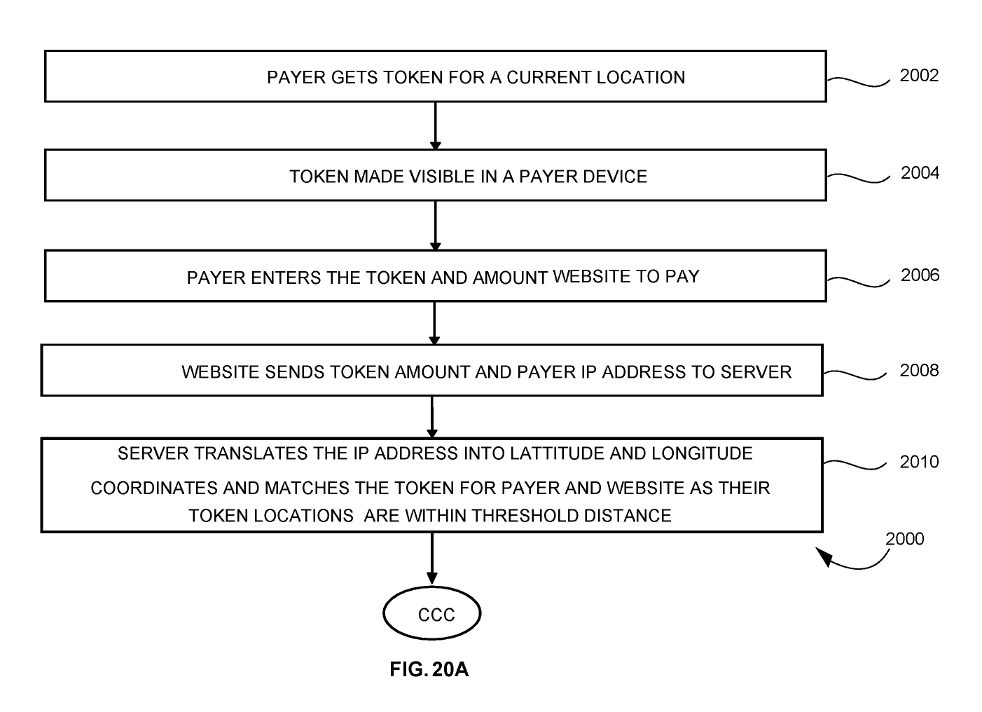

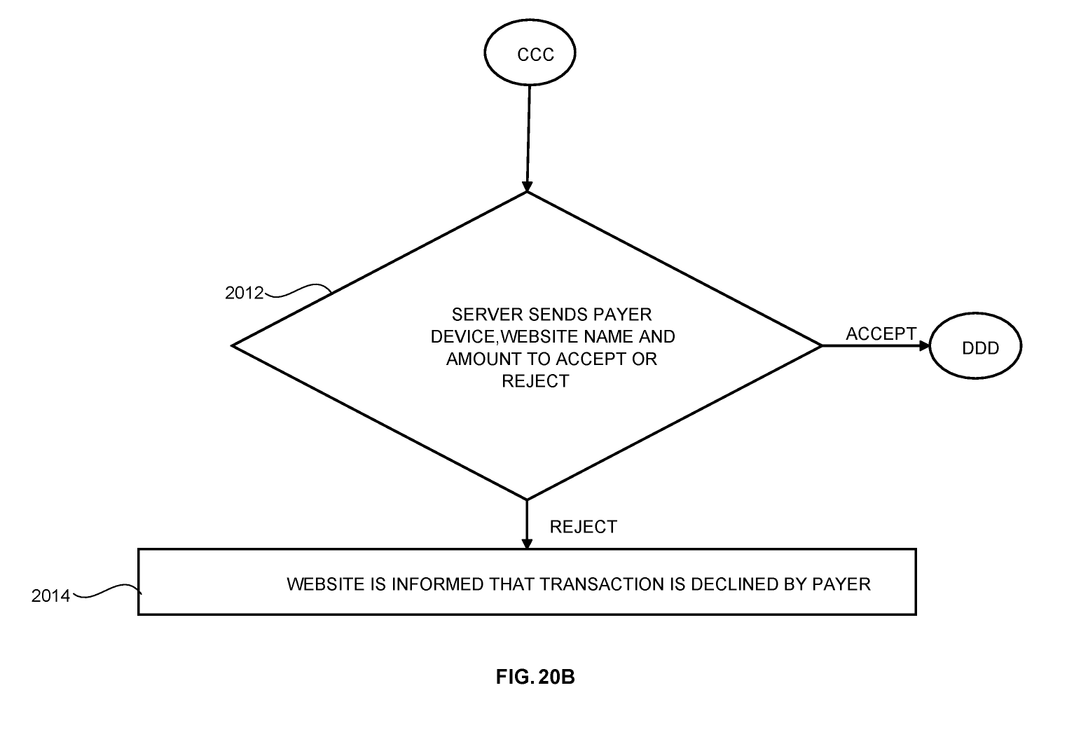

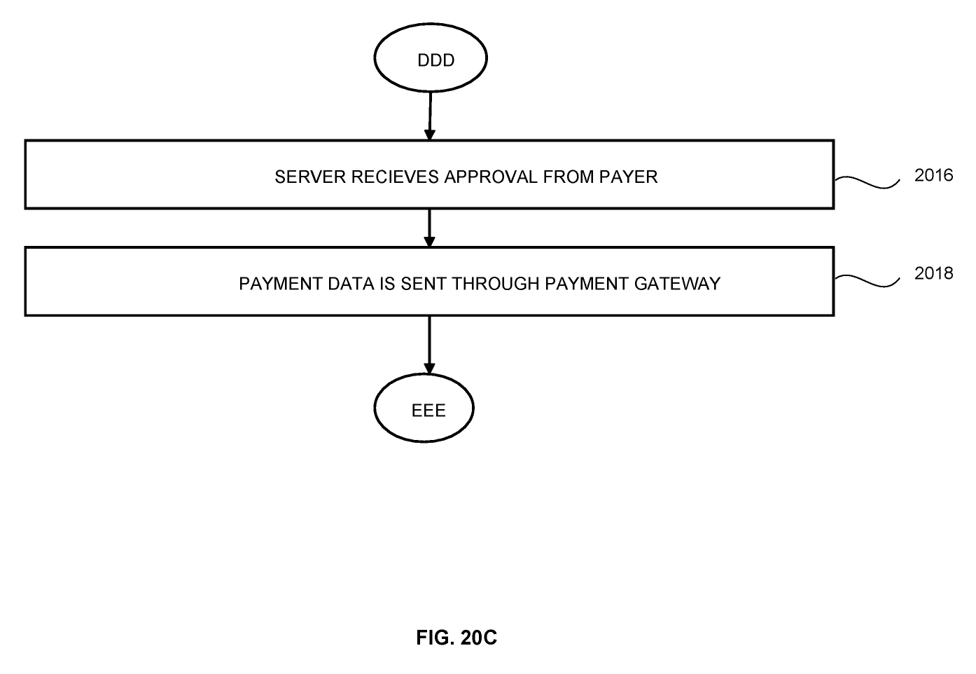

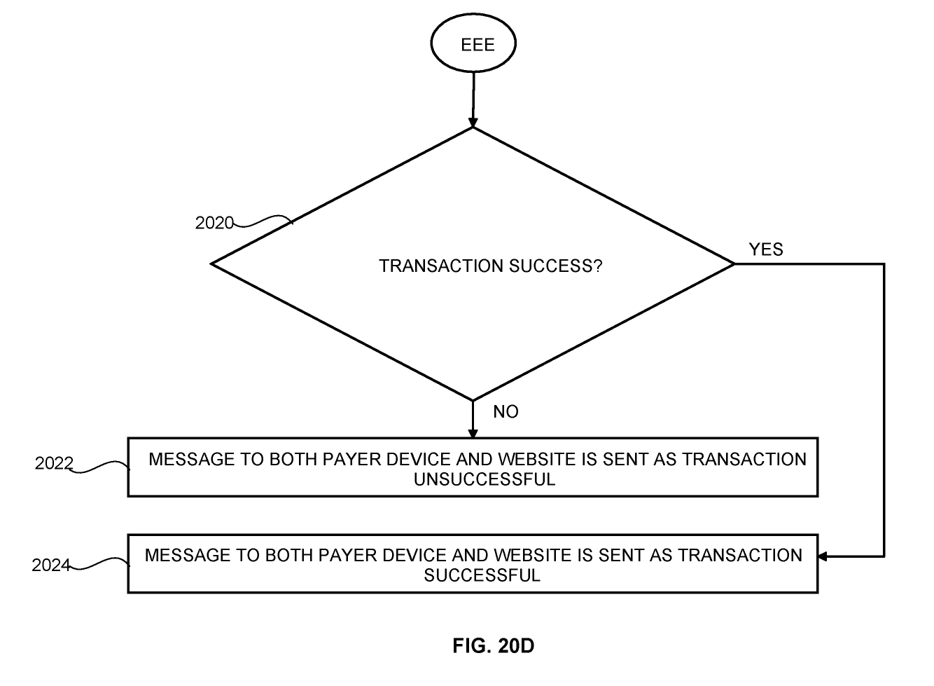

FIGS. 20A, 20B, 20C and 20D are a flowchart that illustrates a method of purchase from a payer 102 to a website through the server 108 of FIG. 1, according to an embodiment herein. In an example embodiment, in step 2002, the payer 102 of FIG. 1 requests a token for a current location. In step 2004, the token is displayed in a payer device 104 of FIG. 1. In step 2006, the payer 102 of FIG. 1 enters the amount and token in to the website. In step 2008, website sends the amount and token and internet protocol address to the server 108. In step 2010, the server 108 translates the internet protocol address into latitude and longitude and the payer 102 of FIG. 1 and the website is matched by the server 108 on the basis of the same token association and being within threshold distance. In step 2012, the server 108 sends the payer device 104 of FIG. 1 and website name, a notification to accept or decline the amount. In step 2014, the request is declined and the website is informed that the payment is declined by the payer 102 of FIG. 1. In step 2016, the request is accepted, and the server 108 receives approval from the payer 102 of FIG. 1. In step 2018, the payment data is sent through the payment gateway. In step 2020, the outcome of the payment is received from the gateway that may connect to banks, an accounting system or a crypto currency (e.g. bit coin) escrow system. In the step 2022, a message is communicated to the payer device 104 and the payee device 110 indicating that the transaction is unsuccessful. In the step 2024, a message is communicated to the payer device 104 and the payee device 110 indicating that the transaction is successful.

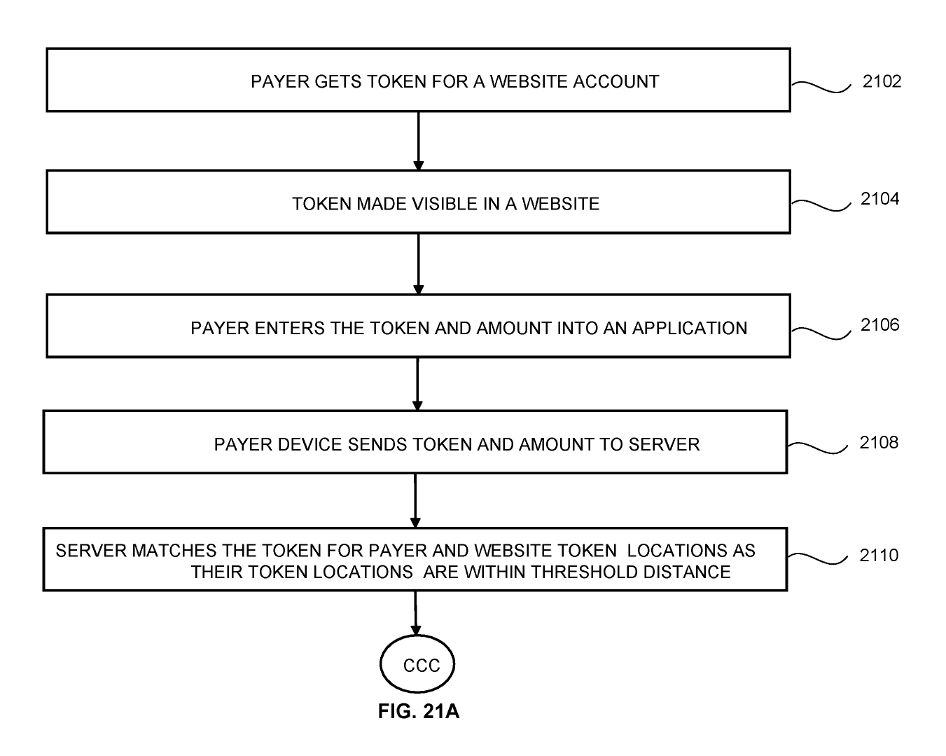

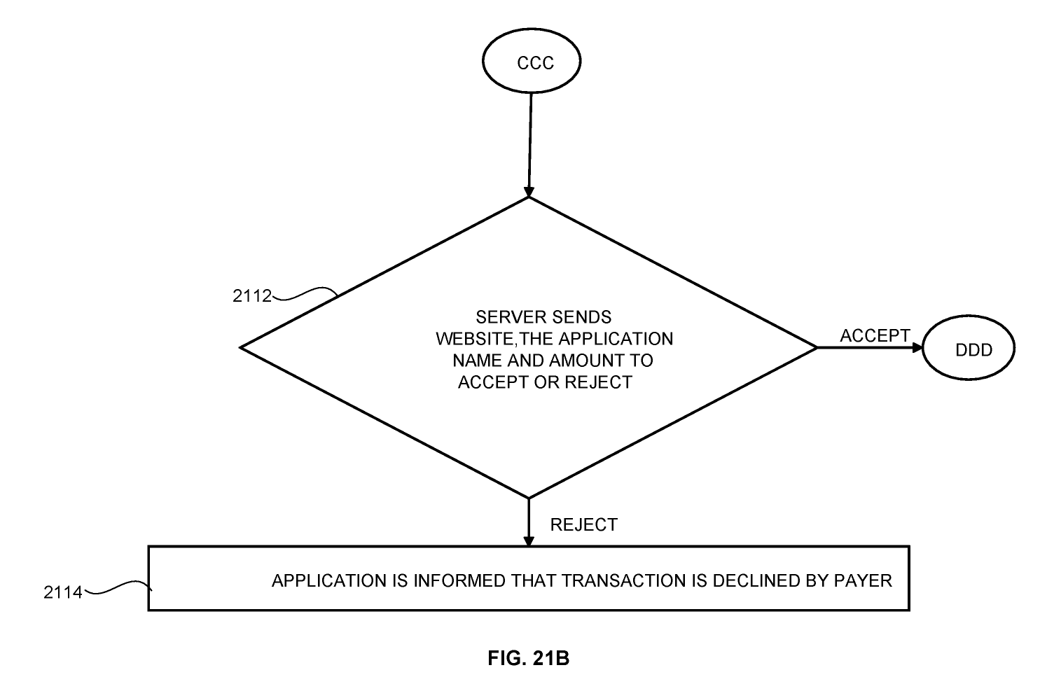

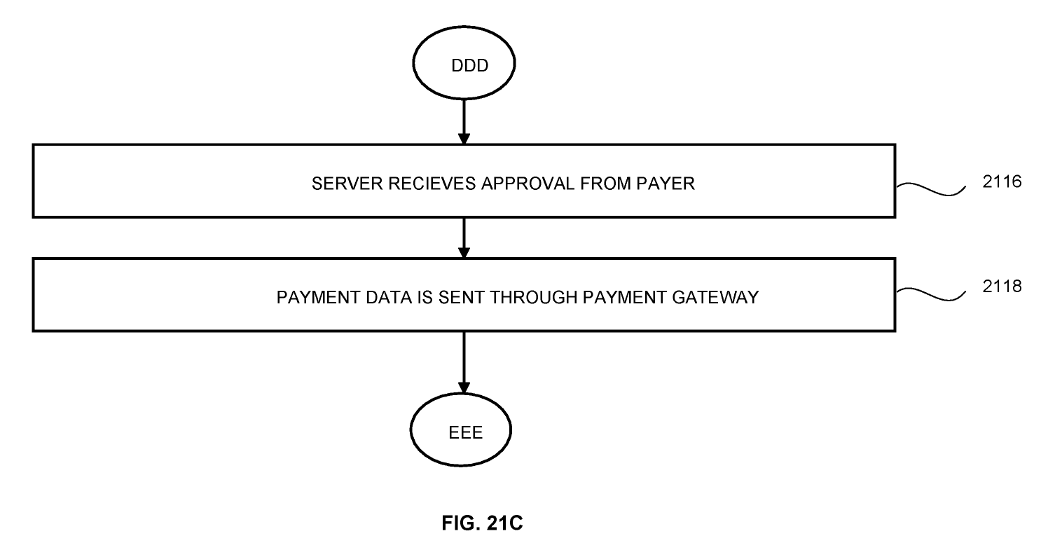

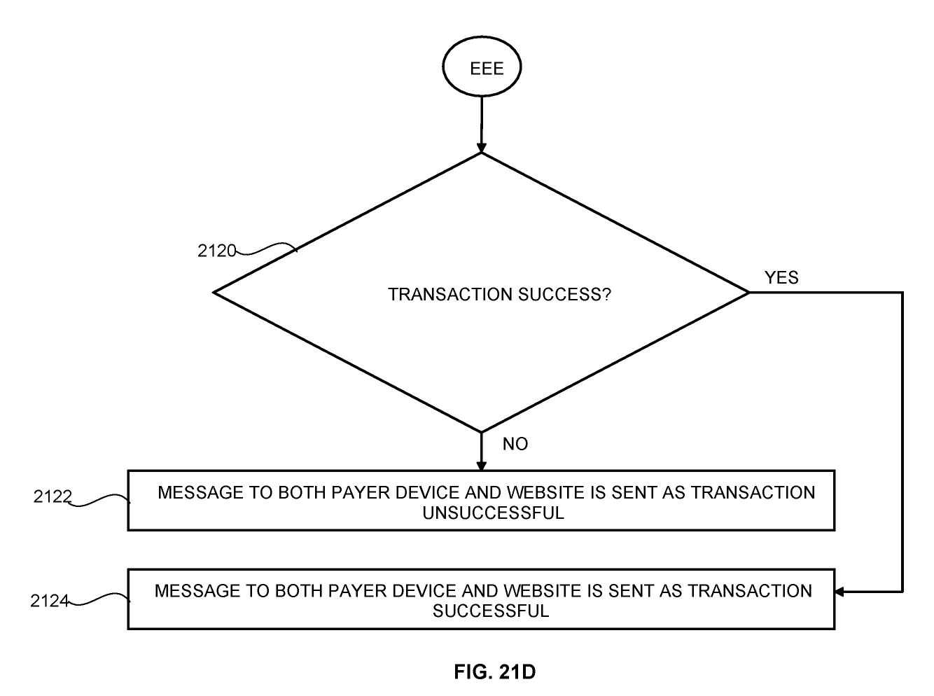

FIGS. 21A, 21B, 21C and 21D are a flowchart that illustrates a method of purchase by a website user (e.g. a payer 102) to an application through the server 108 of FIG. 1, according to an embodiment herein. In an example embodiment, in step 2102, the payer 102 of FIG. 1 requests a token. In step 2104, the token is displayed in a website. In step 2106, the payer 102 of FIG. 1 enters the token and amount into the application. In step 2108, payee application sends the token and amount to the server 108. In step 2110, the website and the payee application 104 of FIG. 1 is matched by the server 108 on the basis of the same token association and being within threshold distance. In step 2112, the server 108 sends the website, the application name with a notification to accept or decline the amount. In step 2114, the request is declined and the application is informed that the payment is declined by the payer 102 of FIG. 1. In step 2116, the request is accepted, and the server 108 receives approval from the payer 102 of FIG. 1. In step 2118, the payment data is sent through the payment gateway. In step 2120, the outcome of the payment is received from the gateway that may connect to banks, an accounting system or a crypto currency (e.g. bit coin) escrow system. In the step 2122, a message is communicated to the payer website user and the payee application indicating that the transaction is unsuccessful. In the step 2124, a message is communicated to the payer website user and the payee application indicating that the transaction is successful.

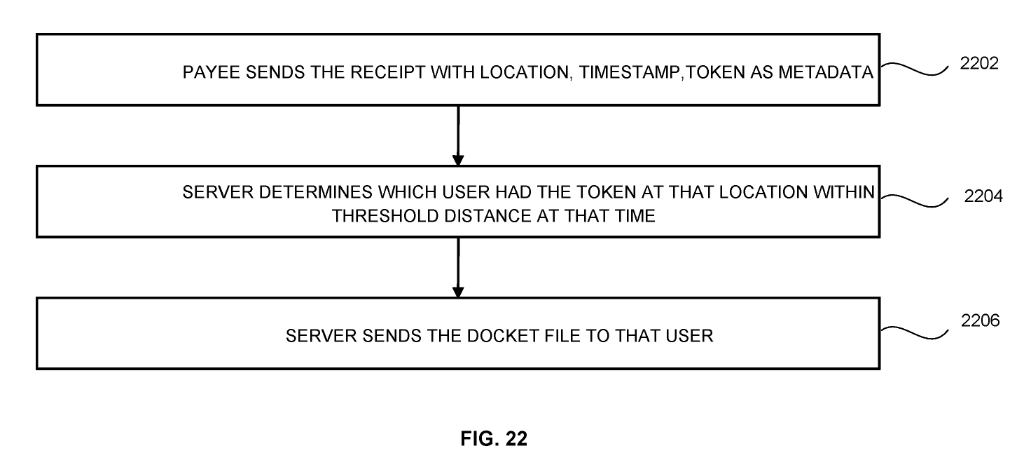

FIG. 22 is a flowchart that illustrates a method of transmission of transaction document (e.g. a purchase receipt) through the server 108 of FIG. 1, according to an embodiment herein. In an example embodiment, in step 2202, the payee 112 of FIG. 1 sends the document with metadata location of the token, the token and date & time stamp of the transaction. In step 2204, the document is matched by the server 108 with the payer device 104 of FIG. 1 based on the metadata within the threshold distance. In step 2206, the file is sent by the server 108 to the user. This method can easily be reversed wherein a payer 102 of FIG. 1 wants to send a document to a payee 112 of FIG. 1 by using the same metadata. However, as the devices can be one-way paired as well as explained already, the itemized description of each item that is being purchased can be shown in real time one-by-one or together on the shopper's device before the payment is approved. Hence, shopper can see list of items being scanned on its own device rather than screen associated with the merchant prior to approving a payment.

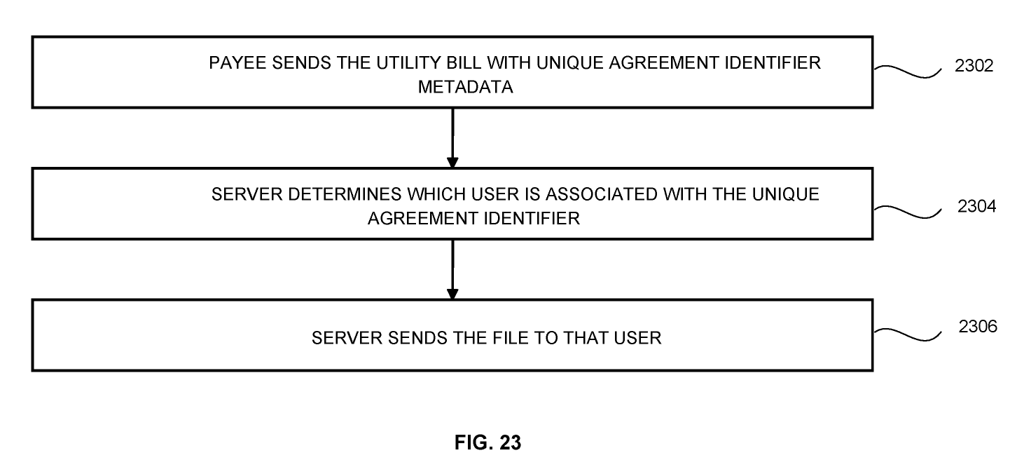

FIG. 23 is a flowchart that illustrates a method of transmission of multiple transaction documents (e.g. a utility bill) based on an agreement identifier through the server 108 of FIG. 1, according to an embodiment herein. In an example embodiment, in step 2302, the bill is sent by the payee 112 of FIG. 1 to the server 108 with a metadata of the unique agreement identifier. In step 2304, the payer 102 of FIG. 1 is determined by the server 108 which is associated with the unique agreement identifier. In step 2306, the file is sent by the server 108 to payer 102 of FIG. 1. Hence documents such as utility bill can be sent regularly without exchanging details such as email address. The embodiment can be easily reversed where the file, for example a salary slip for an agreement between an employer who is a payer 102 and an employee who is a payee 112 of FIG. 1, is sent by the server 108 to the payee 112 of FIG. 1.

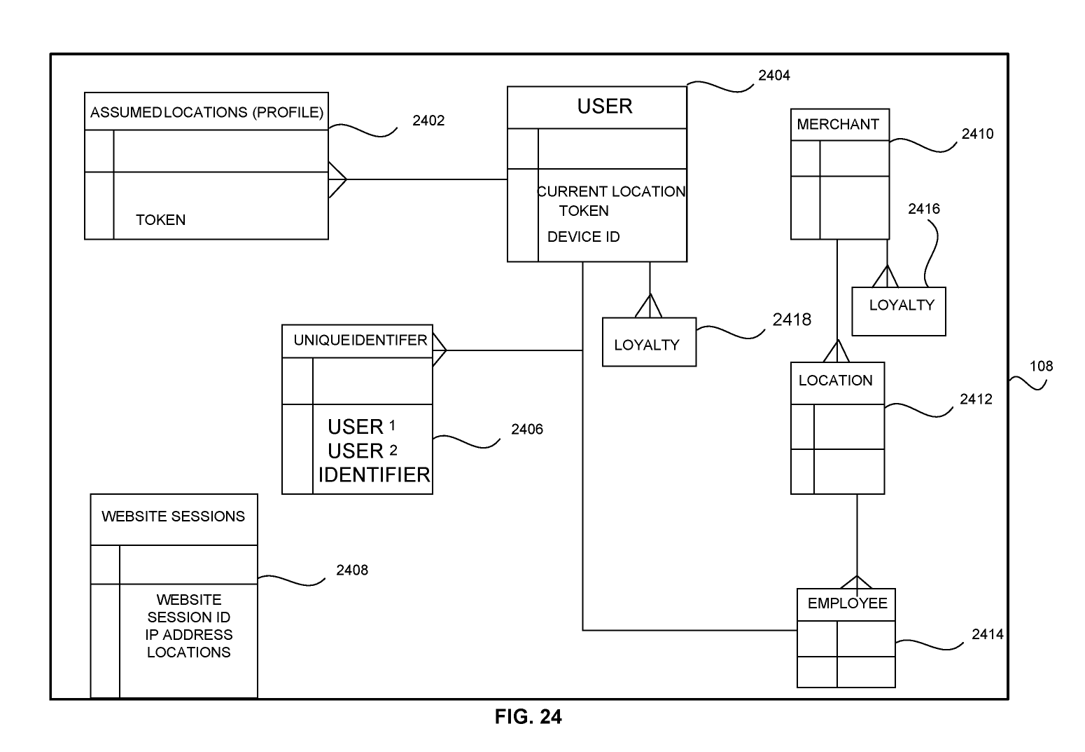

FIG. 24 illustrates an interface view of a database model of the token generation through the server 108 of FIG. 1, according to an embodiment herein. The server 108 of FIG. 1 includes an assumed location 2402, a user table 2404, a unique identifier 2406 for agreements or authorisations between users, a website session 2408, a merchant 2410, a location table 2412 and an employee 2414. An assumed location 2402 may have several profiles or locations where a user is not physically available but he would like to acquire a token. The user table 2404 has a current location, a device id, and a token based on its current location in the table. The merchant 2410 may have many locations, and each location may have many employees 2414. The employee 2414 may have access in the same lines as that of the user, but acts on behalf of the business. The business can have a fixed location defined in the location table 2412.

The unique identifier 2406 stores one-way or two authorisations or agreements between first user device 104 and second user device 110 and either of the user may be a merchant 2410. The website sessions 2408 stores an internet protocol address, a calculated location of the internet protocol address, a website and a session ID of the user interacting with the token. The merchant is participating in loyalty programs 2416, and user is member of those loyalty programs 2418. The shopping data that is agreed between user and merchant to share is shared with the server 108 of the respective loyalty program.

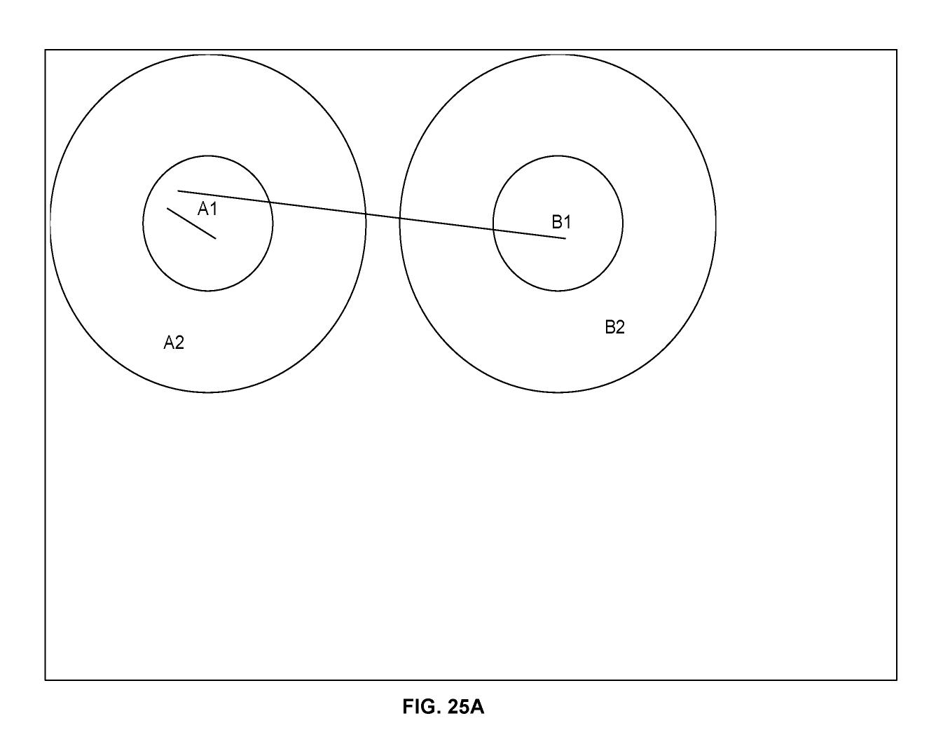

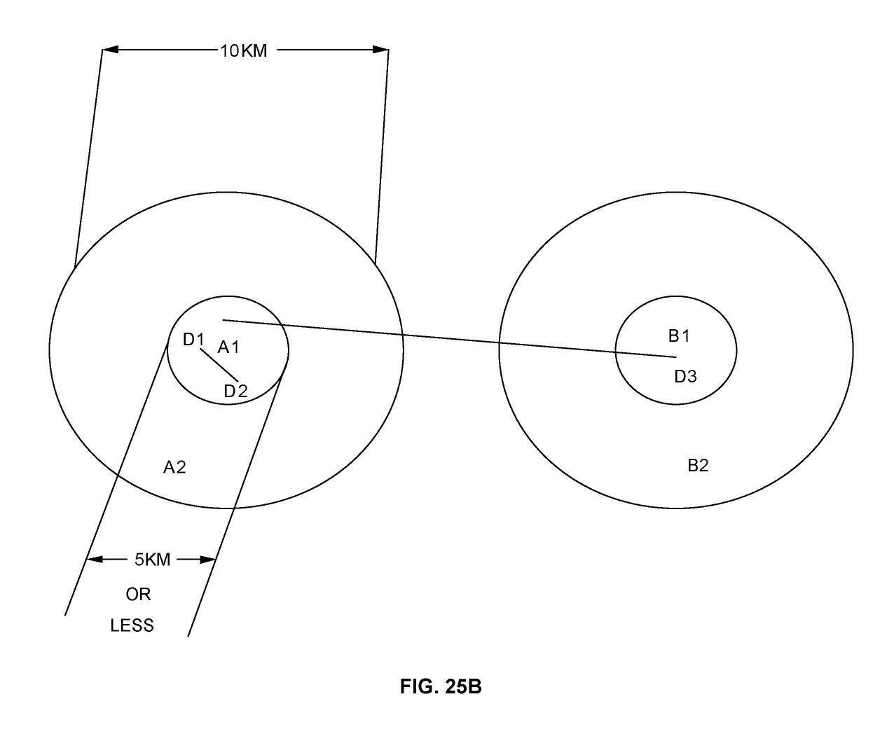

FIGS. 25A and FIG. 25B illustrate a method for pairing two devices in geographically non-intersecting areas through the server 108 of FIG. 1, according to an embodiment herein. The method includes four concentric circles A1, A2, B1 and B2. In FIG. 25A, it is demonstrated by a geometric drawing that all points within A1 are closer than any two points, where one point is in A1 and other point is in B1. A1 and B1 have radius r, and A2 and B2 and radius R. A2 and B2 are non-intersecting, therefore in a limiting case they may be touching tangentially. B1 and A1 have a radius value of r where any two points within A1 are closer than any two points, between A1 and B1. The maximum distance possible between any two points in circle A1 is 2r. The minimum distance possible between any two points, A1 and B1 is 2(R-r). A non-unique token can be generated at the centre of A1, and deactivated before it reaches the circumference of A1 to ensure it always remain farther than 2(R-r) from another identical token within B2. Larger circles A2 and B2 have to be at least two times as big as smaller circles A1 and B1 in terms of radius for this to happen. Prior to granting a random token to a user with associated location at centre on A1, the method checks for presence of other identical active tokens associated with any point within the radius 2R from the centre of A1, which is distance between centre of A2 and B2 at their nearest limiting case. Likewise, prior to granting a random token to a user with associated location at centre on B1, the method checks for presence of another identical active token associated with any point within radius 2R from the centre of B1. If another identical active token exists for another user within radius 2R from centre of A1, another random token is checked. Once a token is associated with location, it is considered to be associated with the specific area A2 around the location, that is, centre of A2, and it is associated with the location that is centre of A2. Moreover, the two identical tokens must not move out of inner circles A1 and B1, for them to always remain farther than 2r from each other. An identical token must be at least 2R distance at the time of association with a location from the nearest identical token's location for non-intersecting areas through the server 108 of FIG. 1 where that location is characterised by a circle or radius R. Since for the limiting case R is equal to 2r, an identical token must be at least 4r distance away at the time of simultaneous association with another location.

In FIG. 25B, an example is made by placing location associated devices in the circles A1, A2, B1 and B2. Moreover, this location need not be actual locations of devices, as uses can assume locations that are different from their physical locations. FIG. 25B is demonstrated by a geometric drawing where D1 and D2 are within A1 and D3 is in B1. In one embodiment, A1 and B1 have a radius 5 km, wherein a token is deactivated before it reaches the circumference of inner circle whist approaching from the boundary from centre outward, and A2 and B2 and radius 10 km. B2 and A2 are non-intersecting. B1 and A1 have a value of 5 km where any two points within A1 are closer than any two points, between A1 and B1. Hence, D1, and D2 are closer than D1 and D3 or D2 and D3. The maximum distance possible between any two points in circle A1 is 2r i.e. 10 km. The minimum distance possible between any two points, A1 and B2 is 2(R-r) i.e 10 km. A non-unique token can be obtained by device D1 at the centre of A2. The token is deactivated if D1 obtained token for its physical location and approaches the circumference of A1 to ensure it always remains farther than 2(R-r) i.e. 10 km from another identical token associated with device D3, within B2. In one embodiment, prior to generating or associating a token for a location, a server 108 will have to check for presence of an identical token for at least 20 Km radius from this location for which token is being generated. Hence, now two identical tokens can be simultaneously utilised by devices. If device D1 shares this token with any device D2 that is within A1, or whose associated location is inside A1, a server 108 can determine conclusively that this token was received from D1 and no D3 despite both having identical tokens to server 108, by calculating distances associated with the tokens. Since any number of such circles can be made, therefore unlimited number of identical tokens can be generated and processed simultaneously by users.

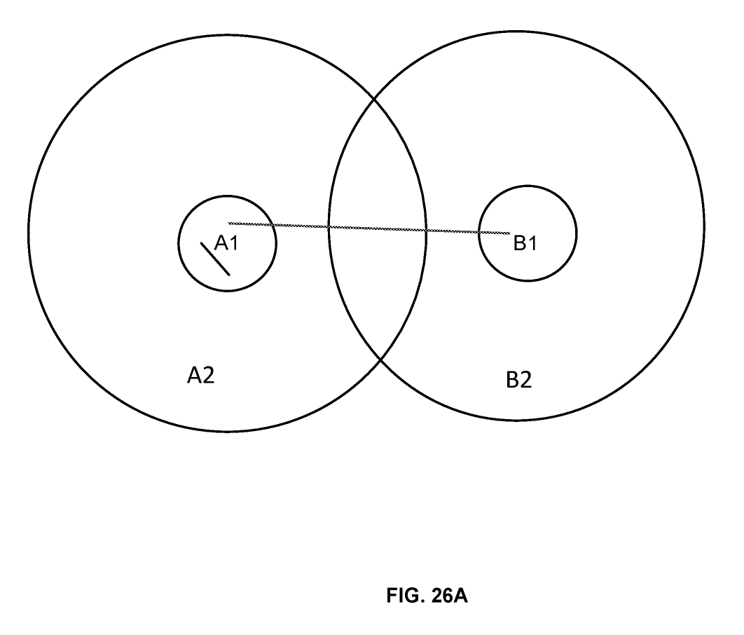

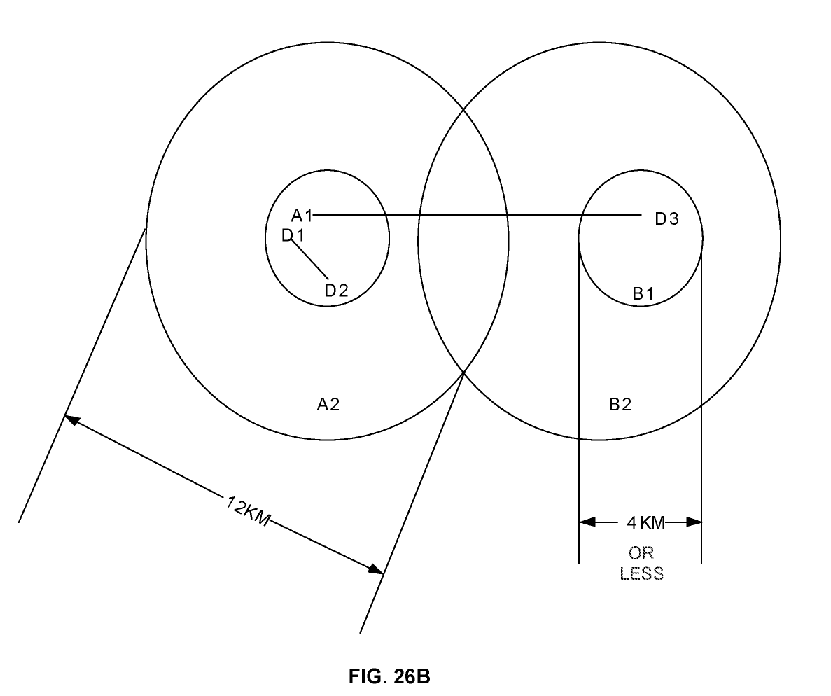

FIGS. 26A and FIG. 26B illustrate a method for pairing two devices in geographically intersecting areas through the server 108 of FIG. 1, according to an embodiment herein. The method includes four concentric circles A1, A2, B1 and B2, in a limiting case, B2 will tangentially touch A1 and B 1 touches A2. A1 and B1 have radius r, and A2 and B2 and radius R. Large circles A2 and B2 are allowed to intersect. Maximum distance possible between any two points in circle A1 is 2r. Minimum distance possible between any two points, one in A1 and other in B1 is (R-r). If overlapping of large circles A2 and B2 is allowed, large circles A2 and B2 has to be at least three times as big in terms of radius compared to small circles A1 and B1. In one embodiment, prior to associating a token with a location, a server 108 must check for presence of another identical active token associated with a location that is within 4r distance of this location, which is distance between centre of A2 and B2 at their nearest limiting case. Whereas in the previous example, it was 2R, but the ratio of r and R was 2, hence, even then this value was 4r. Hence, for circles, the nearest identical token has to be more than 4r where freedom of play allowed for a token is 2r, that is diameter of the inner circle, token being obtained at the centre. The circles A2 and B2 are just for visual understanding as distances can be determined in multiples of r.

In FIG. 26B, an example is made by placing location associated devices in the circles A1, A2, B1 and B2. Moreover, these locations need not be actual locations of devices, as uses can assume locations that are different from their physical locations. FIG. 26B illustrates a method for pairing two devices in geographically intersecting areas through the server 108 of FIG. 1, according to an embodiment herein.A1 and B1 have radius r i.e. 4 km, and A2 and B2 and radius R i.e. 12 km. Large circles A2 and B2 are allowed to intersect. Maximum distance possible between any two points in circle A1 is 2r i.e. 8 KM. Minimum distance possible between any two points, one is A1 and other is B2 is (R-r) i.e. 8KM. If overlapping of large circles A2 and B2 is allowed, large circles A2 and B2, has to be at least three times as big in terms of radius compared to small circles A1 and B1. The server 108 would need to check for presence of another identical token within at least 16 Km radius, which is minimum distance between centre of A2 and B2 for the limiting case. Hence, now two identical tokens can be simultaneously utilised by devices. Since any number of such circles can be made, therefore unlimited number of identical tokens can be generated and processed simultaneously.

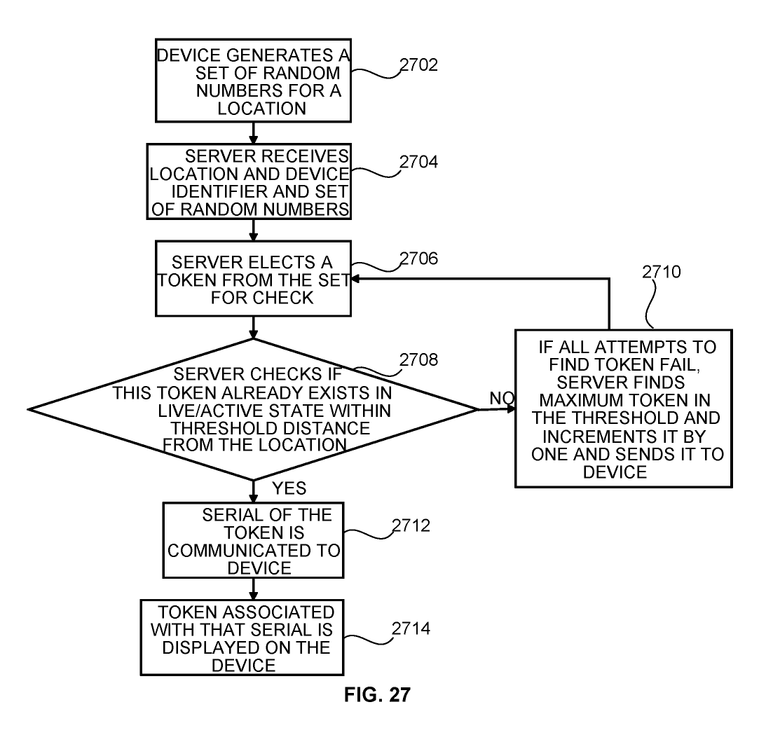

FIG. 27 is a flowchart that illustrates a method for token generation in a device, through the server 108 of FIG. 1, according to an embodiment herein. In step 2702, a set or array of random numbers for a location is generated by a device. In step 2704, the location, a device identifier and the set of random numbers is received by the server 108 of FIG. 1. In an embodiment the location may be obtained from a profile location of the user already stored in server 108. In step 2706, a token from the set is elected by the server 108 of FIG. 1, for check. In step 2708, the server 108 of FIG. 1, checks if the token already exists in live/active state within threshold distance from the location. In step 2710, if all attempts to find token fail, the server 108 of FIG. 1 finds maximum token in the threshold and increments it by one and sends it to device. In step 2712, serial of the token within the set or array is communicated to the device. In step 2714, the token associated with the serial is displayed on the device. A similar check can be done by the device wherein device receives all the active tokens within its threshold distance from the server 108 and generates a unique token that is not in the list sent by the server 108. In this method token is getting associated with a location where token is generated by device.

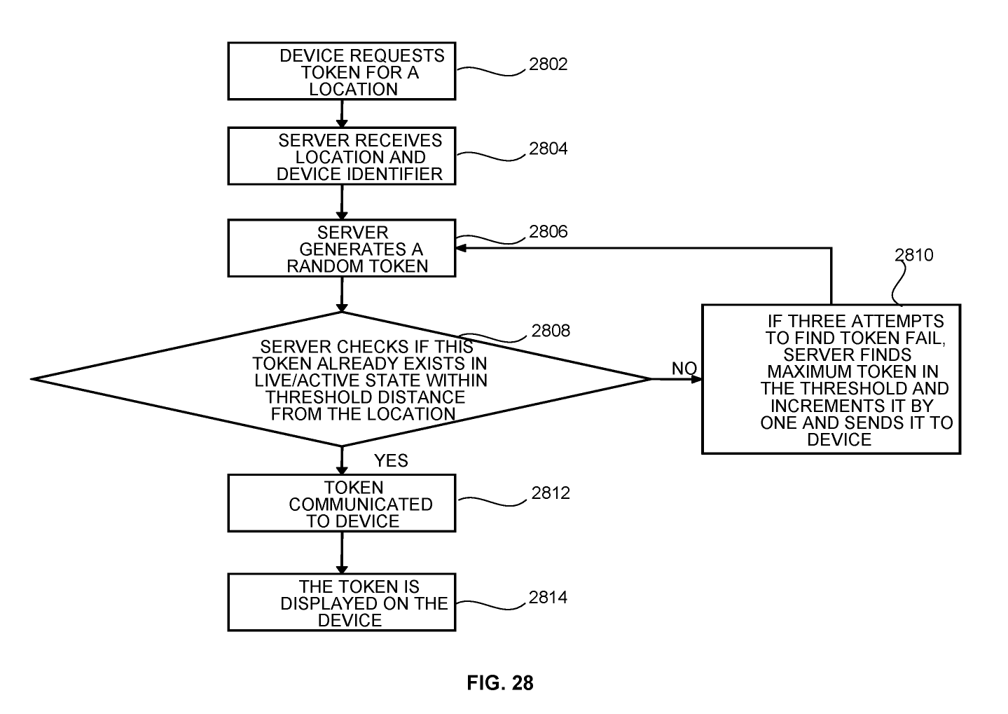

FIG. 28 is a flowchart that illustrates a method for token generation in a server 108 of FIG. 1, according to an embodiment herein. In an embodiment, generated token is unique within a threshold area or distance. In step 2802, the token for a location is requested by the device. In step 2804, the location and a device identifier is received by the server 108 of FIG. 1. In step 2806, a random token is generated by the server 108 of FIG. 1. In step 2808, the server 108 of FIG. 1, checks if this token already exists in live/active state within threshold distance from the location. In step 2810, if three attempts to find token fail, the server 108 of FIG. 1 finds maximum token in the threshold and increments it by one and sends it to the device. In step 2812, the token is communicated to the device. In step 2814, the token is displayed on the device. In one embodiment, the token obtaining module 215 of FIG. 2A obtains identical tokens. The token obtaining module communicates the identical tokens to the token communicating module 206. A location of the first user 102 is a physical location or an assumed location. In this method token is getting associated with a location where token is generated by server 108. In the same manner, comparison tokens can also be done by device as well as server 108. For device comparison of tokens, the server 108 can send all the tokens that are obtained by first users within threshold distance to a token request processing module 202 of a second user device 110 and second user device 110 can perform the comparison within its own processor and confirm to server 108 that a match has been found. Or the device can send a token to the server 108 and server 108 can compare the received token with all the obtained tokens within a threshold distance to find a match between first user and second user tokens. The device may perform the addition security check to protect user in the event device is lost to check of breach of a threshold amount allowed in user's profile.

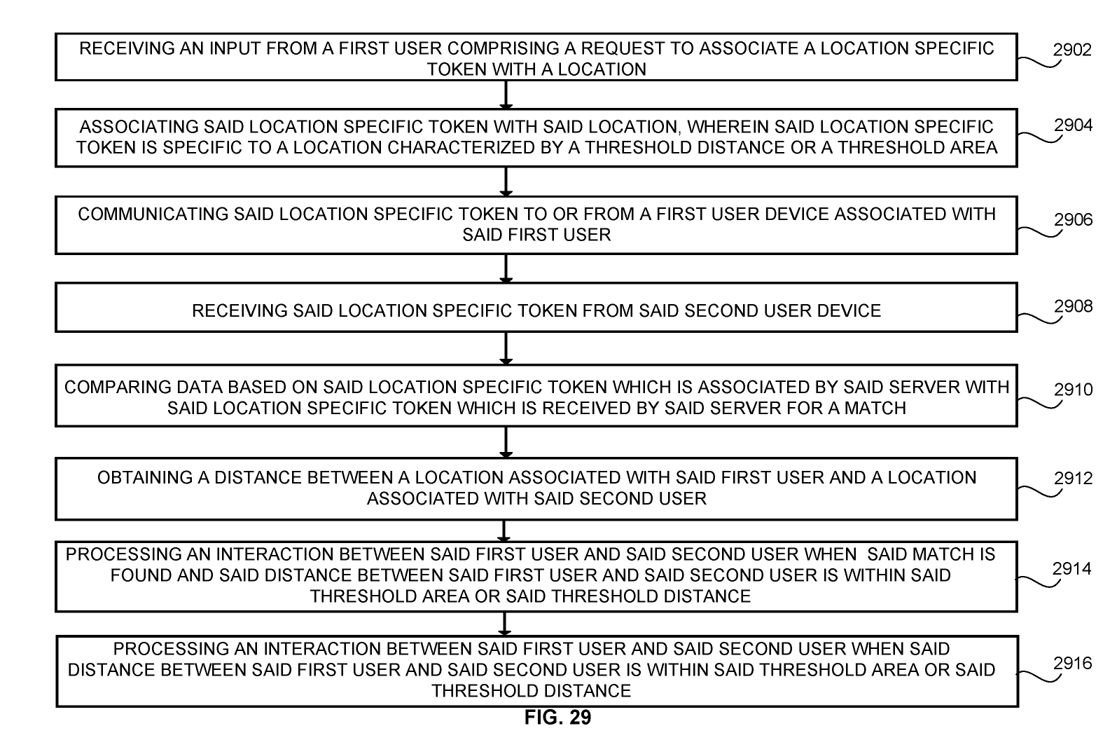

FIG. 29 illustrates a method for obtaining a location specific token for authenticating an interaction between a first user device 104 and a second user device 110 according to an embodiment herein. In step 2902, an input from the first user 102 of FIG. 1 including a request to associate a location specific token with a location is received. In step 2904, the location specific token with the location is associated. The location specific token is specific to a location characterized by a threshold distance or a threshold area. In step 2906, the location specific token to or from the first user device 104 of FIG. 1 associated with the first user 102 of FIG. 1 is communicated. The location specific token is communicated from the first user device 104 of FIG. 1 to a second user device 110 of FIG. 1 associated with the second user 112 of FIG. 1. In step 2908, the location specific token from the second user device 110 is received. In step 2910, data based on the location specific token which is associated by the server 108 with the location specific token which is received by the server 108 for a match is compared. In step 2912, a distance between a location associated with the first user 102 of FIG. 1 and a location associated with the second user 112 of FIG. 1 is obtained. In step 2914, an interaction between the first user 102 of FIG. 1 and the second user 112 of FIG. 1 is processed when the match is found between the location associated with location specific token which is associated by the server 108 and the location specific token which is received by the server 108. In step 2916, an interaction between the first user 102 of FIG. 1 and the second user 112 of FIG. 1 is processed when the distance between the first user 102 and the second user 112 is within the threshold area or the threshold distance. In one embodiment, the token may be a globally unique token. In one embodiment token may be a reusable globally unique token. In one embodiment, the token may be a location specific token that is reusable and globally non-unique token. In one embodiment, location specific token may identical to another token that is simultaneously associated with another user.

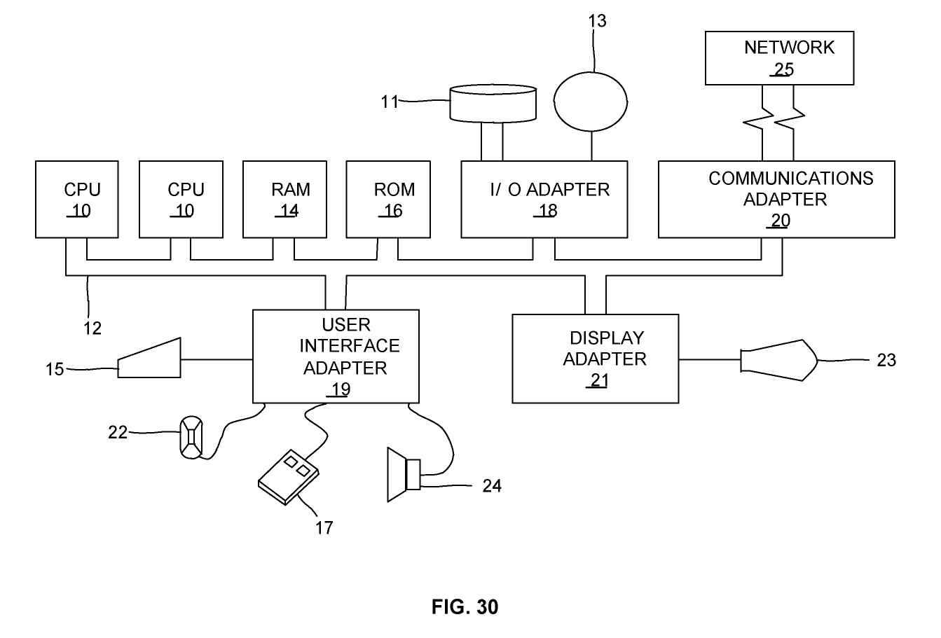

FIG. 30 is a schematic diagram of a computer architecture used in accordance to the embodiments herein. The system includes at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein.

The system further includes a user interface adapter 19 that connects a keyboard 15, mouse 17, speaker 24, microphone 22, and/or other user interface devices such as a touch screen device (not shown) or a remote control to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

This invention leverages the geo-spatial nature of computational devices such as smart phones. Even desktops have internet protocol addresses, and these addresses are mappable on to geo-locations as there are many websites that presently locate, that is, latitude and longitude, desktop within a reasonable error. Areas of concentric shapes can be made such that all points within the inner area are closer to each other than any two points of distant non-intersecting concentric areas. By combining this geometric property with available technology, a new method of generating tokens is devised wherein identical tokens can be used by many users simultaneously. This method is not limited to circles as many shapes can made within the scope of invention. This would lead to smaller tokens that can be easily spoken by humans verbally. This will preclude the need for users to scan large tokens by NFC tags and QR codes. However, this type of token can as well be transmitted by scans like QR code and NFC tags etc. Moreover, in addition to a location specific token associated with interacting interfaces or user have to be within a threshold distance, in some embodiments they must be within a threshold distance of a secret location. The secret location will add another factor of authentication in addition to matching of tokens and threshold-ness of the tokens of interacting parties. For example, a bank may not allow its employee to login into bank's network unless a token is obtained from a smart phone in which the bank employee is logged in, and entered into a desktop, and then accept login notification on his smart phone, but in addition to all o f these, the token must have been acquired of a secret location. Therefore, if the smart phone is stolen or acquired for misuse, even with a logged in access to the smart phone, a hacker cannot access the banks network unless the hacker also knows the secret location for which the token has to be obtained. This establishes use of location associated tokens in its own right even without them to be unique within a threshold area.

The description of the specific embodiments herein so fully reveals the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the invention.

1. A server for obtaining a location specific token for authenticating an interaction between a first user device and a second user device, said server comprising:
(i) a memory unit that stores (a) a set of modules, and (b) a database; and
(ii) a processor which executes said set of modules, wherein said set of modules comprise:
(a) a token processing module, executed by said processor, that receives an input from said first user device comprising a request to associate said location specific token with a location;
(b) a token associating module, executed by said processor, that associates said location specific token with said location, wherein said location specific token is specific to said location characterized by a threshold distance or a threshold area;
(c) a token communicating module, executed by said processor, that communicates said location specific token
(i) to said first user device associated with a first user, wherein said location specific token is first obtained by said server before it is obtained by said first user device; or
(ii) from said first user device associated with said first user, wherein said location specific token is first obtained by said first user device before it is obtained by said server, wherein said location specific token is communicated from said first user device to said second user device associated with said second user, and
(d) a token receiving module, executed by said processor, that receives said location specific token from said second user device;
(e) a token comparison module, executed by said processor, that compares data based on said location specific token which is associated by said server with said location specific token which is received by said server from said second user device for a match;
(f) a distance obtaining module, executed by said processor, that obtains a distance between a location associated with said location specific token of said first user device and a location associated with said location specific token of said second user device, wherein said location associated with said location specific token is a physical location or an assumed location of a user of a user device; and
(g) an interaction processing module, executed by said processor, that processes an interaction between said first user and said second user when
(i) said match is found between said location specific token which is associated by said server and said location specific token which is received by said server from said second user device,
(ii) said distance between said location associated with first user and said location associated with second user is within said threshold area or said threshold distance, wherein said first user or said second user is inside or outside of said location characterized by said threshold area or said threshold distance, or
(iii) said distance between said location associated with said location specific token of said first user device and said location associated with said location specific token of said second user device is within said threshold area or said threshold distance.

2. The server of claim 1, wherein said set of modules further comprise a token obtaining module that obtains identical tokens, wherein said location specific token is associated with said first user and said location, wherein said location is a physical location or an assumed location of said first user.

3. The server of claim 1, wherein said location associated with said first user is characterized by a first threshold outer area or distance and a first threshold inner area or distance, wherein said first threshold inner area or distance is within said first threshold outer area or distance, wherein said location specific token (a) is obtained for said first threshold inner area or distance, (b) is valid only within said first threshold inner area or distance, and (c) is deactivated upon said location specific token moves out of said first threshold inner area or distance, or said location associated with said location specific token gets changed to a location that is not inside said first threshold inner area or distance.

4. (canceled)

5. The server of claim 1, wherein said location specific token is a reusable token that is identical for a plurality of users and simultaneously used by said plurality of users from said plurality of locations.

6. (canceled)

7. The server of claim 1, wherein said set of modules further comprise a token deactivation module, executed by said processor, that deactivates said location specific token when
(a) said first user moves out of said first threshold inner area or distance for which said location specific token is associated;
(b) said interaction between said first user and said second user is completed; (c) upon said first user indicating to deactivate said location specific token; or (d) said location associated with said location specific token is changed to a location that is outside of said first threshold inner area.

8. (canceled)

9. (canceled)

10. (canceled)

11. (canceled)

12. The server of claim 1, wherein said interaction is a transaction between said first user and said second user, wherein said first user is a payer or payee and said second user is a payer or payee.

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. The server of claim 1, wherein said set of modules further comprise a security check module that performs an additional security check for said payer upon detection of breach of a threshold amount by a cumulative total or a number based on said cumulative total of said transaction starting from a previous additional security check.

25. The server of claim 1, wherein said set of modules further comprise a token verification module that verifies whether said location specific token associated with said payer or said payee exists in a database of location specific tokens, wherein said database of said location specific tokens is associated with said threshold distance or said threshold area characterized by said location associated with said payee device or said location associated with said payer device.

26. The server of claim 1, wherein said location specific token is valid up to a predefined threshold time beyond which said location specific token is deactivated.

27. (canceled)

28. (canceled)

29. (canceled)

30. (canceled)

31. (canceled)

32. (canceled)

33. (canceled)

34. One or more non-transitory computer readable storage mediums storing one or more sequences of instructions, which when executed by one or more processors, causes
(a) receiving an input from said first user device comprising a request to associate a location specific token with a location;
(b) associating said location specific token with said location, wherein said location specific token is specific to a location characterized by a threshold distance or a threshold area;
(c) communicating said location specific token (i) to said first user device associated with a first user, wherein said location specific token is first obtained by said server before it is obtained by said first user device; or (ii) from said first user device associated with said first user, wherein said location specific token is first obtained by said first user device before it is obtained by said server, wherein said location specific token is communicated from said first user device to a second user device associated with a second user;
(d) receiving said location specific token from said second user device;
(e) comparing data based on said location specific token which is associated by said server with said location specific token which is received by said server from said second user device for a match;
(f) obtaining a distance between a location associated with said location specific token of said first user device and a location associated with said location specific token of said second user device, wherein said location associated with said location specific token is a physical location or an assumed location of a user of a user device; and
(g) processing an interaction between said first user and said second user when
(i) said match is found between said location specific token which is associated by said server and said location specific token which is received by said server from said second user device,
(ii) said distance between said location associated with said first user and said location associated with said second user is within said threshold area or said threshold distance, wherein said first user or said second user is inside or outside of said location characterized by said threshold area or said threshold distance, or
(iii) said distance between said location associated with said location specific token of said first user device and said location associated with said location specific token of said second user device is within said threshold area or said threshold distance.

35. A server for simultaneously obtaining a plurality of identical tokens for authenticating an interaction between a first user device associated with a first user and a second user device associated with a second user, wherein said first user and said second user are located anywhere with respect to each other and keeping identical tokens separated by a threshold distance, wherein location associated with a token is any location of the world including a location that is remote to user's physical location, said server comprising:
(i) a memory unit that stores (a) a set of modules, and (b) a database; and (ii) a processor which executes said set of modules, wherein said set of modules comprise:
(a) a token processing module, executed by said processor, that receives an input from said first user comprising a request to associate a location specific token with a first location characterized by (i) a first threshold inner area and (ii) a first threshold outer area, wherein said first threshold inner area is subset of first threshold outer area;
(b) a token uniqueness validating module, executed by said processor, that (i) compares said location specific token generated at said first threshold inner area with active tokens in said first threshold outer area or said first threshold inner area; and (ii) validates a uniqueness of said location specific token within said first location, wherein said location specific token is simultaneously used for a second location that is located proximal or elsewhere with respect to said first location, wherein said second location is characterized by (i) a second threshold inner area and (ii) a second threshold outer area, wherein said second threshold inner area is subset of second threshold outer area;
(c) a token associating module, executed by said processor, that associates said location specific token with said first location by validating said uniqueness of said location specific token within said first location; and simultaneously associates said location specific token also with said second location.

36. The server of claim 35, wherein said set of modules further comprise a token communicating module, executed by said processor, that communicates said location specific token (i) to said first user device associated with said first user, wherein said location specific token is first obtained by said server before it is obtained by said first user device; or (ii) from said first user device associated with said first user, wherein said location specific token is first obtained by said first user device before it is obtained by said server, wherein said location specific token is communicated from said first user device to said second user device associated with said second user.

37. The server of claim 35, further comprising a token receiving module, that receives said location specific token from said second user device with an associated location within said first inner threshold area or said first outer threshold area.

38. The server of claim 35, further comprising a token comparison module that matches data based on said location specific token associated with said first user device and said location specific token associated with said second user device by analysing if a location associated with both said location specific token is within said first inner threshold area or said first outer threshold area.

39. The server of claim 35, wherein said set of modules further comprise:
(i) a distance obtaining module, executed by said processor, that obtains a distance between a location associated with said location specific token of said first user device and a location associated with said location specific token of said second user device, wherein said location associated with said location specific token is a physical location or an assumed location of a user of a user device; and
(ii) an interaction processing module, executed by said processor, that processes an interaction between said first user and said second user when
(a) said match is found between said location specific token which is associated by said server and said location specific token which is received by said server, and
(b) said distance between said location associated with said location specific token of said first user device and said location associated with said location specific token of said second user device is within a predefined threshold area or a predefined threshold distance, wherein said first user or said second user is inside or outside of said location characterized by said predefined threshold area or said predefined threshold distance, and a location associated with said first user and said second user is a physical location of said user or an assumed location of said user, wherein a location associated with (i) said location specific token, (ii) said first user device, or (iii) said second user device is a user's physical location or located remotely to said user's physical location.

40. The server of claim of 35, wherein said location specific token is also used for an interaction between a third user and a fourth user in said second location by utilizing said second threshold inner area and said second threshold outer area.

41. (canceled)

42. The server of claim 35, wherein said set of modules further comprise an approval receiving module that receives an approval for said transaction from said payer device.

43. The server of claim 35, wherein said set of modules further comprise an approval receiving module that receives an approval for said transaction or interaction from said first user device or said second user device.

44. The server of claim 43, wherein said set of modules further comprise a transaction processing module that is configured to process said transaction between said payer and said payee upon
(i) successfully receiving said approval; and
(ii) a match is found between said location specific token associated with said payer device and said location specific token associated with said payee device.

45. The server of claim 35, wherein said set of modules further comprise a token verification module that verifies whether said location specific token associated with said payer or said payee exists in a database of location specific tokens, wherein said database of said location specific tokens is associated with a threshold distance or a threshold area characterized by a location associated with a payer device or a location associated with a payee device.

46. (canceled)
